(19) United States
(12) Patent Application Publication
(10) Pub. No.: US 2014/0227777 A1
(43) Pub. Date: Aug. 14, 2014

(54) CELL SORTING BY 3D FLOW AND ADHESIVE ROLLING

(71) Applicants: Brigham and Women's Hospital, Boston, MA (US); Massachusetts Institute of Technology, Cambridge, MA (US)

(72) Inventors: Sung Young Choi, Cambridge, MA (US); Rohit N. Karnik, Cambridge, MA (US); Jeffrey M. Karp, Brookline, MA (US)

(73) Assignee: Brigham and Women's Hospital, Boston, MA (US)

(21) Appl. No.: 14/348,043

(22) PCT Filed: Oct. 1, 2012
(86) PCT No.: PCT/US12/58375

§ 371 Date: Mar. 27, 2014

Related U.S. Application Data
(60) Provisional application No. 61/542,089, filed on Sep. 30, 2011.
(60) Provisional application No. 61/542,093, filed on Sep. 30, 2011.

(51) Int. Cl. G01N 1/34

(52) U.S. Cl. CPC G01N 1/34
USPC 435/309.1

(57) ABSTRACT

The present disclosure, among other things, describes cell rolling by 3D flow and adhesive rolling. In some embodiments, a device described herein includes a flow channel dimensioned to permit fluid flow therethrough; at least one 3D structure protruding from at least one surface of the flow channel; and at least one cell adhesion entity coated on at least part of at least one of the 3D structures, which adhesion entity interacts with a target cell brought into contact with the 3D structures by flow of a stream comprising the target cell through the flow channel such that the target cell's trajectory through the flow channel is diverted due to the interaction.

### RELATED REFERENCES

This application claims priority to U.S. provisional patent application Ser. No. 61/542,089, filed Sep. 30, 2011, and U.S. provisional patent application Ser. No. 61/542,093, filed Sep. 30, 2011, the entire contents of which are herein incorporated by reference.

### GOVERNMENT SUPPORT

The work described herein was supported, in part, by grants from the National Science Foundation (CBET-0952493) and from the National Institutes of Health (HL-097172 and HL-095722). The Government of the United States has certain rights in this application.

### BACKGROUND

Fast, efficient isolation of subpopulations of cells from fluid samples, such as whole blood, is desired in many clinical and research applications. For example, many diagnostic assays require an initial step of isolating white blood cells (WBCs) from whole blood to avoid interference from other elements in the blood. Similarly, for stem cell-mediated tissue regeneration, mesenchymal stem/progenitor cells (MSPCs) need to be isolated from bone marrow before being applied to the site of the damaged tissue in order to stimulate or enhance tissue repair and/or regeneration.

One of the known challenges which arises when trying to isolate WBCs and MSPCs is the need to remove vast quantities of “contaminating cell types,” such as red blood cells (RBCs) while preserving the often small quantities of the cells of interest (e.g., typical whole blood contains about 1 WBC for every 1000 RBCs, while bone marrow blood contains far fewer MSPCs per RBCs, typically existing within bone marrow at a frequency per mononucleated cell of about 1 in 10,000 to 1 in 100,000). Suitable separation systems therefore need to be capable of extremely high selectivity in order to produce enriched populations of WBCs and MSPCs.

Current techniques for separating cells can generally be divided into techniques that require the cells to be differentially tagged (e.g., with antibodies) and techniques that separate cells using differences in the physical properties of the cells.

Tagged techniques include fluorescence-activated cell sorting (FACS) and magnetic-activated cell sorting (MACS). In FACS, fluorescently labeled dyes are differentially attached to cell mixtures, which are then sorted individually using fluorescence and light scattering. This technique can provide highly enriched cell populations (>95%), but requires expensive equipment and has a limited throughput of about 10⁷ cells per hour. MACS can have much higher throughput, on the order of about 10¹¹ cells per hour, but requires magnetic beads to be attached to the cells, which can be difficult to separate, and also requires further processing.

For example, most current techniques for isolating MSPCs involve antibody tagging. These techniques require advance knowledge of the appropriate MSPC surface ligands and availability of suitable tagging antibodies. This can prove a challenge because MSPCs that express the standard surface ligands (i.e., STRO-1, CD73, CD166, CD44) typically still have heterogeneity in their expression of non-standard surface ligands that may affect their utility (e.g., engraftment efficiency). This variability highlights the need for sorting techniques that can be used to generate more homogenous MSPC populations. In addition, because tagged techniques involve attaching external substances (e.g., antibodies) to the cell surface this can cause the cells to be rejected by the body when used for therapeutic applications. The numerous processing steps involved in tagged techniques can also impact the state of the cells and thereby hamper further diagnostic analysis or therapeutic applications. Minimizing the number of processing steps would help preserve the native state of the isolated cells and also speed up the process, thus enabling point-of-care use.

Non-tagged techniques typically use size, shape, and dielectrophoretic mobility to separate cells. For example RBCs, which lack a hard nucleus, are approximately disc-shaped, have a diameter of about 8 micrometers, have a thickness of about 2.5 micrometers, and are highly deformable. In contrast, MSPCs and WBCs are approximately spherically shaped in suspension, have a diameter about in the range of 8 to 25 micrometers, and are less deformable when compared to RBCs. Based on these differences, filters have been developed for leuko-depletion from blood, e.g., to prevent reperfusion injury. For example, filters have been used to remove free circulating leukocytes from the arterial line of the extracorporeal circuit employed in open-heart surgery. Unfortunately, current filters have a number of limitations. For example, some filters have been shown to activate leukocytes while others become clogged with larger cells. Current attempts to unclog the filters generally cause filtered cells to be reintroduced into the unfiltered population, thereby negating a sorting that has already occurred. Filters also are limited in their ability to separate cells with high specificity and purity.

There remains a need in the art for devices and methods for effective cell sorting and analysis. In particular, there remains a need for devices and methods that enable rapid separation of cells with minimal processing steps.

### SUMMARY

The present invention encompasses the recognition that useful systems can be designed that include three-dimensional (3D) structures protruding from a flow cell channel surface, some or all of which are associated with cell adhesive entities. In some embodiments, such 3D structures are designed and arranged so that two or more fluid streamlines oriented in substantially different directions occur in the flow cell channel, and interaction between cells in a fluid flowing through the flow cell and adhesive entities on the protrusions alters the cell's trajectory from a first streamline to a second streamline.

In some embodiments, the present invention encompasses the recognition that flow cell channels can be designed and constructed, including by design and arrangement of 3D structures within the channels, to achieve hydrophoretic focusing of cells within a flow cell channel toward or into a particular region directed by certain set of streamlines; use of cell adhesion entities, for example coated on such 3D structures, in accordance with the present invention can direct interacting cells out of the certain set of streamlines to an alternative set of streamlines oriented in a substantially different direction that direct the cells into another region.

In some embodiments, the present invention encompasses the recognition that flow cell channels can be designed and constructed, including by design and arrangement of 3D structures within the channels, to achieve deterministic lateral displacement (DLD) sorting of cells, for example based on size, combined with sorting even of similarly-sized cells through adhesive interactions as described herein.

In some embodiments, the present invention encompasses the recognition of a source of a problem with certain other adhesion-based cell sorting systems. For example certain adhesion-based cell sorting systems utilize micropatterning of adhesive entities to achieve effective sorting even of low frequency cells within a population (see, for example US 20100112026, US 20100304485 and Nishimura et al., “Label-free continuous cell sorter with specifically adhesive oblique micro-grooves” J. Micromech. Microeng. 19 (2009) 125002, each of which is incorporated herein by reference. However, different from the present disclosure, Nishimura et al. describes a system that does not divert cells from one set of streamlines to another set of streamlines that are oriented in a different direction. Moreover, Nishimura et al. expressly teaches a groove depth of 0.25 μm and expects that “the effect of local flow inside the grooves on the overall flow profile is negligible”. Furthermore, the present invention encompasses the recognition that required mircopatterning of adhesive entities can complicate device fabrication and can present challenges for multiplexing. In some embodiments, provided flow cell channels comprising one or more 3D structures are substantially uniformly coated with cell adhesion entities; micropatterning is not required. In some embodiments, at least the 3D structures are substantially uniformly coated; in some embodiments at least some surfaces within the flow cell channel are not uniformly coated, or not coated at all, with cell adhesion entities.

The present invention also encompasses the recognition that many available cell-adhesion-based sorting systems require multiple inlets (e.g., for cell-containing fluid and buffer fluid) and/or outlets; the present invention encompasses the recognition that design of flow cell channels containing 3D structures as described herein can simplify flow cell production including by permitting use of a single inlet, particularly for embodiments that achieve hydrophoretic focusing of cells. Alternatively or in addition, one or more focusing channels can be added in series upstream of the separation channel. In some embodiments, provided devices contain a single outlet (and/or a single inlet).

In some embodiments, the present invention provides a plurality of devices, each of which comprises one or more flow cell channels, at least one of which comprises 3D structures, preferably associated with a cell adhesion entity, arranged and constructed therein. In some embodiments, the plurality of such devices is in open continuation, so that fluid flow passes from a first flow cell channel into at least one second flow cell channel. Assuming comparable flow rates and cell concentrations in samples, such multiplexed systems can achieve higher throughput that individual systems, and particular than systems relying on micropatterning of cell adhesion entities.

The present invention provides the particular insight that flow cell devices as described herein that comprise a flow cell channel with adhesion-entity-associated 3D structures as described herein are particularly useful for, for example, in high throughput, gross scale cell sorting (e.g., not for isolation of very low abundance cells), in some embodiments desirably combined with high specificity cell sorting, for example for diagnostic and/or other applications that require or involve particularly high sensitivity. In certain embodiments, provided devices can be used with a flow rate of or greater than about 20 mL/min, about 30 mL/min, about 40 mL/min, about 50 mL/min, about 60 mL/min, about 70 mL/min, about 80 mL/min, about 90 mL/min, about 100 mL/min, about 150 mL/min, or about 200 mL/min. In certain embodiments, provided devices can be used with a cell concentration of or greater than about 10⁴ mL⁻¹, about 10⁵ mL⁻¹, about 2×10⁵ mL⁻¹, about 3×10⁵ mL⁻¹, about 4×10⁵ mL⁻¹, about 5×10⁵ mL⁻¹, about 6×10⁵ mL⁻¹, about 7×10⁵ mL⁻¹, about 8×10⁵ mL⁻¹, about 9×10⁵ mL⁻¹, about 10⁶ mL⁻¹, about 1×10⁶ mL⁻¹, about 2×10⁶ mL⁻¹, about 5×10⁶ mL⁻¹, or about 10⁷ mL⁻¹.

In some embodiments, the present invention provides devices comprising at least one flow cell channel having 3D structures therein, at least some of which are associated (e.g., coated) with one or more cell interacting moieties. In some embodiments, the present invention encompasses the recognition that, when flowing cells across surfaces or through channels, with which at least some of the cells interact, the probability, efficiency, and/or affinity of such interactions can be improved by including one or more three-dimensional (3D) structures in the flow path.

The present invention specifically demonstrates that, in systems designed to alter the trajectory of a flowing cell through contact with one or more adhesion entities with which the cell interacts and which are associated with part or all of a surface over which the cell is flowed, use of such 3D structures, protruding from the surface(s) over which the cell is flowed, improves the system's ability to alter the cell's trajectory. The present disclosure demonstrates, for example, improved sorting of cell populations by altering the trajectory of cells that interact with a surface over which they are flowed, so that such interacting cells are diverted from the flow across the surface.

In general, in many embodiments of the present invention, a liquid comprising cells is flowed through a sorting channel from whose surface(s) one or more 3D structures protrude. In some embodiments, at least some of the protrusions are at least partially coated with a cell adhesion entity so that target cells can roll on them. As a result of such rolling the target cells follow a trajectory that is different from the trajectory that would be followed by the same cells in the same system absent the coating, and/or that is or would be followed by other cells that do not interact with the cell adhesion entity.

In some embodiments, 3D structures present in provided devices are designed and/or arranged to separate cells based on differences in physical properties (e.g., differences in size). Advantageously such devices can be used to sort cell types that would otherwise follow the same trajectories in the absence of the coating (e.g., because the cell types have similar sizes).

In some embodiments, protruding 3D structures comprise a series of lateral microstructures, preferably arranged at an angle to the direction of bulk flow so that, when a stream comprising target cells (and optionally also comprising non-target cells) is flowed through the channel under conditions that permit cell rolling, the trajectory of target cells is altered, and specifically is diverted laterally from the direction of bulk flow.

In some embodiments of the present invention, target cell trajectories are altered (with respect to bulk flow and/or with respect to trajectories otherwise followed by comparable cells, optionally including non-target cells present in the stream) so that target cells are directed to a location distinct from that to which non-target cells are flowed. Such direction effects separation of target cells from non-target cells.

### DEFINITIONS

In order for the present disclosure to be more readily understood, certain terms are first defined below. Additional definitions for the following terms and other terms are set forth throughout the specification.

In this application, the use of “or” means “and/or” unless stated otherwise. As used in this application, the term “comprise” and variations of the term, such as “comprising” and “comprises,” are not intended to exclude other additives, components, integers or steps. As used in this application, the terms “about” and “approximately” are used as equivalents. Any numerals used in this application with or without about/approximately are meant to cover any normal fluctuations appreciated by one of ordinary skill in the relevant art. In certain embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

“Associated”: As used herein, the term “associated” typically refers to two or more entities in physical proximity with one another, either directly or indirectly (e.g., via one or more additional entities that serve as a linking agent), to form a structure that is sufficiently stable so that the entities remain in physical proximity under relevant conditions, e.g., physiological conditions. In some embodiments, associated moieties are covalently linked to one another. In some embodiments, associated entities are non-covalently linked. In some embodiments, associated entities are linked to one another by specific non-covalent interactions (i.e., by interactions between interacting ligands that discriminate between their interaction partner and other entities present in the context of use, such as, for example. streptavidin/avidin interactions, antibody/antigen interactions, etc.). Alternatively or additionally, a sufficient number of weaker non-covalent interactions can provide sufficient stability for moieties to remain associated. Exemplary non-covalent interactions include, but are not limited to, affinity interactions, metal coordination, physical adsorption, host-guest interactions, hydrophobic interactions, pi stacking interactions, hydrogen bonding interactions, van der Waals interactions, magnetic interactions, electrostatic interactions, dipole-dipole interactions, etc.

“Substantially”: As used herein, the term “substantially”, and grammatical equivalents, refer to the qualitative condition of exhibiting total or near-total extent or degree of a characteristic or property of interest. One of ordinary skill in the art will understand that biological and chemical phenomena rarely, if ever, go to completion and/or proceed to completeness or achieve or avoid an absolute result.

### BRIEF DESCRIPTION OF THE DRAWING

The drawing is for illustration purposes only, not for limitation.

FIG. 1 illustrates an exemplary approach to geometry-directed rolling in a deterministic lateral displacement (DLD) device that includes a square post array.

FIG. 2 illustrates an exemplary approach to geometry-directed rolling in a deterministic lateral displacement (DLD) device that includes a circular post array.

FIG. 3 illustrates an exemplary approach to geometry-directed rolling in a deterministic lateral displacement (DLD) device that includes a triangular post array.

FIG. 4 illustrates an exemplary approach to geometry-directed rolling in a deterministic lateral displacement (DLD) device that includes a tear-drop post array.

FIG. 5 illustrates an exemplary approach to geometry-directed rolling in a deterministic lateral displacement (DLD) device that includes densely-packed obstacles.

FIG. 6 illustrates an exemplary approach to geometry-directed rolling in a hydrodynamic focusing device that includes a constriction and expansion region.

FIG. 7 illustrates (A) an exemplary approach to geometry-directed rolling in a hydrodynamic filtration device that includes a main channel and multiple side channels, and (B) a close up of the flow rate distribution at a branch between the main channel and a side channel.

FIG. 8 depicts exemplary combinations of cell focusing and cell sorting units that include a traditional cell sorting unit 1 and a geometry-directed cell rolling unit 2. These units can be integrated into a single microfluidic cell sorting device.

FIG. 9 depicts exemplary combinations of cell focusing and cell sorting units that include two geometry-directed cell rolling units 1 and 2 with different cell adhesion entities A and B, respectively. These units can be integrated into a single microfluidic cell sorting device.

FIG. 10 depicts exemplary combinations of cell focusing and cell sorting units that include two geometry-directed cell rolling units 1 and 2 that are based on different separation techniques. These units can be integrated into a single microfluidic cell sorting device.

FIG. 11 depicts an exemplary parallelized device for high-throughput separation.

FIG. 12 shows images of (A) a target HL60 cell rolling around a square post that has been coated with P-selectin and (B) a non-target K562 cell that does not bind to the P-selectin coating and flows along the streamline paths that are depicted as solid lines in the left half of the image.

FIG. 13 depicts a schematic showing cell sorting using directed cell rolling on an exemplary device. As shown, non-target cells are focused along the central flow axis while target cells roll on cell adhesion entity-coated microstructures until they reach either of the side-ends of the microstructures.

FIG. 14 illustrates an exemplary cell sorting method that uses a device with a separation unit that is based on cell rolling (Sorting 2) downstream of another separation unit that relies on a different cell sorting modality (Sorting 1).

FIG. 15 illustrates an exemplary cell sorting method that uses a device with a separation unit that is based on cell rolling (Receptor 2) downstream of another separation unit that is also based on cell rolling (Receptor 1). The two separation units are coated with different cell adhesion entities.

FIG. 16 illustrates an exemplary high-throughput device that includes a series of parallel separation units.

FIG. 17 depicts (a) a schematic showing exemplary trajectories of non-target and target cells as they interact with microstructures coated with a cell adhesion entity and (b) optical micrographs showing microstructures of an exemplary device.

FIG. 18 shows (a) superimposed images of motion sequences of target HL60 cells rolling in a separation channel coated with the cell adhesion entity P-selectin; (b, c) superimposed images of target HL60 cells flowing in the channel outlet region after escaping from the separation channel; and (d) cell flux distributions of non-target K562 cells and target HL60 cells in the outlet region.

FIG. 19 shows (a) a graph that illustrates the effect of the concentration of cell adhesion entity P-selectin and shear stress on a sorting efficiency of target HL60 cells and non-target K562 cells; (b) image of non-target K562 cells travelling into the outlet which is aligned with the central flow axis and target HL60 cells travelling into the side outlets of the device; (c) image of the mixed cell population before separation; (d) image of the resulting non-target K562 cells (stained with a green fluorescent dye); and (e) image of the resulting target HL60 cells (not stained with a green fluorescent dye).

FIG. 20 shows a graph that illustrates the results of a control experiment that used a coating of BSA instead of a coating of P-selectin.

FIG. 21 depicts (a) a top-view schematic of an exemplary sorting channel comprising V-shaped microstructures (only one microstructure is shown for clarity). Dotted lines A₁ and A₂ respectively denote a longitudinal axis of the microstructure across the width of a sorting channel and a longitudinal axis of a sorting channel along the direction of bulk flow and (b) a side-view schematic of the exemplary sorting channel comprising V-shaped microstructures.

FIG. 22 shows a scalable parallel sorting device. (A) (Top) Schematic of a single microfluidic channel comprising the focusing ridges in the narrow channel and a sorting ridges in the wide channel. The ribbon indicates a schematic helical streamline. (Bottom) Cross-section views of the wide sorting channel along the x-axis, showing the cell trajectories. (B) The 2×10 channel array is in a 3.5 cm×3.5 cm square device. Scale bar, 1 cm.

FIG. 23 illustrates deterministic cell rolling. (A) Overlay image showing a rolling sequence of two HL60 cells in order of (1) tethering, (2) rolling on the vertical wall, (3) rolling on the bottom wall, and (4) detaching. The time difference between each frame (total 12 frames) is ˜6 s. The maximum wall shear stress on the SR was 3.4 dyn/cm². Simulated streamlines over the SR are overlaid on the image; the side view shows the streamlines projected along the SR, y′ axis. The top surface of the SR was set to z=0 μm. (B) Rolling dynamics on a model square post. (Left) The HL60 cell rolls on the P-selectin-coated post, crossing the streamlines, whereas (Right), the HL60 cell does not bind to the BSA-passivated post and flows along the streamlines. The lines represent simulated streamline paths. The maximum wall shear stress on the post was 3 dyn/cm² (channel Reynolds number ˜0.1). Scale bars, 100 μm (A) and 20 μm (B).

FIG. 24 shows trajectories of HL60 cells in passivated and P-selectin-coated channels. (A) The fluorescently labeled cells are focused into a single stream after passing through the focusing channel. The cell stream that enters a sorting channel is focused again to a tight streamline about 25 ridges downstream. The entire channel was passivated with 1% BSA solution. The arrow indicates the focusing direction of cells. (B) Overlay trajectories of rolling HL60 cells. The time difference between each frame (total 19 frames) is ˜1.5 s. The entire channel was incubated with P-selectin solution of 1.5 μg/mL. The channel geometry is the same as in (A). The arrow indicates the rolling trajectory of a cell. Scale bar, 200 μm.

FIG. 25 shows parallel sorting of leukemic cell lines. (A) Effect of shear stress (σ) and P-selectin incubation concentration (cₚ) on a sorting efficiencies of HL60 and K562 cells for a single sorting channel. As a negative control, the device passivated with 1% BSA solution was tested with the cell mixture of HL60 and K562. Error bars, s.d. (n=3). (B) Sorting of HL60 (red) and K562 (green) cells at σ=3.4 dyn/cm² and cₚ=1.5 μg/mL. The flow distribution is indicated by arrows. (C) Flow cytometric analysis of cell sorting. The initial cell mixture consisted of 39.1% HL60 cells. The output at outlet A comprised 95.0±2.8% HL60 cells, while that at outlet B comprised 94.3±0.9% K562 cells. Scale bar, 100 μm.

FIG. 26 illustrates flow visualization of a sorting channel with 1-μm fluorescent beads. The fluorescence images show the rotational pattern of the flow streams in a clockwise direction as viewed from the x-axis. Scale bar, 200 μm.

FIG. 27 shows the four PDMS layers (an injection layer, two sorting layers, and a collection layer) were aligned and assembled together after their exposure to oxygen plasma for 40 s. The photographs were three-dimensionally reconstructed for better illustration.

FIG. 28 shows geometry of a single microfluidic channel comprising the narrow focusing channel and the wide sorting channel. The pressure dump channels (100 μm in width) are connected at the end of a sorting channel so that most of the pressure drop occurs through them. Thereby, the dump channels maintain a uniform flow distribution at each outlet junction in the parallel channel circuit.

FIG. 29 shows adhesion of HL60 cells in the focusing channel. HL60 cells rolling in the focusing channel under steady state were counted from the images taken with a long exposure time where flowing cells could not be observed. Some HL60 cells could tether on the focusing ridges even at the high shear stresses over 30 dyn/cm² but could not sustain rolling. The flow rate of the cells being introduced into the channel was ˜100 to 220 cells/s. No channel clogging by the rolling cells was observed during separation. Error bars, s.d. (n=3).

FIG. 30 shows flow simulations. (A,B) Simulated velocity fields and vectors on xy cross-sections at positions of z=13 μm (A) and z=−18 μm (B), where the top surface of a sorting ridge was set to z=0 μm. Above the top surface of the ridges, the flow circulates from a sorting/gutter side to the focusing side, while within the trenches, the flow circulates in the opposite direction towards a sorting/gutter side. (C) Simulated streamlines over a sorting ridges. The side view image shows the streamlines projected along a sorting ridges, y′-axis. The color coding is used to denote the out-of-plane position of the streamlines Numerical simulations suggest that the flow streamlines are expected to be similar at the corner of the square post in FIG. 2C and the corner of the ridge. The gray regions denote a sorting ridges. hᵣ is the height of the SR. h_{g} is the gap between the top surfaces of the SR and the channel ceiling. Scale bars in A, B, and C, top, 200 μm. Scale bar in C, bottom, 60 μm.

FIG. 31 illustrates number of rolling HL60 cells exiting each trench (counted per min) in the P-selectin-coated device (see FIG. 3B). Mean lateral positions of the HL60 cells in the BSA-passivated channel at each trench in FIG. 3A are also shown (blue triangles).

FIG. 32 shows effect of the angle of a sorting ridge, θₛ and shear stress intensity on a sorting efficiencies of HL60. There is no observable variation of a sorting efficiency of HL60 cells with change in a sorting ridge angle. Error bars, s.d. (n=3).

FIG. 33 illustrates an exemplary cell rolling cytometer. (Top) Schematic of the microfluidic device in which cells are controllably contacted with adhesion entity-coated ridges and the adhesion of single cells is quantified via transit time, tₜ, and rolling trajectory, xᵣ. The red arrow indicates a schematic helical streamline (Bottom) Cross-section views of a bottom ridge. Without specific interactions a cell travels fastest through the channel, following the focusing trajectory. Specific adhesion interactions retard the cell and change its trajectory.

FIG. 34 shows transient cell adhesion of HL60 positive control cells which exhibit robust rolling on P-selectin. a) Trajectories of HL60 cells in (Top) BSA-passivated and (Middle) P-selectin-coated channels. Each circle represents the position of a cell and is colored by its velocity magnitude. (Bottom) Wall shear stress magnitude is plotted on the channel surfaces. Scale bar, 100 μm. b) Scatter plots of the transit time and lateral position of 394 cells in (Left) BSA-passivated and (Right) P-selectin-coated channels. The histograms were obtained from the vertical and lateral projection of the counts. c) Efficiency of HL60 cell adhesion in the cell rolling cytometer (CRC) and the control device with the flat chamber. d) Tethering frequency of HL60 cells on each ridge.

FIG. 35 shows quantification of dynamic adhesion of MSCs by transient ligand-receptor interactions. a) Scatter plots of the transit time and lateral position of 400 MSCs in (Left) IgG-passivated, (Middle) P-selectin-coated and (Right) E-selectin-coated channels. The histograms were obtained from the vertical projection of the counts. b) Efficiency of MSC adhesion in the cell rolling cytometer and the control device with the flat flow chamber. c) Effects of enzyme treatments on MSC rolling adhesion. Control rolling represents rolling of untreated MSCs. d) Effects of MSC differentiation on MSC rolling adhesion. *, p<0.01 (results are significantly different from the results for undifferentiated control; one-way ANOVA). Error bars show standard deviations (n=3). e) Histochemical staining was performed to assess differentiated adipogenic (Left, Oil Red O stain) and osteogenic cells (Right, alkaline phosphatase stain).

FIG. 36 shows a) scatter plots of the transit time and lateral position of 200 (Left) preadipocytes, (Middle) adipocytes, and (Right) osteoblasts in E-selectin-coated channels. b) Efficiency of cell adhesion in E-selectin-coated and IgG-passivated channels (n=3). c) Histochemical staining of preadipocytes and adipocytes with Oil Red O stain. d) Histochemical staining of osteoblasts with alkaline phosphatase stain.

FIG. 37 shows micrographs of a cell rolling cytometer. Only one inlet is enough for device operation, since cell focusing autonomously occurs by hydrophoresis. This design enables effective cell capture in the controlled area, the adhesion region and quantification of dynamic adhesion at the single cell level. Scale bars, 200 μm.

FIG. 38 shows flow cytometric analysis of P-selectin glycoprotein ligand-1 (PSGL-1) on HL60 cells. Blue line is isotype control, and red line is specific antibody.

FIG. 39 shows flow simulations. (a,b) Simulated velocity vectors on xy cross-sections at positions of z=5 μm (a) and z=28 μm (b), where the midplane of the channel was set to z=0 μm. (c) Simulated streamlines around the top ridges. Because of geometry symmetry, only top half the channel is shown here. The side view image shows the streamline projected along the ridges, y′-axis. hᵣ is the height of the ridge. h_{g} is the gap between the top and bottom ridges. Scale bars, 100 μm.

FIG. 40 illustrates effect of E-selectin incubation concentration on MSC rolling adhesion. Error bars show standard deviations (n=3).

FIG. 41 shows flow cytometric analysis of E-selectin ligand expression on human MSCs. Red lines represent target antibody reactivity and blue lines show the corresponding isotype control reactivity.

FIG. 42 shows exemplary scatter plots of the transit time and lateral position of 200 undifferentiated, adipogenic, and osteogenic MSCs in IgG-passivated and E-selectin coated channels.

FIG. 43 shows flow cytometric analysis of enzyme-treated HL60 cells. Red lines represent target antibody reactivity and blue lines show the corresponding isotype control reactivity.

FIG. 44 shows immunophenotype of human MSCs. MSCs expressed high levels of mesenchymal markers (CD73 and CD90), while lacking hematopoietic markers (CD34 and CD45). Red line represents target antibody reactivity, and blue lines show the corresponding isotype control reactivity.

FIG. 45 shows exemplary scatter plots of the transit time and lateral position of 200 preadipocytes, adipocytes, osteoblasts in IgG-passivated channels.

### DETAILED DESCRIPTION OF CERTAIN EMBODIMENTS

Methods for separating cells based on strong interactions with antibodies and transient interactions with cell adhesion entities have been described in the art. Antibody based systems tend to exhibit high capture rates. However, the recovery of target cells that have been captured using antibodies is difficult and tends to require invasive elution methods that can damage the target cells. Transient systems that are based on cell rolling using cell adhesion entities allow for easier recovery of target cells; however, conventional cell rolling systems exhibit lower capture efficiency and therefore require very long separation times or increased complexity to increase capture efficiency (e.g., see Karnik et al., Nano Lett. 2008, 8, (4), 1153-1158 and Lee et al., Langmuir 2011, 27, (1), 240-249).

### A. Methods and Devices

In general, provided devices and methods use a sorting channel that includes a three-dimensional structure (or three-dimensional structures) that is designed to separate cells based on differences in one or more physical properties (e.g., a difference in cell adhesion, or differences in cell adhesion and size). In some embodiments, part of all of such three-dimensional structures is/are coated with a cell adhesion entity so that target cells can roll on them.

In many embodiments, provided devices are arranged and constructed so that fluid sources containing target cells of interest are flowed into the flow cell channel, where they encounter and interact with one or more adhesion entities on one or more 3D structures, so that their trajectory through the flow cell channel is altered relative to the initial streamline. In particular, provided devices are arranged and constructed, and fluid is flowed through them, such that target cell interactions with cell adhesion entities result in cell rolling of target cells along an altered trajectory. For example, in some embodiments, target cells follow a trajectory that is different from the trajectory of the same cells without the presence of the coating. Advantageously, provided devices can be used to sort cell types that would otherwise follow the same trajectories in the absence of the coating (e.g., because the cell types have similar sizes).

In various embodiments, a device described herein includes one or more sorting channels that are parallelized and/or stacked with one or more units (e.g., sorting channels, focusing channels or other units).

In some embodiments, provided methods comprise using the devices to isolate at least one type of cell from others in a stream comprising a mixture of cell types. As used herein, the term “isolate” (and similarly the terms “separate” or “sort”) does not mean that the isolated target cells are 100% isolated from other non-target but simply that the cell mixture has experience some amount of enrichment as compared to the starting mixture. In certain embodiments the resulting mixture comprises at least 60% target cells, e.g., at least 70%, 80%, 85%, 90%, 95% or at least 99% target cells.

In some embodiments, separation of cells in a sorting channel may be based on differential rolling characteristics of at least one target cell as compared to non-target cells. In certain embodiments, target cells are cells that share a common characteristic that is recognized by cell adhesion entities coated on the three-dimensional structure(s). In general, target cells are diverted away from the direction of bulk flow by cell rolling, whereas non-target cells that are not recognized by cell adhesion entities do not roll and are not diverted from the direction of bulk flow. While the present disclosure refers generally to the diverted cells as “target cells” it will be appreciated that this is an arbitrary designation and that, in certain embodiments, separation of cells may be performed in a negative selection mode whereby the real “target cells” are in fact the cells that are not diverted.

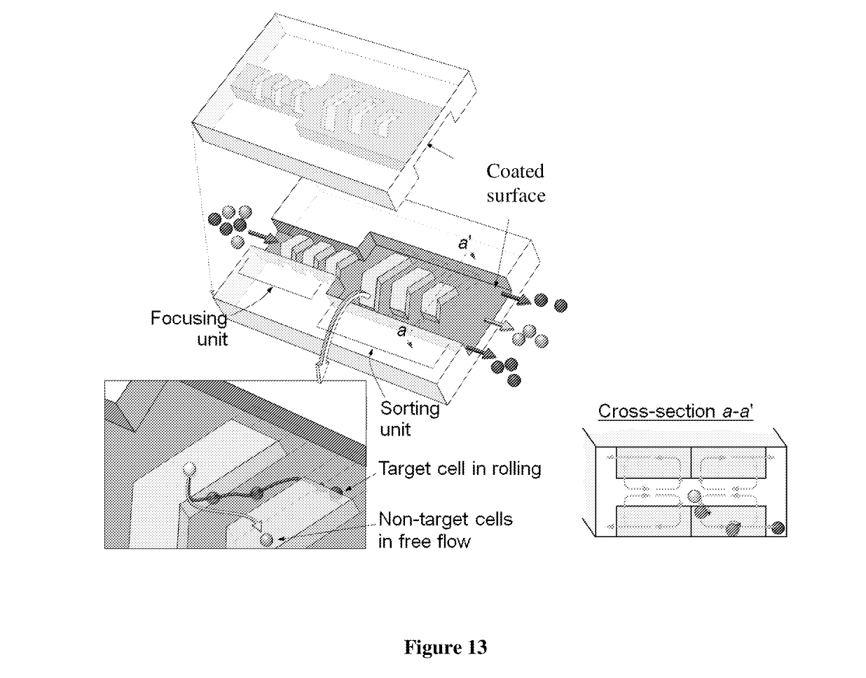

A sorting channel includes at least one inlet through which the target and non-target cells are introduced. In some embodiments, a sorting channel includes at least one outlet through which the target cells are collected and at least one outlet through with the non-target cells are collected. In certain embodiments, a longitudinal axis along the direction of bulk flow bisects both the inlet and the outlet through which non-target cells are collected (e.g., see FIGS. 13-15).

It will be appreciated that a provided device may include any number of inlets or outlets as may be required for a particular application. For example, in certain embodiments, a device may further comprise an additional inlet for introducing a stream free of cells (e.g., a buffer) into a sorting channel. A plurality of target cell outlets may also be useful, e.g., when it is desirable to collect subpopulations of target cells which are differentially separated as a result of flowing through a sorting channel. In some embodiments, provided devices contain and/or utilize a single inlet and/or a single outlet.

In some embodiments, inventive devices may be used in conjunction with other units and/or devices. For example, cells flowing out of an outlet of a sorting channel may flow into another device (which may be a secondary sorting channel or a device that sorts cells using a different approach, e.g., size based separation). Alternatively or additionally, devices may be fabricated such that a sorting channel receives (via an inlet) cells flowing from another device (which may be a primary sorting channel or a device that sorts cells using a different approach, e.g., size based separation). As discussed below, in certain embodiments it may be advantageous to include a focusing channel upstream of a sorting channel that focuses the incoming cells into a substantially linear flow of cells as they enter the sorting channel.

As discussed herein, target and/or non-target cells may be collected at one or more collection points along and/or at the end of their respective trajectories through the device. One or more outlets can be placed within the device for this purpose.

The dimensions of a sorting channel and 3D structures, the flow rate and the density (e.g., concentration) of the cell adhesion entities are all chosen so that target cells will roll on coated surfaces in the sorting channel (e.g., 3D structures). In some embodiments, 3D structures have a height that is taller than half the average diameter of cells (e.g., target cells).

In some embodiments, 3D structures are arranged and constructed within the flow cell channel so that cells are hydrophoretically focused. In some embodiments, 3D structures are arranged and constructed within the flow cell channels so that cells are sorted by determinative lateral displacement (e.g., based on size).

In some embodiments, 3D structures form an acute angle with the direction of bulk flow, i.e., the structures point downstream. Without wishing to be bound by any theory, such angle between structures and the direction of bulk flow is thought to cause repeated collisions between cells and the structures and thereby increase the chances that target cells will tether onto the coated surfaces and begin rolling. The angle also serves to divert the target cells laterally from the direction of bulk flow and thereby separate the target cells from non-target cells that do not roll on the coated surfaces.

In some embodiments, 3D structures are arranged and constructed within the flow cell channel so that at least two fluid streamlines are defined; in some such embodiments, interaction of target cells with cell adhesion entities on the 3D structures alters the trajectory of such cells from the first steam line to a second streamline Typically, such streamlines form at least a 5 degree angle with one another. In some embodiments, such streamlines form an angle of at least 10, 15, 20, 25, 30, 35, 40, 45, 50, 55, 60, 65, 70, 75, 80, 85, or 90 degrees with one another. In some embodiments, such streamlines intersect.

In some embodiments, 3D structures are arranged and constructed to define “trenches” or “grooves” between them along which target cells roll. In some embodiments, such channels have a direction different from that of bulk flow in the flow cell channel. In many embodiments, such channels have a width sufficient to permit target cells to traverse them (e.g., wider than the average target cell diameter), but optionally not sufficient to permit other cells potentially present to traverse them.

In some particular embodiments, provided devices comprise a flow cell channel having (e.g., by virtue of 3D structures therein) trenches or grooves that travel in a direction different from and/or at an angle with the direction of bulk fluid flow. In certain embodiments, target cells that roll on the coated structures roll into such trenches or grooves, and roll along them to a designated region, for example at a side walls of the flow cell channel. In certain embodiments, surface of such 3D structures are coated with cell adhesion entities in order to promote cell rolling.

In various embodiments, provided devices comprising a flow cell channel include 3D structures defining one or more trenches or grooves that ends before encountering the flow cell channel side wall, so that a gap is defined between at least one end of the 3D structures and the wall of the channel. Such a gap or “gutter”, in some embodiments, permits target (i.e., rolled) cells to continue travelling in the direction of bulk flow without rejoining non-target cells. In certain embodiments, the size of a gap between the side wall and structures increases (e.g., linearly) as the structures get further downstream. In certain embodiments, such an increase in size may serve to increase the likelihood that separated target cells remain in the “gutter” as they flow in the direction of bulk flow.

### Sorting Channel

In general, lithographic or other techniques known to those of skill in the art may be used to pattern practically any material for use as a flow channel (or focusing channel as discussed below). Exemplary methods for preparing suitable channels are disclosed in U.S. Pat. No. 6,197,575, U.S. Patent Publication No. 2010/0112026 and U.S. Patent Publication No. 2010/0304485 the entire contents of which are incorporated herein by reference. A flow channel described in various embodiments of the present disclosure can be a sorting channel. In some embodiments, a flow channel is a focusing channel or other units as discussed below.

In various embodiments, a flow channel may be fabricated from poly(dimethyl siloxane) (PDMS), glass, silicon dioxide, or a fluoropolymer. In certain embodiments, the walls of the channel may be treated with a material to modify hydrophilicity, protein affinity, cell affinity, or any combination of these. Exemplary treatment materials, include but are not limited to, polyethylene glycols (e.g., poly(3-trimethoxysilyl)-propylmethacrylate-r-poly(ethylene glycol) methyl ether or TMSMA-r-PEGMA), organosilanes that form self-assembled monolayers, ethanol, etc.

A sorting channel generally may be defined within a substrate (or between two substrates) by opposing side walls and opposing lower and, in some embodiments, upper surfaces. Without wishing to be bound by any particular theory, the height H_{S} of a sorting channel (i.e., the distance between lower and upper surfaces ignoring any microstructures or alternatively the height of the side walls) may influence cells being flowed through a sorting channel and their interaction with a coated structure within the channel. Thus, it may be desirable, in certain embodiments, to limit the height of a sorting channel. In certain embodiments, the height of a sorting channel may range from about 1 μm to about 1,000 μm (i.e., 1 mm) In certain embodiments, the height of a sorting channel may range from about 10 μm to about 750 μm. In certain embodiments, the height of a sorting channel may range from about 10 μm to about 500 μm. In certain embodiments, the height of a sorting channel may range from about 10 μm to about 200 μm. In certain embodiments, the height of a sorting channel is less than about 200 μm, less than about 100 μm, less than about 90 μm, less than about 80 μm, less than about 70 μm, less than about 60 μm, less than about 50 μm, less than about 40 μm, less than about 30 μm, less than about 20 μm, less than about 10 μm or less than about 1 μm. In certain embodiments the height of a sorting channel may range in between any of these values. The height may but is not necessarily uniform along the length of a sorting channel.

In some embodiments, a sorting channel may be constructed by creating channels in the top surface of two substrates that are then placed in opposition. In certain embodiments, a sorting channel may be constructed by creating a channel in the top surface of a single substrate and then placing another substrate with a flat surface over the open channel.

In some embodiments, a sorting channel comprises a longitudinal axis defined along the lower and upper surfaces and parallel to the side walls. A sorting channel also comprises a width W_{S} between the side walls. In certain embodiments, the width of a sorting channel may range from about 1 μm to about 5 mm. In certain embodiments, the width of a sorting channel may range from about 50 μm to about 3 mm. In certain embodiments, the width of a sorting channel may range from about 50 μm to about 1 mm. In certain embodiments, the width of a sorting channel may range from about 50 μm to about 500 μm. In certain embodiments, the width of a sorting channel may range from about 500 μm to about 5 mm. In certain embodiments, the width of a sorting channel may range from about 1 mm to about 2 mm. In certain embodiments, the width of a sorting channel may range from about 1 mm to about 1.5 mm. In certain embodiments, the width of a sorting channel may range from about 1 mm to about 5 mm. In certain embodiments, the width may be greater than about 50 μm, greater than about 100 μm, greater than about 200 μm, greater than about 300 μm, greater than about 400 μm, greater than about 500 μm, greater than about 600 μm, greater than about 700 μm, greater than about 800 μm, greater than about 900 μm, greater than about 1 mm, greater than about 2 mm, greater than about 3 mm, greater than about 4 mm, or greater than about 5 mm. In certain embodiments, the width may be less than about 100 μm, less than about 200 μm, less than about 300 μm, less than about 400 μm, less than about 500 μm, less than about 600 μm, less than about 700 μm, less than about 800 μm, less than about 900 μm, less than about 1 mm, less than about 2 mm, less than about 3 mm, less than about 4 mm, or less than about 5 mm. In certain embodiments the width of a sorting channel may range in between any of these values. The width may is not necessarily uniform along the length of a sorting channel.

### 3D Structures

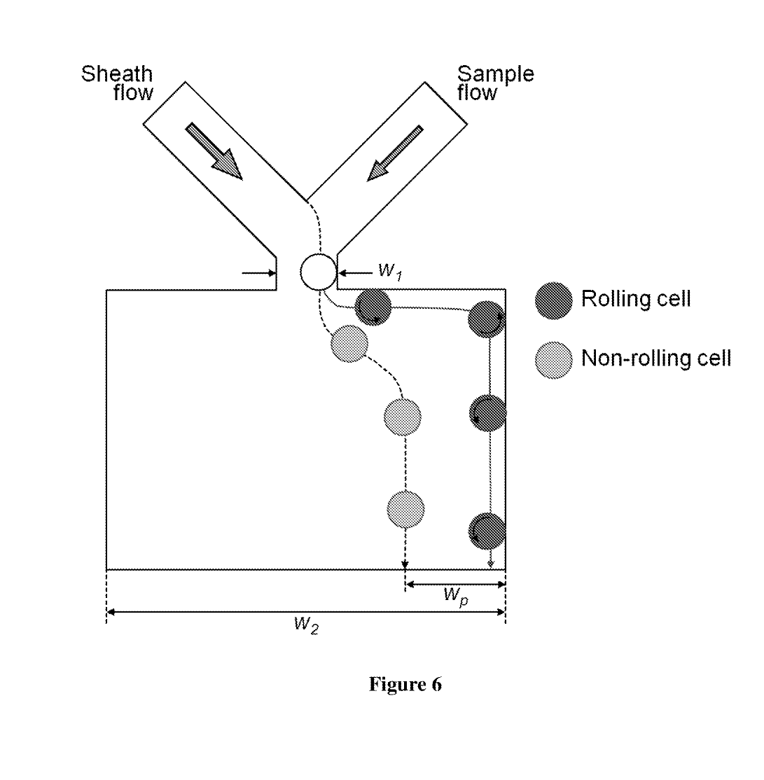

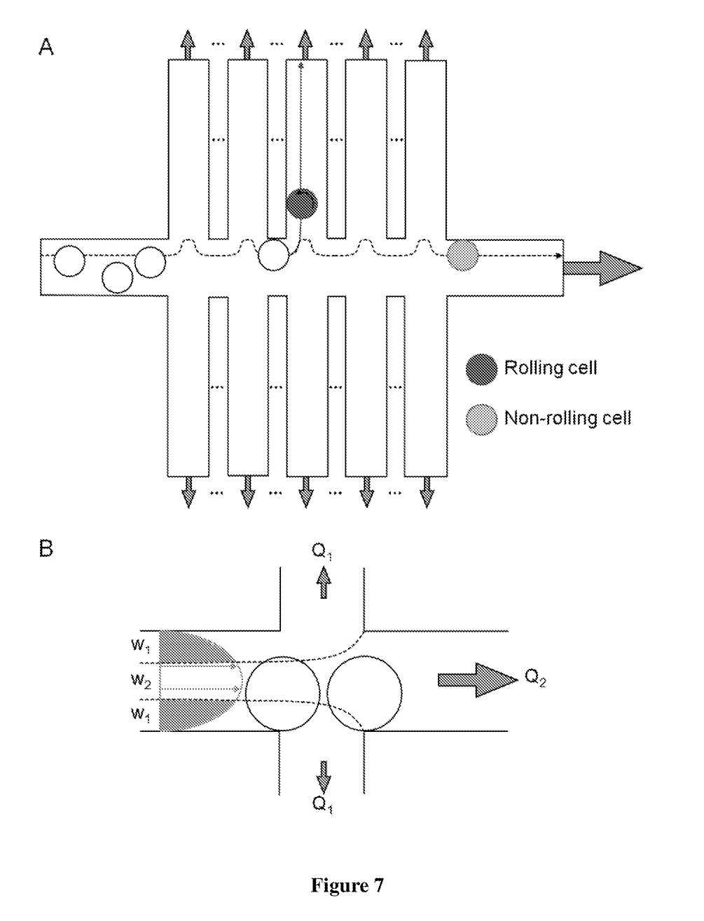

As noted above, a sorting channel for use in accordance with the present invention includes one or more 3D structures. In some embodiments, one or more 3D structures protrude from the lower surface of a channel; in some embodiments, one or more 3D structures protrude from an upper surface of a channel; in some embodiments, both lower and upper surfaces have protrusions. In some particular embodiments (see, e.g., FIGS. 6 and 7), channel walls can be considered to be 3D structures protruding from the lower (and/or upper) surface. In various embodiments, 3D structures are microstructures. In some embodiments, 3D structures are obstacles. In some such embodiments, obstacles are positioned so as to disrupt or interrupt fluid flow through the channel. 3D structures generally can be of any shape. In some embodiments, 3D structures in a flow channel have the same shape. In some embodiments, 3D structures in a flow channel have difference shapes.

3D structures comprise a longitudinal axis defined across the width of a sorting channel that forms an acute angle α_{S} with the longitudinal axis of a sorting channel. 3D structures may have a width W_{M} which is less than W_{S} thereby defining a gap between the 3D structures and at least one of the side walls. 3D structures may have a height H_{M} which is less than H_{S} thereby defining a clearance over or under the microstructures. In certain embodiments, 3D structures protrude from both the lower and upper surface of a sorting channel. In certain embodiments, 3D structures that protrude from the lower surface are positioned directly below the 3D structures that protrude from the upper surface. In certain embodiments, 3D structures that protrude from the lower surface are not positioned directly below the 3D structures that protrude from the upper surface. In certain embodiments, the 3D structures protrude from the lower and upper surfaces in an alternating fashion.

In some embodiments, the dimensions of a sorting channel and 3D structures are such that when a stream of target and non-target cells is flowed along the direction of the longitudinal axis of the sorting channel under conditions that permit cell rolling, target cells are diverted laterally from the direction of the longitudinal axis and into the gap between the microstructures and at least one of the side walls as a result of rolling on the microstructures.

A 3D structure can be any type of protrusion from an internal surface (e.g., lower surface and/or upper surface) of a sorting channel. Generally 3D structures will have a width across a sorting channel that is sufficient to generate the necessary collisions with the flowing cells and also divert the rolling cells away from the direction of bulk flow. 3D structures may have any cross-section, e.g., without limitation, square, rectangle, triangle, trapezoid, hexagon, tear-drop, polygon, ellipse, circle, arc, wave, and/or combinations thereof. A 3D structure used in accordance with the present disclosure may be substantially linear and/or may comprise a curved portion. In certain embodiments, a 3D structure may include both linear and curved portions. In certain embodiments, 3D structures are substantially parallel to each other.

Depending on the length (L_{S}) of a sorting channel, a plurality of 3D structures can be arranged in a sorting channel. In some embodiments, a sorting channel comprises about 10, about 20, about 30, about 40, about 50, about 60, about 70, about 80, about 90, or about 100 3D structures. In some embodiments, a sorting channel has at least about 10, at least about 20, at least about 30, at least about 40, at least about 50, or at least about 60 3D structures. In some embodiments, a sorting channel comprises less than about 100, less than about 90, less than about 80, less than about 70, less than about 60, less than about 50, less than about 40, less than about 30, or less than about 20 3D structures. In some embodiments, the number of 3D structures in a sorting channel may be in a range between any two of these values. In certain embodiments, the number of 3D structures may be in a range of about 10 to about 80, about 20 to about 50, or about 30 to about 40.

Depending on the width of a sorting channel, a 3D structure may have a width W_{M} that is between about 1 μm and about 5,000 μm (i.e., 5 mm), for example, between 10 μm and 3 mm, between 100 μm and 2 mm, between 500 μm and 1.5 mm, or between 800 μm and 1 mm. In some embodiments, W_{M} is at least about 10 μm, at least about 100 μm, at least about 200 μm, at least about 300 μm, at least about 500 μm, at least about 800 μm, or at least about 1 mm. In some embodiments, W_{M} is less than about 5 mm, less than about 3 mm, less than about 2 mm, less than about 1 mm, less than about 800 μm, less than about 500 μm, or less than about 30 μm. In some embodiments, W_{M} may be in a range between any two of these values.

Depending on the height of a sorting channel, a 3D structure may have a height H_{M} that is between about 1 μm and about 1,000 μm (i.e., 1 mm), for example, between 1 and 10 μm, between 10 and 100 μm, between 100 and 500 μm, or between 500 μm and 1 mm. In some embodiments, H_{M} is at least about 10 μm, at least about 20 μm, at least about 30 μm, at least about 40 μm, at least about 50 μm, at least about 60 μm, at least about 70 μm, at least about 80 μm, at least about 90 μm, at least about 100 μm, at least about 200 μm, at least about 500 μm, or at least about 800 μm. In some embodiments, H_{M} is less than about 800 μm, less than about 500 μm, less than about 200 μm, less than about 100 μm, less than about 90 μm, less than about 80 μm, less than about 70 μm, less than about 60 μm, less than about 50 μm, less than about 40 μm, less than about 30 μm, or less than about 20 μm. In some embodiments, H_{M} may be in a range between any two of these values.

In some embodiments, a region between adjacent 3D structures (also called the trench or groove herein) has a height determined by H_{M}. Such a height of trenches or grooves, in certain embodiments, can be greater than half the average cell diameter of cells in a cell stream that is flowed through a device used in accordance with the present disclosure. The cells in various embodiments are target cells. In certain embodiments, such a height is greater than about 1 time, about 2 times, about 3 times, about 4 times, or 5 times the average cell diameter of cells in a cell stream. In some embodiments, if a stream of cells having a diameter in a range of D_{L} (lower limit) and D_{U} (upper limit) is flowed through a sorting channel, the region may be constructed so that it has a dimension greater than 1 D_{U}, greater than 2 D_{U}, greater than 3 D_{U}, greater than 4 D_{U}, or greater than 5 D_{U}.

In some embodiments, the clearance (H_{C}) over or under the 3D structures is as defined herein. As discussed previously, if a sorting channel only includes 3D structures on its lower surface (or only on its upper surface) then the clearance will be the distance between the top of the 3D structures and the upper surface of a sorting channel (or the bottom of the 3D structures and the lower surface of a sorting channel). If a sorting channel includes 3D structures on both lower and upper surfaces then the clearance may still be the distance between the top of the 3D structures and the upper surface of the sorting channel (or the distance between the bottom of the 3D structures and the lower surface of the sorting channel), e.g., if the 3D structures alternate between being on the lower and upper surfaces. Alternatively if the 3D structures are on both surface and facing each other then the clearance may be the distance between opposing 3D structures.

In some embodiments, the clearance may be less than 10 μm, 15 μm, 20 μm, 30 μm, 40 μm, 50 μm, 60 μm, 70 μm, 80 μm, 90 μm, 100 μm, 150 μm or 200 μm. In certain embodiments, the clearance may be greater than 1 μm, 2 μm, 3 μm, 4 μm, 5 μm, 6 μm, 7 μm, 8 μm, 9 μm, 10 μm, 20 μm, 30 μm or 50 μm. In certain embodiments, the clearance may be in a range between of any two of these values. For example, in certain embodiments the clearance is in the range of about 4 to about 100 μm, e.g., about 10 to about 60 μm. In certain embodiments, the clearance is less than about 30 μm. In certain embodiments, the dimensions of the clearance is selected based on cell size. For example, if a stream of cells having a diameter in a range of D_{L} and D_{U} is flowed through a sorting channel, then, in certain embodiments the clearance may have a dimension in a range between D_{U} and 2.5*D_{L}. In certain embodiments, target cells have an average diameter, such a clearance is in a range of about the average diameter and 2.5 times of that. In certain embodiments, such a clearance is less than 0.5 times of the channel height. In certain embodiments, such a clearance is less than a trench depth. The trench depth in certain embodiments can be determined by the height of 3D structures.

As noted above, 3D structures of a device described herein are coated with cell adhesion entities. It is to be understood that the density and patterning of the coating may be adjusted depending on the nature of the device, the cell adhesion entity and the target cell type. In certain embodiments the entire surface of 3D structures is coated.

In some embodiments, if 3D structures protrude from only the lower surface of a sorting channel it may be advantageous to also coat regions of the lower surface that are located in between the 3D structures. This may facilitate cell rolling once the target cells have been rolled from 3D structures into that region. It may also facilitate the manufacturing of a device described herein by removing the need for selective coating of certain structures. In certain embodiments the entire lower surface of a sorting channel (i.e., including the gutter, etc.) is coated with a cell adhesion entity. The same can apply if 3D structures were only present on the upper surface of a sorting channel.

In some embodiments, if 3D structures protrude from both the lower and upper surfaces of a sorting channel it may be advantageous to also coat regions of the lower and upper surface that are located in between the 3D structures. In certain embodiments the entire lower and upper surfaces of a sorting channel (i.e., including the gutter, etc.) are coated with a cell adhesion entity.

### Microstructures

According to some embodiments of the present disclosure, a sorting channel includes a series of lateral microstructures protruding from one or both of the lower and upper surfaces of a sorting channel that are coated with a cell adhesion entity.

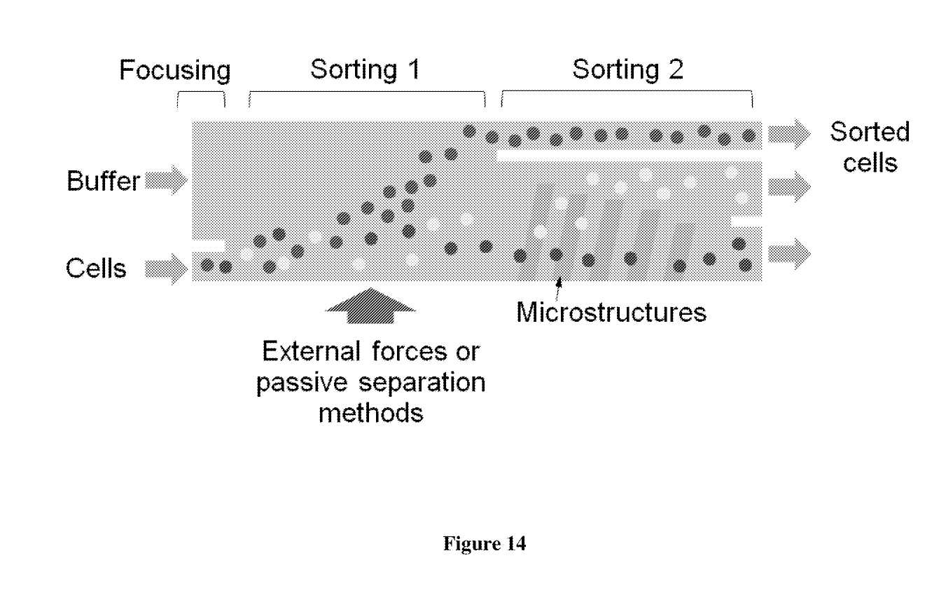

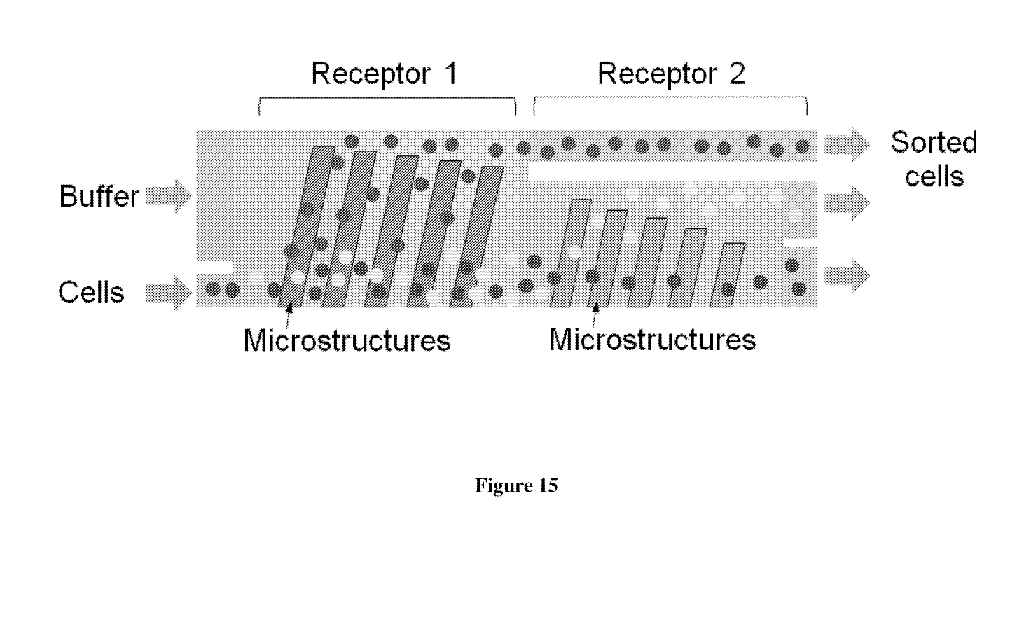

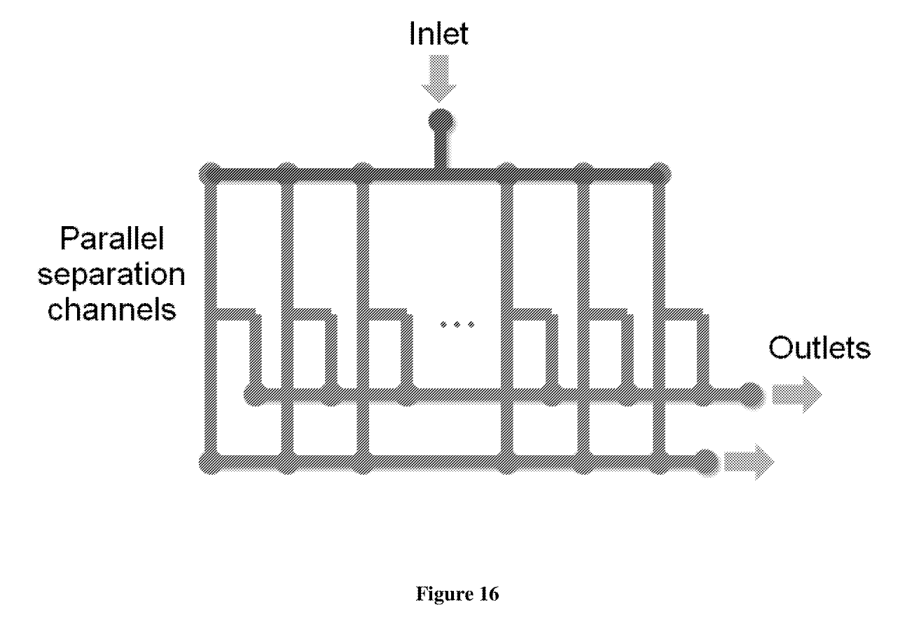

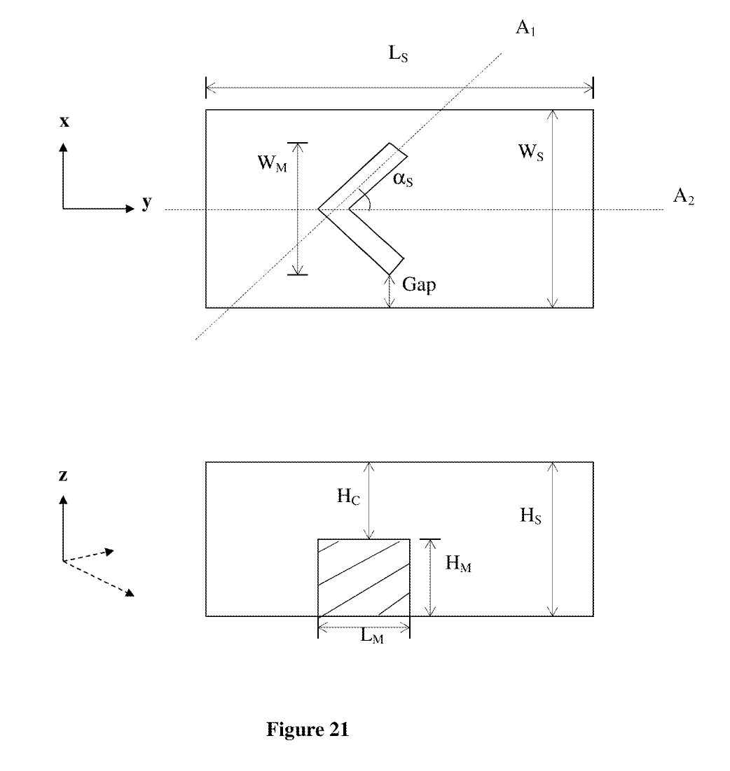

A microstructure can be asymmetric or symmetric relative to the direction of bulk flow. In some embodiments, the microstructures may be three-dimensional parallelograms as shown in FIGS. 14 and 15. In some embodiments, the microstructures can be V-shaped as shown in FIG. 13. Top-view and side-view schematics of such an exemplary sorting channel with V-shaped microstructures are also shown in FIG. 21. For example, V-shaped microstructures that were described in Choi et al, Small 2008, 4(5):634-641 (the contents of which are incorporated herein by reference), can be used as microstructures in accordance with the present disclosure. In certain embodiments, these V-shaped microstructures have the added benefit of focusing the non-target cells along the direction of bulk flow by hydrophoresis.

In some embodiments, microstructure may have a cross-section with a length (L_{M}) along a longitudinal axis of the separator channel is between about 1 μm and about 1 mm, for example, between 1 and 10 μm, between 10 and 100 μm, between 100 and 500 μm, or between 500 μm and 1 mm. In certain embodiments the length is at least about 10 μm, at least about 50 μm or at least about 100 μm.

In some embodiments, the spacing between adjacent microstructures along a longitudinal axis of the separator channel is between about 1 μm and about 1 mm, for example, between 1 and 10 μm, between 10 and 100 μm, between 100 and 500 μm, or between 500 μm and 1 mm. In certain embodiments the spacing is at least about 10 μm, at least about 50 μm or at least about 100 μm.

It will be appreciated that the optimal dimensions for a specific device may be adjusted depending on the type of cell being targeted and/or the intended use of the device.

As noted above, microstructures comprise a longitudinal axis defined across the width of a sorting channel that forms an acute angle α_{S} with the longitudinal axis of the sorting channel. In certain embodiments, α_{S} is at least 5 degrees. In certain embodiments, α_{S} may be at least 10 degrees, at least 12 degrees, at least 15 degrees, at least 16 degrees, at least 17 degrees, at least 18 degrees, at least 19 degrees, or at least 20 degrees. In certain embodiments, α_{S} may be less than about 80 degrees, less than about 75 degrees, less than about 70 degrees, less than about 65 degrees, less than about 60 degrees, less than about 55 degrees, less than about 50 degrees, less than about 45 degrees, less than about 40 degrees, less than about 35 degrees, less than about 30 degrees, less than about 25 degrees, less than about 20 degrees, less than about 15 degrees or less than about 10 degrees. In certain embodiments, α_{S} may be in a range between any two of these values. For example, in certain embodiments acute angle α_{S} may range from about 15 to about 60 degrees, e.g., from about 25 to about 50 degrees or from about 20 to about 45 degrees. In certain embodiments, two or more microstructures may each form a different acute angle α_{S} with the longitudinal axis of a sorting channel.

In some embodiments, a region between adjacent microstructures (also called the trench or groove herein) has a dimension in the direction of bulk flow that is greater than 1 μm, 2 μm, 5 μm, 10 μm, 15 μm, 20 μm, 30 μm, 40 μm, 50 μm, 60 μm, 70 μm, 80 μm, 90 μm, 100 μm, 150 μm or greater than 200 μm. In certain embodiments, a region between adjacent microstructures has a dimension in the direction of bulk flow that is in a range between of any two of these values. In certain embodiments, the dimensions of the region between adjacent microstructures is selected so that two or more cells can be present with minimal cell-cell interactions. For example, this can be achieved by ensuring that the region has a dimension in the direction of bulk flow that is at least 1, 2, 3, 4, or 5 times larger than the largest cell diameter. In certain embodiments, if a stream of cells having a diameter in a range of D_{L} (lower limit) and D_{U} (upper limit) is flowed through a sorting channel, the region may be constructed so that it has a dimension greater than 1 D_{U}, greater than 2 D_{U}, greater than 3 D_{U}, greater than 4 D_{U}, or greater than 5 D_{U}.

As noted above, the width of microstructures across a sorting channel is such that there is a gap between the microstructures and at least one of the side walls. Without wishing to be bound by any theory, this gap provides an escape route or “gutter” for target cells that have been deflected away from the direction of bulk flow. In certain embodiments, this gap may increase as the microstructures move downstream (e.g., as shown in FIGS. 13-15). Without limitation this may ensure that target cells do not encounter another downstream microstructure once they have been deflected away from the direction of bulk flow. In certain embodiments the size of the gap may lie within one of the ranges provided above for the clearance. For example, in certain embodiments the gap is in the range of about 4 to about 100 μm, e.g., about 10 to about 60 μm. In certain embodiments, the gap is less than about 30 μm.

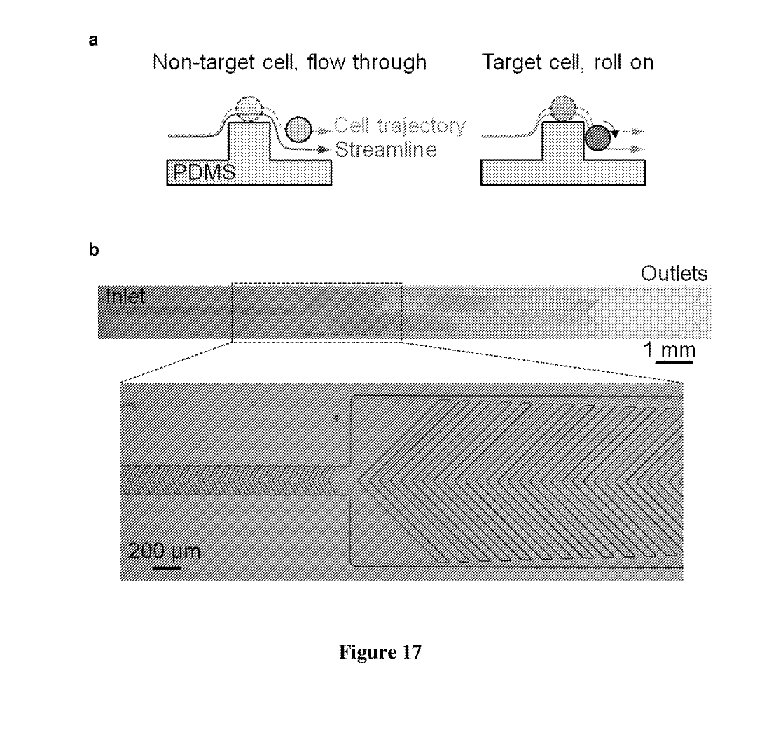

As shown in FIGS. 13 and 17, in certain embodiments, microstructures are V-shaped and the longitudinal axis of a sorting channel bisects the microstructures. According to such embodiments, a gap may exist between the microstructures and both of the side walls of a sorting channel. In certain embodiments, the inlet and the outlet through which non-target cells are collected are both aligned with the apex of the V-shaped microstructures. According to such embodiments it may be advantageous to include two outlets through which target cells are collected that are adjacent to the two side walls (e.g., as shown in FIGS. 13 and 17).

As shown in FIGS. 14 and 15, when the microstructures are three-dimensional parallelograms or another substantially linear geometry a gap may only exist between the microstructures and one of the side walls. According to such embodiments it may be advantageous to place an outlet through which target cells are collected adjacent to the side wall with the gap. It may also prove advantageous to place the inlet and the outlet through which non-target cells are collected adjacent to the side wall without the gap.

In addition to cell rolling or alternatively, a sorting channel used in accordance with the present disclosure may utilize microfluidic geometries to change cell flow. For example, a sorting channel focuses the target and non-target cells in the stream by hydrodynamics whereby the cells flow into the desired position (e.g., channel center) by guiding them with sheath flows. In some embodiments, a variety of techniques that have been developed to sort cells (e.g., ones based on size) can be used for geometry-directed cell rolling. Such techniques include, but are not limited to, deterministic lateral displacement, hydrodynamic focusing, and hydrodynamic filtration. These exemplary techniques are discussed in more detail below.

Deterministic Lateral Displacement

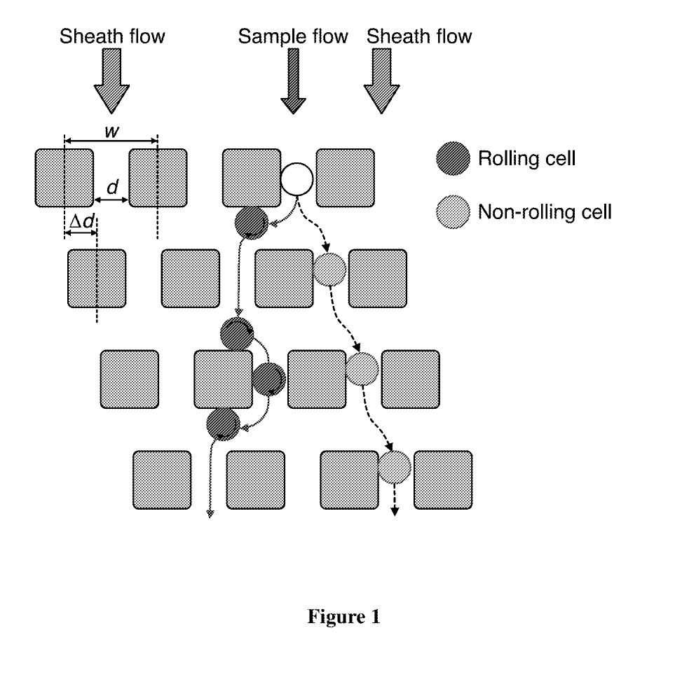

In some embodiments, a sorting channel achieves and/or relies on deterministic lateral displacement (DLD) to separate cells. In some embodiments, shapes and spatial arrangement selected to achieve deterministic lateral displacement. DLD is a microfluidic particle separation technique that uses arrays of obstacles and has been used for size separation of cells, droplets and DNA. In general, a critical diameter for separation is described by D_{c}=2ηdε, where η is a unit-less parameter, d is the distance between the edges of adjacent obstacles and ε is the row shift fraction (see, for example, Huang et al., Science 2004, 304, (5673), 987-990; see also FIG. 1). ε is defined as ε=Δd/W, where W is the distance from center to center of two adjacent obstacles in the same row and Δd is the lateral shift between two adjacent obstacles in successive rows (see FIG. 1). Particles (e.g., cells) that are larger than D_{c} are forced to move at an angle relative to the direction of bulk flow by repetitively bumping against the obstacles (see non-rolling cell in FIG. 1). The repetitive bumping can be advantageously used in the context of the present disclosure to promote interactions between cells and surfaces of the obstacles that are coated with a cell adhesion entity.

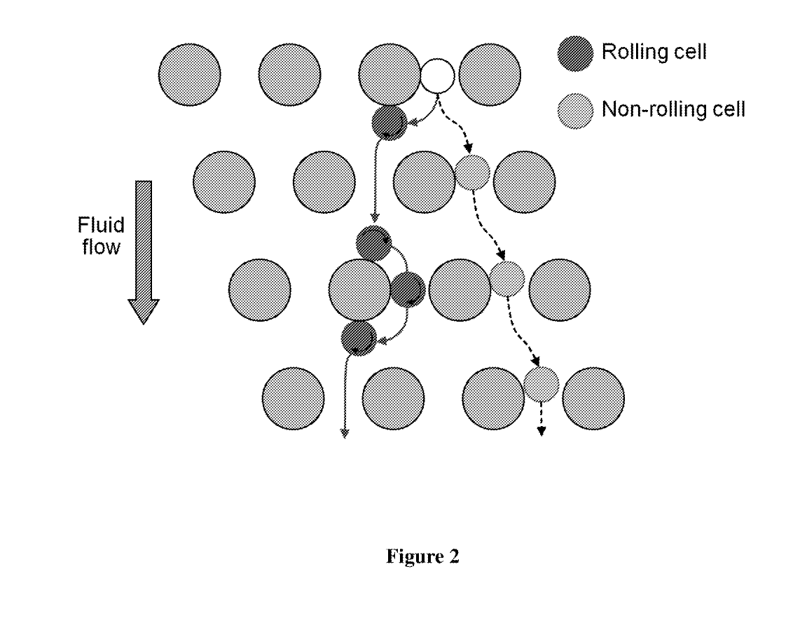

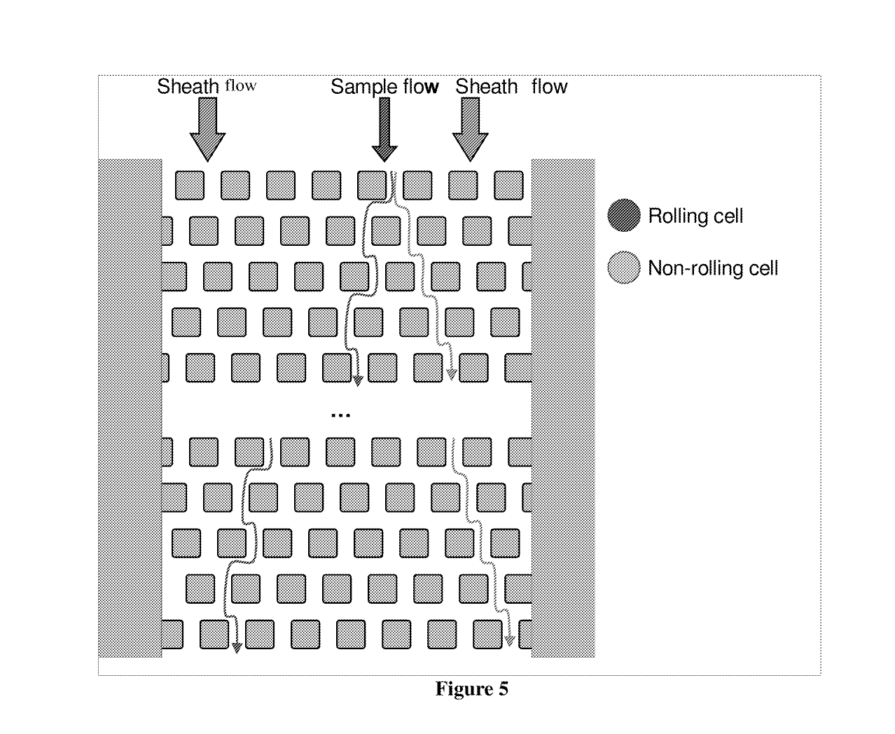

Obstacles in the array are typically protrusions from an internal surface (e.g., lower surface, upper surface, side walls or combination thereof) of a sorting channel. In certain embodiments, protrusions span the distance between the lower and upper surface of a sorting channel. An obstacle may have any shape, e.g., without limitation, squares, rectangles, triangles, trapezoids, hexagons, tear-drops, polygons, ellipses, circles, arcs, waves, and/or combinations thereof. For example, as demonstrated in Examples and FIG. 1, a square obstacle can be used. Additionally or alternatively, other shapes such as circular, triangular, trapezoidal, hexagonal, and tear-drop obstacles can be used for geometry-directed rolling in DLD devices (see FIGS. 2 to 4). In certain embodiments, obstacles can be densely packed in a device to increase separation resolution (see FIG. 5).

In some embodiments, obstacles can have a cross-sectional dimension (e.g., diameter or width) between about 1 μm and about 1,000 μm (e.g., 1 mm), for example, between 1 and 10 μm, between 10 and 100 μm, between 100 and 500 μm, or between 500 μm and 1 mm. In certain embodiments, an obstacle can have a diameter about 1 μm to about 10 μm, about 10 μm to about 20 μm, about 20 μm to about 30 μm, about 30 μm to about 40 μm, about 40 μm to about 50 μm, about 50 μm to about 60 μm, about 60 μm to about 70 μm, about 70 μm to about 80 μm, about 80 μm to about 90 μm, or about 90 μm to about 100 μm. In certain embodiments, the obstacles have a height that is between about 1 μm and about 1,000 μm (e.g., 1 mm), for example, between 1 and 10 μm, between 10 and 100 μm, between 100 and 500 μm, or between 500 μm and 1 mm. In certain embodiments the obstacles have a height that corresponds to the height of a sorting channel side walls. It will be appreciated that the optimal dimensions for a specific device may be adjusted depending on the type of cell being targeted and/or the intended use of the device.

In various embodiments, obstacles in the array are coated with a cell adhesion entity, so that a target cell can tether and roll on the obstacles (e.g., see FIG. 1). Such a geometry-directed rolling can cause the deviation of a cell trajectory from its original flow direction. In particular a target cell that would move at a given angle in the absence of cell adhesion entities can be directed to move at a different angle when cell adhesion entities are present.

In some embodiments, the device is designed for use with cells that have an average diameter D and the critical diameter D_{c} is designed to be less than D. The cells in various embodiments are target cells. In certain embodiments, a sorting channel may have a critical diameter D_{c} that is less than 100 μm, 90 μm, 80 μm, 70 μm, 60 μm, 50 μm, 40 μm, 30 μm, 20 μm, or less than 10 μm. In certain embodiments, a sorting channel may have a critical diameter D_{c} that is greater than 1 μm, 2 μm, 3 μm, 4 μm, 5 μm, 6 μm, 7 μm, 8 μm, 9 μm, 10 μm, 20 μm or greater than 30 μm. In certain embodiments, a sorting channel may have a critical diameter D_{c} in a range that is between any two of these values. For example, in certain embodiments, a sorting channel may have a critical diameter D_{c} in the range of about 4 μm to about 50 μm, e.g., about 10 μm to about 50 μm, about 10 μm to about 30 μm, etc.

Hydrodynamic Focusing

In some embodiments, a sorting channel utilizes hydrodynamic focusing to separate cells. Generally, a sorting channel that relies on hydrodynamic focusing will comprise a constriction region and an expansion region. Hydrodynamic focusing works by forcing cells to line up single file along the longitudinal direction by covering a sample flow with a sheath flow (e.g., see FIG. 6). As shown in FIG. 6, in certain embodiments of the present disclosure, the position of a cell in the expansion region (in the absence of cell rolling) can be determined by Wₚ=(W₂/W₁)d, where d is the diameter of the cell, W₁ is the width of the constriction region and W₂ is the width of the expansion region. Typically, the sheath flow forces cells to contact with a side wall of the constriction region and in the context of the present disclosure this can be used to promote interactions between cells and a surface of the side wall that is coated with a cell adhesion entity. As shown in FIG. 6, the presence of a coating can cause a cell that would otherwise reach the expansion region at position Wₚ to roll along the side wall of the expansion region and exit at a different position in the expansion region. It will be appreciated that the specific dimensions W₁ and W₂ as well as the flow velocities of the sheath and sample flows can be adjusted depending on the nature of the cells that are being sorted and the nature of the coating.

Hydrodynamic Filtration

In some embodiments, a sorting channel utilizes hydrodynamic filtration to separate cells. Hydrodynamic filtration, also known as a “microfluidic particle separation technique” has been used for size separation of cells and particles (see, for example, Yamada et al., Lab Chip 2005, 5, (11), 1233-1239). As shown in FIG. 7A, a sorting channel that relies on hydrodynamic filtration can comprise a main channel and a plurality of side channels. As shown in FIG. 7B, at a branch between the main and side channels, the flow rate ratio, Q₁/Q₂ determines whether particles (e.g., cells) continue to flow through the main channel or exit into a side channel. Generally, in the absence of cell rolling, cells that are larger than 2W₁ are forced to flow through the main channel, not the side channel by repetitively aligning against a sidewall (see FIG. 7B, where W₁ is the width of the main channel stream that flows out of the side channels).

In the context of the present disclosure, such repetitive alignment can be used to promote interactions between cells and surfaces of the channel walls that are coated with a cell adhesion entity. Advantageously, cells that would normally continue to travel down the main channel can be caused to roll into the side channel as shown in FIG. 7A. In certain embodiments, a sidewall of the main channel is therefore coated with a cell adhesion entity, so that a target cell can tether and roll on the sidewall. In certain embodiments, the dimensions of the main and side channels are such that cells with a diameter D that is greater than 2W₁ are directed into a side channel as a result of cell rolling. In certain embodiments, a sorting channel may have a side stream width W₁ that is less than 50 μm, 45 μm, 40 μm, 35 μm, 30 μm, 25 μm, 20 μm, 15 μm, 10 μm, or less than 5 μm. In certain embodiments, a sorting channel may have a side stream width W₁ that is greater than 1 μm, 2 μm, 3 μm, 4 μm, 5 μm, 6 μm, 7 μm, 8 μm, 9 μm, 10 μm, 15 μm or 20 μm. In certain embodiments, a sorting channel may have a side stream width W₁ in a range that is between any two of these values. For example, in certain embodiments, a sorting channel may have a side stream width W₁ in the range of about 2 μm to about 25 μm, e.g., about 5 μm to about 15 μm, about 5 μm to about 25 μm, etc.

### Focusing Channel

In many embodiments, a device may comprise a focusing channel upstream of a sorting channel that is capable of aligning target and non-target cells in the stream before they enter a sorting channel. A focusing channel, in some embodiments, may include 3D structures similar to a sorting channel described herein. In some embodiments, the stream of target and non-target cells is aligned along the direction of the longitudinal axis of a sorting channel.

In some embodiments, a focusing channel focuses the target and non-target cells in the stream by hydrophoresis. As demonstrated in the literature, (e.g., see Choi et al., Small 2008, 4, (5), 634-641 and Choi et al., Anal. Chem. 2008, 80, (8), 3035-3039), cells inside such a focusing channel are subject to rotational flows induced by a series of angled 3D structures (e.g., a series of V-shaped or linear microstructures as shown in Examples). For example, as illustrated in Example 2, a focusing channel may be defined by opposing side walls and opposing lower and upper surfaces and comprise a series of V-shaped microstructures protruding from one or both of the lower and upper surfaces of the sorting channel. In some embodiments, there are no gaps between microstructures and the side walls of a focusing channel in order to promote focusing of target and non-target cells by hydrophoresis.

In some embodiments, the side walls of a focusing channel may have the same height as the side walls of a sorting channel.

In some embodiments the width W_{F} between the side walls of a focusing channel is less than W_{S} in order to increase the shear stress on the cells. In certain embodiments, the width W_{F} between the side walls of a focusing channel is less than about 0.5*W_{S}. In certain embodiments, the width W_{F} between the side walls of a focusing channel is less than about 0.25*W_{S}. In certain embodiments, a focusing channel may have a width W_{F} between the side walls that ranges from about 1 μm to about 1,000 μm (i.e., 1 mm) In certain embodiments, the width is less than about 200 μm, less than about 100 μm, less than about 90 μm, less than about 80 μm, less than about 70 μm, less than about 60 μm, less than about 50 μm, less than about 40 μm, less than about 30 μm, less than about 20 μm, less than about 10 μm or less than about 1 μm. The width may not be uniform through the length of a focusing channel. For example, the width may vary across the length of a focusing channel in steps.

In some embodiments, a focusing channel can be designed with such a narrower width so that it too can be coated with a cell adhesion entity yet not support cell rolling because of the high shear stress. In certain embodiments, 3D structures of a focusing channel and optionally the lower and/or upper surfaces from which they protrude are coated with a cell adhesion entity. It will be appreciated that this may advantageously facilitate the manufacturing process of a device that includes a focusing channel and a sorting channel.

In some embodiments, 3D structures of a focusing channel form an acute angle α_{F} with the longitudinal axis of a focusing channel that is larger than α_{S}. In certain embodiments, 3D structures of a focusing channel form an acute angle α_{F} with the longitudinal axis of the focusing channel that is at least 5 degrees. In certain embodiments, α_{F} may be at least 10 degrees, at least 12 degrees, at least 15 degrees, at least 16 degrees, at least 17 degrees, at least 18 degrees, at least 19 degrees, or at least 20 degrees. In certain embodiments, α_{F} may be less than about 80 degrees, less than about 75 degrees, less than about 70 degrees, less than about 65 degrees, less than about 60 degrees, less than about 55 degrees, less than about 50 degrees, less than about 45 degrees, less than about 40 degrees, less than about 35 degrees, less than about 30 degrees, less than about 25 degrees, less than about 20 degrees, less than about 15 degrees or less than about 10 degrees. In certain embodiments, α_{F} may be in a range between any two of these values. For example, in certain embodiments acute angle α_{F} may range from about 25 to about 85 degrees, e.g., from about 25 to about 75 degrees or from about 45 to about 65 degrees. In certain embodiments, two or more 3D structures of a focusing channel may each form a different acute angle α_{F} with the longitudinal axis of the focusing channel.

In some embodiments, a focusing channel focuses the target and non-target cells in the stream by hydrodynamics whereby the cells flow into the desired position (e.g., channel center) by guiding them with sheath flows. In addition or alternatively, sheathless focusing techniques can be used in a focusing channel, e.g., by employing dielectrophoretic forces (see, for example, Yu et al., J. Microelectromech. Syst. 2005, 14, (3), 480-487), inertial forces (see, for example, Di Carlo et al., Proc. Natl. Acad. Sci. U.S.A. 2008, 104, (48), 18892-18897), acoustic forces (see, for example, Shi et al., Lab Chip 2008, 8, (2), 221-223), deterministic lateral displacement (see, for example, Morton et al., Proc. Natl. Acad. Sci. U.S.A. 2008, 105, (21), 7434-7438) and hydrodynamic filtration (see, for example, Aoki et al., Microfluid. Nanofluid. 2008, 6, (4), 571-576). Each of these references is incorporated herein by reference.

In some embodiments, a focusing channel does not include a coating of cell adhesion entities. However, in certain embodiments a coating of cell adhesion entities may be included for ease of manufacturing but a focusing channel can otherwise be designed (e.g., a much narrower width than a sorting channel) so that it cannot support cell rolling because of the high shear stress (as discussed below).

### Shear Stress

In general, the level of interactions between cells and coated surface can be controlled by adjusting shear stress in a channel. For example, Example 3 demonstrates sorting efficiency can be tuned by controlling the level of interactions via shear stress and the concentration of cell adhesion entities. The higher an applied shear rate, the higher the drag force acting on cells, thereby accelerating bond dissociation and reducing cell rolling. For example, as discussed above in the context of the optional focusing channel, if the shear stress is sufficiently high then cell rolling can be prevented even in the presence of cell adhesion entities.

Assuming a linear fluid velocity profile, shear on a cell may be related to fluid velocity in certain embodiments as:

τ=μ×V_{fluid}/R_{cell}

where μ is the viscosity of the fluid, R_{cell} is the radius of the cell, and V_{fluid} is the velocity of fluid flow at distance R_{cell} from the surface. For a given cell and fluid shear stress is most readily adjusted by adjusting the velocity of fluid flow and/or the width of the channel.

In some embodiments, a shear stress on cells flowed through a sorting channel is in a range between about 0.05 dyn/cm² to about 50 dyn/cm². In certain embodiments, a shear stress can be in a range of about 0.1 dyn/cm² to about 20 dyn/cm². In certain embodiments, a shear stress can be in a range of about 1 dyn/cm² to about 10 dyn/cm². In certain embodiments, a shear stress can be in a range of about 5 dyn/cm² to about 10 dyn/cm². In certain embodiments, a shear stress can be in a range of about 1 dyn/cm² to about 10 dyn/cm². In certain embodiments, a shear stress can be at least about 0.1 dyn/cm², 0.2 dyn/cm², 0.5 dyn/cm², 1 dyn/cm², 2 dyn/cm², 5 dyn/cm², 10 dyn/cm², 20 dyn/cm², 30 dyn/cm², 40 dyn/cm², or 50 dyn/cm². In certain embodiments, a shear stress can be less than about 10 dyn/cm², 20 dyn/cm², 30 dyn/cm², 40 dyn/cm², or 50 dyn/cm². In certain embodiments, a shear stress can be in a range between any two of these values. In some embodiments, a sorting channel has spatial shear stress gradients as illustrated in Examples 2-4.

In some embodiments, a shear stress on cells flowed through a focusing channel is higher than in a sorting channel, e.g., in a range between about 20 dyn/cm² to about 200 dyn/cm². In certain embodiments, a shear stress can be in a range of about 30 dyn/cm² to about 150 dyn/cm². In certain embodiments, a shear stress can be in a range of about 50 dyn/cm² to about 100 dyn/cm². In certain embodiments, a shear stress can be in a range of about 50 dyn/cm² to about 100 dyn/cm². In certain embodiments, a shear stress can be at least about 20 dyn/cm², 30 dyn/cm², 40 dyn/cm², 50 dyn/cm², 100 dyn/cm², 150 dyn/cm², 200 dyn/cm². In certain embodiments, a shear stress can be less than about 50 dyn/cm², 100 dyn/cm², 150 dyn/cm², 200 dyn/cm². In certain embodiments, a shear stress can be in a range between any two of these values.

### Other Units

In some embodiments, provides devices may include a sorting channel that is in fluid communication with other units (e.g., the aforementioned focusing channels or additional sorting channels) and/or other devices.

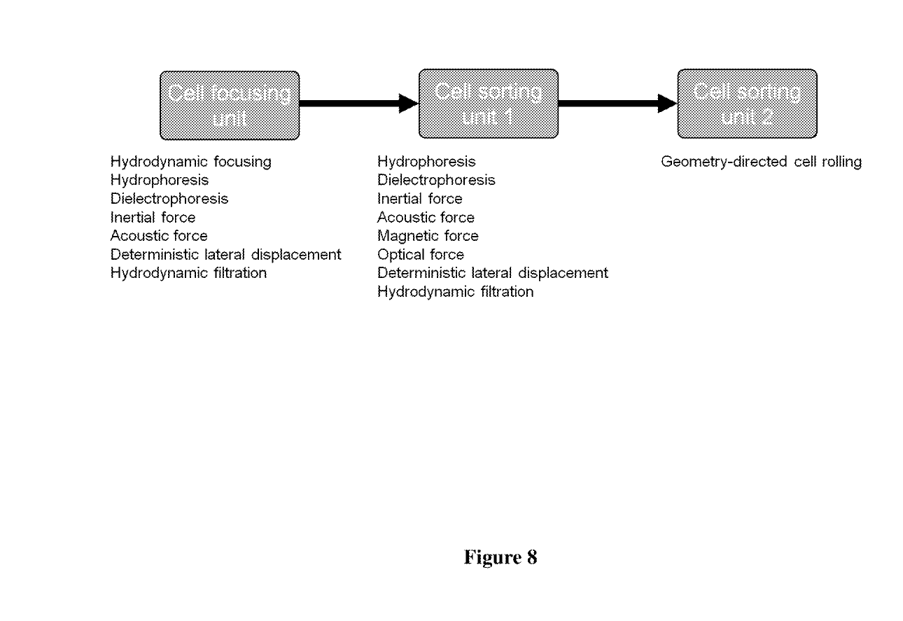

For example, as shown in FIG. 8, a cell rolling based sorting unit 2 may be combined with an upstream cell sorting unit 1 that is not based on cell rolling and optionally an upstream cell focusing unit (it is to be understood that in other embodiments the cell rolling based sorting unit 2 could be upstream of cell rolling unit 1). In some embodiments, exemplary cell sorting technologies that do not rely on cell rolling may use dielectrophoretic forces (see, for example, Hu et al., Proc. Natl. Acad. Sci. U.S.A. 2005, 102, (44), 15757-15761), magnetic forces (see, for example, Adams et al., Proc. Natl. Acad. Sci. U.S.A. 2008, 105, (47), 18165-18170), inertial forces (see, for example, Di Carlo et al., Proc. Natl. Acad. Sci. U.S.A. 2008, 104, (48), 18892-18897), optical forces (see, for example, Kim et al., Anal. Chem. 2008, 80, (7), 2628-2630), acoustic forces (see, for example, Adams et al., Appl. Phys. Lett. 2010, 97, (6), 064103), deterministic lateral displacement (see, for example, Huang et al., Science 2004, 304, (5673), 987-990) and hydrodynamic filtration (see, for example, Yamada et al., Lab Chip 2005, 5, (11), 1233-1239).

Such combinations may facilitate efficient rolling of target cells by initially removing non-target cells that can interfere with the cell-surface interactions (e.g., see FIG. 14).

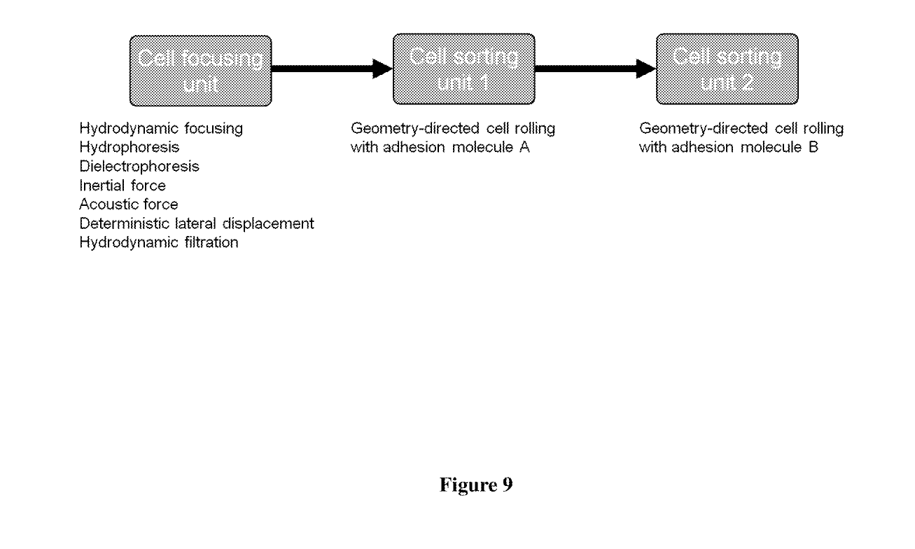

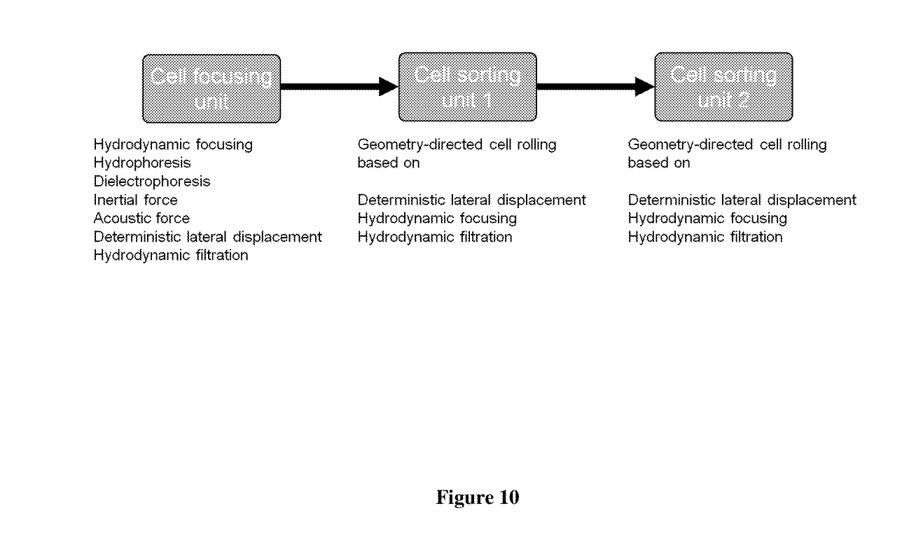

In other embodiments, sorting of multiple target cells can be achieved by combining two or more sorting channels that are coated with different cell adhesion entity (see cell sorting units 1 and 2 in FIG. 9) and/or two or more sorting channels that are coated with a cell adhesion entity but rely on different geometric-directed separation techniques (see cell sorting units 1 and 2 in FIG. 10).

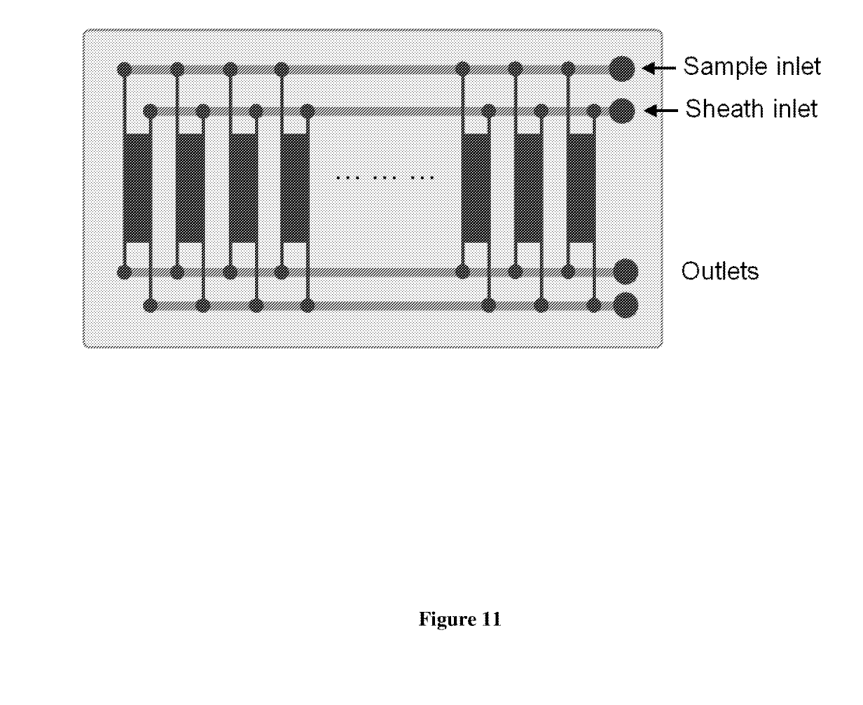

In some embodiments, integrating multiple parallel sorting channels into a single device can be used to increase a sorting throughput considerably in order to reach clinically relevant throughputs (e.g., see FIG. 11). For example, in certain embodiments, two or more sorting channels may be separate and unable to communicate (i.e., a parallel system). Each sorting channel in such a device may be the same or different (e.g., different 3D structures and/or coating of cell adhesion entities). Devices which include a plurality of sorting channels with the same design may be useful when there is a need to replicate a separation under similar conditions (e.g., one or more test samples and a control sample). Devices which include a plurality of different sorting channels may be useful when there is a need to identify a design which produces optimal separation (e.g., using different aliquots of the same test sample).

In some embodiments, a device may include two or more sorting channels that are in fluid communication (e.g., where the outlet from a first separation channel is in fluid communication with the inlet of a second separation channel). Each sorting channel in such a device may include the same or a different design. It will be appreciated that such serial set ups may be useful when, for example, it is desirable to expose a subpopulation of cells which has been isolated by a first separation phase to a second separation phase (e.g., to isolate sub-subpopulations).

### B. Cells

Provided methods and devices may be used to sort or isolate a variety of cell types. The initial cell mixtures may therefore comprise any of a variety of cell types and may be obtained from any of a variety of sources. Cell populations typically comprise at least one cell with a characteristic or at least one subpopulation of cells with a common characteristic.

A characteristic can be a phenotype such as expression of a cell surface moiety, cell type (such as, for example, lineage type), differentiation potential, etc. For example, a cell may comprise a cell surface moiety that is recognized by a cell adhesion entity. Examples of cell surface moieties include ligands of P-selectin, ligands of E-selectin, ligands of L-selectin, etc. Examples of such moieties include P-selectin ligand 1 (PSGL-1), CD44 (a ligand for E-selectin and L-selectin), glycosylation-dependent cell adhesion entity 1 (GlyCAM-1, a ligand for L-selectin), CD15 (a ligand for P-selectin), CD34 (a ligand for L-selectin), E-selectin ligand 1 (ESL-1), etc. Other non-limiting examples of cell surface moieties include Very Late Antigen 4 (VLA-4, a ligand for VCAM-1), gp200, etc.

Subpopulations may comprise particular cell types and/or combinations of cell types. For example, cells in a subpopulation may be cancer cells. Further examples of cell types include stem cells (e.g., mesenchymal stem cells, hematopoietic stem cells, embryonic stem cells, etc.), progenitor cells, red blood cells (RBCs), white blood cells (WBCs), neutrophils, lymphocytes, monocytes, etc. In certain embodiments, all cells in a subpopulation are of a particular cell type, e.g., all cancer cells, all stem cells, all progenitor cells, etc. Though platelets are not formally classified cells, they may be induced to roll and separated using provided methods and devices.

Cells may be obtained from a variety of sources, including, but not limited to, bodily fluids containing cells (such as, for example, blood, lymph, ascites fluid, urine, saliva, synovial fluid, cerebrospinal fluid, vitreous humor, seminal fluid, etc), tissue samples, frozen stocks, cell cultures, etc.

Cells may be treated with agents before and/or as they are flowed. For example, in certain embodiments, cells may be treated with agents that modify their deformability. Examples of such agents include cytochalasin, N-ethylmaleimide, p-choloromercuribenzene, vinblastine, etc. In certain embodiments, this treatment step may facilitate cell rolling of a certain type of cell.

### C. Cell Adhesion Entities

As discussed herein, certain surfaces of the devices are coated with one or more cell adhesion entities. In some embodiments, the term “cell adhesion entity” refers to entities (e.g., proteins) that are located on cell surfaces involved in binding (via cell adhesion) of the cell on which they are found with other cells or with the extracellular matrix. Examples of cell adhesion entities include, but are not limited to selectins (e.g., E-selectins, P-selectins, L-selectins, etc.), integrins (e.g., an alpha integrin such as CD49a, CD49b, CD49c, CD49d, CD49e, CD49f, ITGA7, ITGA8, ITGA9, ITGA10, ITGA11, CD11D, CD103, CD11a, CD11b, CD51, ITGAW, CD11c, or a beta integrin such as CD29, CD18, CD61, CD104, ITGB5, ITGB6, ITGB7, IT), cadherins (e.g., E-cadherins, N-cadherins, P-cadherins, etc.), and immunoglobulin cell adhesion entities (e.g., SynCAMs, NCAMs, ICAM-1, VCAM-1, PECAM-1, L1, CHL1, MAG, nectins, CD2, CD48, SIGLEC family members such as CD22 and CD83, and CTX family members such as CTX, JAMs, BT-IgSF, CAR, VSIG, and ESAM). In certain embodiments, the term “cell adhesion entity” encompasses neural cell adhesion entities (NCAMs), intercellular cell adhesion entities (ICAMs), vascular cell adhesion entities (VCAMs), platelet-endothelial cell adhesion entities (PECAMs), epithelial cell adhesion entities (EpCAM), synaptic cell adhesion entities (SynCAMs) and extracellular matrix cell adhesion entities (e.g., vitronectins, fibronectins, laminins, etc.). In certain embodiments, the term “cell adhesion entity” encompasses other molecules that can facilitate cell adhesion. Thus, in certain embodiments, aptamers, carbohydrates, peptides (e.g., RGD peptides, etc.), and/or folic acid, etc. can serve as cell adhesion entities. As used herein, the term “cell adhesion entity” does not encompass antibodies. It is to be understood that reference to any one of the cell adhesion entities that are described herein (e.g., “P-selectin”) encompasses the full-length version of the molecule as well as functional fragments or analogs thereof that are capable of inducing cell rolling.

It will be appreciated that the particular choice of cell adhesion entity (or cell adhesion entities when more than one type is used in the same or in a series of sorting channels) will depend in part on the nature of the cells being sorted and the types of cell surface moieties that are present on those cells. Those skilled in the art are familiar with the types of cell adhesion entities that are suitable for sorting different cell types.

It will also be appreciated that the behavior of cells on a coated surface of a device will depend on the density and/or patterning of the cell adhesion entities (e.g., see results discussed in Example 3). The dissociation constant between the cell adhesion entities and cell surface moieties will also play a role in determining the behavior of cells on a coated surface of a device. In certain embodiments, a coating comprises cell adhesion entities having a dissociation constant (K_{D}) for interaction with the relevant cell surface moieties that is greater than about 1×10⁻⁸ mole/liter (M). In certain embodiments, a coating comprises cell adhesion entities having a dissociation constant (K_{D}) for interaction with the relevant cell surface moieties that is in the range of about 1×10 to about 1×10⁻⁸ M, inclusive, e.g., in the range of about 1×10⁻⁴ to about 1×10⁻⁷ M, inclusive, in the range of about 1×10⁻⁴ to about 1×10⁻⁶ M, inclusive, in the range of about 1×10⁻⁴ to about 1×10⁻⁵ M, inclusive, in the range of about 1×10⁻⁵ to about 1×10⁻⁸ M, inclusive, in the range of about 1×10⁻⁵ to about 1×10⁻⁷ M, inclusive, in the range of about 1×10⁻⁵ to about 1×10⁻⁶ M, inclusive, in the range of about 1×10⁻⁶ to about 1×10⁻⁸ M, inclusive, in the range of about 1×10⁻⁶ to about 1×10⁻⁷ M, inclusive, or in the range of about 1×10⁻⁷ to about 1×10⁻⁸ M, inclusive.

Cell adhesion entities can be coated onto surfaces in a variety of ways. In some embodiments cell adhesion entities may interact with the surface via non-covalent interactions (e.g., without limitation van der Waals interactions, hydrogen bonding, and electrostatic interactions). For example, a ligand/receptor type interaction may be used to indirectly link a cell adhesion entity to a surface of the device. Any ligand/receptor pair with a sufficient stability and specificity to operate in the context of the methods of present disclosure may be used. For example, streptavidin molecules may be used to form non-covalent bridges between biotinylated cell adhesion entities and a mixed self-assembled monolayer (SAM) of OEG-biotin/OEG-OH that is covalently bonded to a surface of the device. The strong non-covalent bond between biotin and streptavidin allows for association of the cell adhesion entity with the SAM and thus with the surface of the device. Other possible ligand/receptor pairs include antibody/antigen, FK506/FK506-binding protein (FKBP), rapamycin/FKBP, cyclophilin/cyclosporin, and glutathione/glutathione transferase pairs. Other ligand/receptor pairs are well known to those skilled in the art.

In some embodiments cell adhesion entities may interact with the surface via covalent bonds. Any covalent chemistry may be used. Exemplary non-covalent and covalent coating methods (e.g., epoxy based chemistry) are described in U.S. Patent Publication No. 2010/0112026 and U.S. Patent Publication No. 2010/0304485, the entire contents of which are incorporated by reference.

In some embodiments, cell adhesion entities may interact with the surface through one or more linker moieties. In certain embodiments, a linker moiety is bound to the cell adhesion entity at one of its ends and to the surface at another end. In various embodiments, the bond between the linker moiety and the surface may be covalent. The bond between the linker moiety and the cell adhesion entity may be covalent or non-covalent (e.g., if it involves a ligand/receptor pair as discussed above). Without limitation, in certain embodiments, the linker moiety comprises one or more of a dextran, a dendrimer, polyethylene glycol, poly(L-lysine), poly(L-glutamic acid), poly(D-lysine), poly(D-glutamic acid), polyvinyl alcohol, and polyethylenimine. In certain embodiments, the linker moiety comprises one or more of an amine, an aldehyde, an epoxy group, a vinyl, a thiol, a carboxylate, and a hydroxyl group. In certain embodiments, the linker moiety includes a member of a ligand/receptor pair and the cell adhesion entity has been chemically modified to include the other member of the pair.

In some embodiments, the use of covalent interactions may improve the long term stability and behavior of the coated surface. In certain embodiments it may also facilitate the control of cell adhesion entity density, as well as the patterning and orientation of cell adhesion entities on the surface. For example, the density will depend on the density of groups on the surface available for covalent bonding. Similarly, the patterning will depend on the pattern of groups on the surface available for covalent bonding. Methods are well known in the art for preparing surfaces with different densities and patterns groups for covalent bonding (e.g., see Rusmini et al., Biomacromolecules 8(6):1775-89 (2007) and Leckband et al., Biotechnology and Bioengineering 37(3):227-237 (1991), the entire contents of which are incorporated herein by reference). In certain embodiments, the density of cell adhesion entities may range from about 10 ng/cm² to about 600 ng/cm². In certain embodiments, the density of cell adhesion entities may be greater than about 30 ng/cm². For example, in certain embodiments, the density of cell adhesion entities may range from about 30 ng/cm² to about 360 ng/cm². In certain embodiments, the density of cell adhesion entities may range from about 50 ng/cm² to about 300 ng/cm². In certain embodiments, the density of cell adhesion entities may range from about 100 ng/cm² to about 200 ng/cm².

In some embodiments, the orientation of cell adhesion entities on the surface is controlled. This can be advantageous, e.g., because the cell adhesion entities are forced to interact with cells only if a particular region of the cell adhesion entities is accessible to the cells. For example, P-selectin includes a single cysteine residue. As a result, if P-selectin is attached to the surface via a linker moiety that reacts specifically with cysteine, all P-selection molecules will be attached to the surface with the same orientation. In general, this approach can be applied whenever the cell adhesion entity includes a unique group. In certain embodiments, a cell adhesion entity can be engineered or chemically modified using methods known in the art to produce a functional analog that includes such a unique group (e.g., a particular amino acid residue) at a position that provides an optimal orientation. For example, a suitable amino acid residue can be added at the C- or N-terminus of protein based cell adhesion entities.

In some embodiments, cell adhesion entities are synthesized and/or purified such that only a limited subset of the residues is able to react with reactive groups on a surface or on a linker. In certain embodiments, there is only one group or residue on each cell adhesion entity that can react with reactive groups on a surface or on a linker. For example, in certain embodiments, cell adhesion entities are synthesized and/or purified with protecting groups that prevent the residues to which they are attached from reacting with reactive groups on the surface or linker. In such embodiments, one or more residues in the cell adhesion entity are not protected. Because a cell adhesion entity can only attach to the surface or linker via the one or more unprotected residues, a cell adhesion entity may attach to the surface or linker in a specific orientation. In certain embodiments, protective groups are removed after attachment of the cell adhesion entity to the surface or linker (see, e.g., Gregorius et al. Analytical Biochemistry 299(1):84-91 (2001), the entire contents of which are incorporated herein by reference).

### D. Antibodies

In some embodiments, antibodies (including antibody fragments) may be co-immobilized on surface of the device along with cell adhesion entities. In general, an antibody may be attached to the surface in a similar fashion to the cell adhesion entity (e.g., using the same linker moiety). In certain embodiments, an antibody may be attached using a different covalent attachment method. In certain embodiments, an antibody may be attached non-covalently.

In some embodiments, an antibody that binds to a cell surface moiety may be co-immobilized with cell adhesion entities. In principle, any pair of antibody and cell surface moieties may be used, so long as the antibody binds to the cell surface moiety. For example, if it is desired to modify interactions between a coated surface and a cell type that expresses CD64, then anti-CD64 antibodies may be co-immobilized with cell adhesion entities. Those skilled in the art will appreciate how this can be extended to other cell surface moieties that are known in the art. Molar ratios of cell adhesion entities to antibodies in such embodiments may be varied depending on the desired rolling characteristics (such as, for example, velocity, percentage of cells stopping, etc.). Examples of suitable ratios include those ranging from about 100:1 to 1:1. In certain embodiments, molar ratios range between 50:1 and 1:1, e.g., between 20:1 and 1:1, between 10:1 and 1:1 or between 5:1 and 1:1.

In some embodiments, antibodies can be included in order to modulate the speed at which cells roll on a coated surface. In certain embodiments this may be achieved by controlling the density and/or arrangement of antibodies. In certain embodiments, antibodies may be immobilized onto surfaces at a density that slows down the speed of rolling without causing the cells to stop.

### E. Cell Modifying Ligands

In some embodiments, cell modifying ligands may be co-immobilized with cell adhesion entities. In general, a cell modifying ligand may be attached to the surface in a similar fashion to the cell adhesion entity (e.g., using the same linker moiety). In certain embodiments, a cell modifying ligand may be attached using a different covalent attachment method. In certain embodiments, a cell modifying ligand may be attached non-covalently.

In some embodiments, the population of cells which is flowed over a coated surface of a device includes at least one subpopulation of cells with a common characteristic, and a cell modifying ligand is capable of modifying a phenotype of the subpopulation of cells. Any of a variety of cell types can comprise the subpopulation, as discussed herein. As an example, certain cancer cells may express a receptor such as TNF receptor 5 and/or 6, which is not expressed on normal cells. Tumor necrosis factor (TNF)-related receptor apoptosis-inducing ligand (TRAIL) specifically binds to TNF receptors 5 and 6. To induce apoptosis or programmed cell death of such cells, TRAIL may be co-immobilized with a cell adhesion entity. Cell modifying ligands such as TRAIL and/or other chemotherapeutic agents can be co-immobilized with a cell adhesion entity to impart signals to kill or arrest growth of cancer cells. It will be appreciated by those skilled in the art that other cell modifying ligands can be immobilized and/or presented on and/or located within the substrate to influence the behavior of cells that interact with the cell adhesion entities. For example, fibroblast growth factor 2 (FGF-2) can be presented to facilitate maintaining cells in an undifferentiated state. As a further example, bone morphogenic protein 2 (BMP-2) can be presented to stimulate osteogenic differentiation of stem cells, etc. Combinations of cell modifying ligands are also contemplated.

### F. Uses of Devices

In many embodiments, provided methods and devices may be used to isolate cells from a mixture of cells. As noted previously, in certain embodiments, the isolation of cells may facilitate diagnostic applications including point-of-care diagnostics. Indeed, the presence of certain cell types in a biological sample (e.g., blood, urine or some other bodily fluid) may be indicative of certain conditions, disorders, diseases, etc. In certain embodiments, provided methods and devices may be used to isolate cells (e.g., stem cells, leukocytes, neutrophils, etc.) for research laboratory applications. For example, provided methods and devices can be used for lab-scale sample preparation.

Provided methods and devices may be used for both qualitative and quantitative diagnostic applications. In certain embodiments, provided methods and devices may be used to isolate and generate absolute counts of white blood cells (WBCs), neutrophils, CD4+ and CD8+ T cells, eosinophils, etc. In certain embodiments, provided methods and devices may be used to generate relative counts of WBCs/CD4+ T cells, CD4+/CD8+ T cells, etc. In certain embodiments, provided methods and devices may be used to diagnose sepsis based on (a) the isolation of neutrophils with activation markers of sepsis and/or (b) the failure to isolate normal resting neutrophils. In certain embodiments, provided methods and devices may be used to isolate circulating tumor cells in whole blood, e.g., using EpCAM or similar cell adhesion entities. In certain embodiments, provided methods and devices may be used to isolate antigen specific T-cells using an MHC tetramer as the cell adhesion entity.

In some embodiments, the isolation of cells using provided methods and devices may be used for the analysis of cell. In certain embodiments, cell phenotype may be analyzed by studying the rolling behavior of the cells to detect phenotypic changes such as up or down regulation of certain surface moieties (optionally in combination with changes in morphology, etc.). In certain embodiments, provided methods and devices can be used for quality control of cells (e.g., stem cells). For example, provided methods and devices may be adapted and used to track changes in phenotype of stem cells (e.g., MSC, ES, etc), to monitor neutrophil activation, to detect T-cell developmental stages, to test the effect of drugs on bacterial phenotypes, to distinguish bacterial from viral infection by screening activated neutrophils from peripheral blood or tissue, etc.

Provided methods and devices may be used to address the needs for quantitative analysis of MSC adhesion. Cell adhesion entities (e.g., ligands) that induce cell rolling are important for development of anti-inflammatory therapeutics and anti-metastasis therapeutics, and regenerative medicines. Homing of msenchymal stem cells (MSCs) is an important consideration for systemically delivered MSCs, as the therapeutic effect may be expected to depend on the distribution of MSCs following systemic injection. Although the precise mechanism of MSC homing and engraftment is an area of active research, ligands that mediate MSC rolling have been implicated. Henschler and colleagues reported that although P-selectin glycoprotein ligand (PSGL)-1 is not expressed by MSCs, the rolling of human MSCs on human umbilical cord vein endothelial cells is independently mediated both by P-selectin and VCAM-1. MSCs were shown to roll and adhere in a P-selectin-dependent manner to post-capillary venules in vivo in a mouse model. Promoting the expression of CD49d integrin on the surface of MSCs was also found to enhance homing response. As shown in Example 4, a cell rolling cytometer (CRC) in accordance with the present disclosure can be used for controllably contacting and transporting cells in suspension using a three-dimensional microtopography coated with adhesion entities, which enables quantification of cell-surface adhesion dynamics via transit time and lateral position at the single cell level.

Cells that have been isolated using provided methods and devices may also be used in a variety of non-diagnostic applications. In certain embodiments, isolated cells may have therapeutic uses. Thus, in certain embodiments isolated cells may be used as the seed culture for a subpopulation of cells that is only present in low quantities in a starting population of cells or in a fluid. For example, isolated stem cells may be cultured and then used to regenerate tissue and/or function. In certain embodiments, provided methods and devices may be adapted and used for applications in cell therapy, dialysis, disease prevention, and cell heterogeneity reduction. Exemplary diseases include, but are not limited to, malaria, tuberculosis, sepsis, sickle cell anemia, HIV/AIDS, cancer, and various blood borne diseases. For example, a device disclosed herein can be used in vivo or ex vivo to remove circulating tumor cells to prevent metastasis of some forms of cancer. This can allow the progression of cancer to be monitored and can also assist in preventing the spread of cancer.

### EXAMPLES

### Example 1

### Directed Cell Rolling on a Square Geometry

We have developed new approaches for affecting the trajectories of cells using microfluidic geometries and cell adhesion entities. Specifically, we have shown that the trajectories of cells through a traditional cell sorting device can be adjusted by coating three-dimensional obstacles within the device with cell adhesion entities. Thus, traditional devices that are incapable of separating two cell types as they pass through the device can be reconfigured in order to separate these cells.

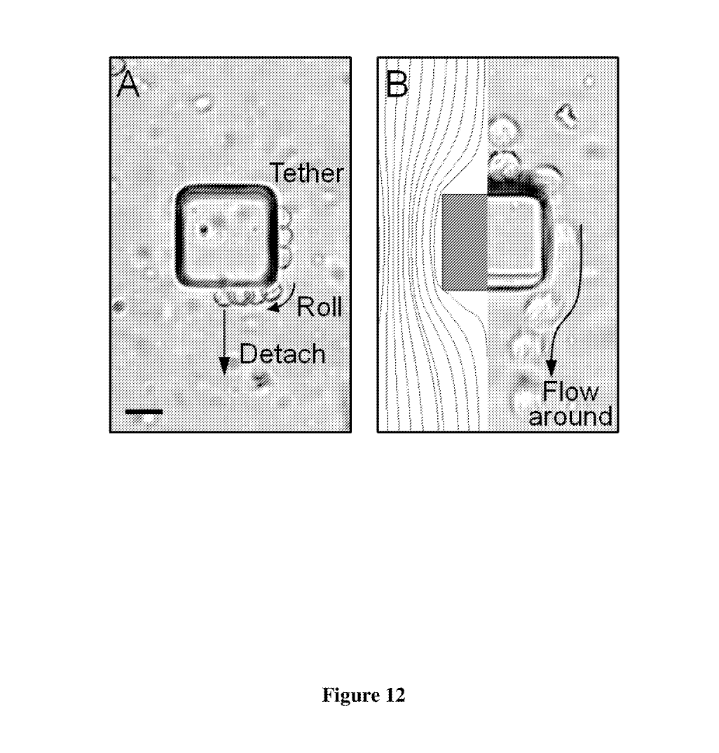

For purposes of illustration we investigated the effect of a square geometry coated with P-selectin on the rolling motion of HL60 cells (see FIG. 12A). HL60 is a human myeloid cell line that exhibits rolling on selectins mediated primarily by PSGL-1. Human P-selectin was coated on a PDMS device consisting of 50 μm×50 μm micro-posts for 3 hours and then washed with 2 mg/ml BSA. As shown in FIG. 12A, once HL60 cells tether on the square post surface, they experience shear-induced force, Fₛ and torque Tₛ, which can be determined by Fₛ=1.7×(6πμr²S) and Tₛ=0.944×(4πμr³S), respectively, where μ is the kinematic viscosity, r is the cell radius and S is the shear rate. Tₛ is induced by Fₛ as the rolling cells pivot around a bond cluster and can be divided in two perpendicular force vectors—one acting in the rolling direction and the other normal to the surface. If the resultant torque is large enough, additional bonds are apparently able to form even on the trailing surface of the square post where Fₛ is no longer parallel to the rolling direction (see FIG. 12A). In contrast, K562 cells that do not express PSGL-1 do not bind to P-selectin and traveled along the flow streamlines despite coming into contact with the square post (see FIG. 12B).

### Example 2

### V-Shaped Microstructures and Devices Thereof

Design

FIG. 13 shows an exemplary cell sorting device that uses V-shaped microstructures (or “obstacles”) that alter the flow streamlines and induce repeated collisions between cells and the microstructures. In the narrow (and optionally uncoated) upstream focusing channel these collisions result in focusing of both target and non-target cells at the center of the channel by hydrophoresis. In the wider downstream sorting channel the shear stress is reduced and the microstructures are coated with cell adhesion entities. The collisions in the sorting channel still result in focusing of non-target cells at the center of the channel by hydrophoresis. In contrast, target cells are now captured on the coated microstructures and are diverted into the trenches (or “grooves”) that separate the microstructures, roll along the trenches, and finally detach near the side-ends of the microstructures into a gutter. The downstream end of the device includes a central outlet for collecting the non-target cells and side outlets for collecting the target cells.

Surface Preparation

As shown in FIG. 17, the device of FIG. 13 was fabricated in poly(dimethylsiloxane) (PDMS) using soft lithography, with a total channel height of 76 μm and a clearance between the top and bottom microstructures of 20 μm. The slanting angles of the microstructures relative to the bulk flow axis were 60° and 45° for the focusing and sorting channel, respectively. The channel widths were 110 and 1,200 μm for the focusing and sorting channel, respectively. The entire channel was incubated with 1 μg/mL or 3 μg/mL human P-selectin for 3 hours and then washed with 2 mg/mL BSA. A control experiment was also performed by incubating the entire channel with 1 mg/mL BSA for 3 hours.

Cell Sorting

HL60 and K562 cells were tested in the device described above. HL60 cells are from a human myeloid cell line that exhibits rolling on selectins such as P-selectin. The cell rolling is primarily mediated by PSGL-1 ligands (P-selectin glycoprotein ligand-1) that are expressed on the surface of HL60 cells. K562 cells do not express PSGL-1 on their surface and do not roll on P-selectin coated surfaces and were therefore used as non-target cells.

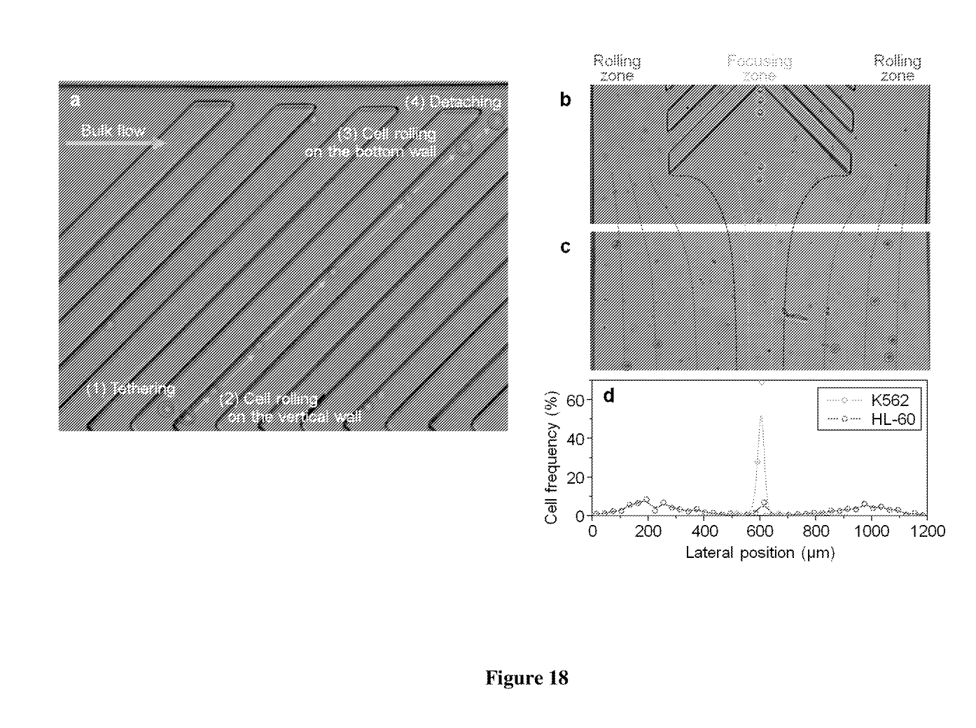

FIG. 18a shows the rolling sequence of a target HL-60 cell within the device, namely: (1) tethering on the top surface of the microstructure, (2 and 3) rolling in the trench, and (4) detaching into the gutter. The microstructures are angled to the bulk flow axis and thereby disturb streamlines to induce repeated collisions between the cells and microstructures by hydrophoresis. Once target cells attach on the coated surface of the microstructure, they roll and are deflected into the trench, continue rolling within the trench, and are finally detached on either of the side-ends of the microstructures. In the trench of the microstructure, rolling cells are exposed to outward flows toward either of the side walls. This assists in directing the motion of the rolling cells. After detaching into the gutter the target HL-60 cells flowed near the side walls of the sorting channel. In contrast, non-target K562 cells remained focused along the central flow axis of the sorting channel center (see FIGS. 18b-d).

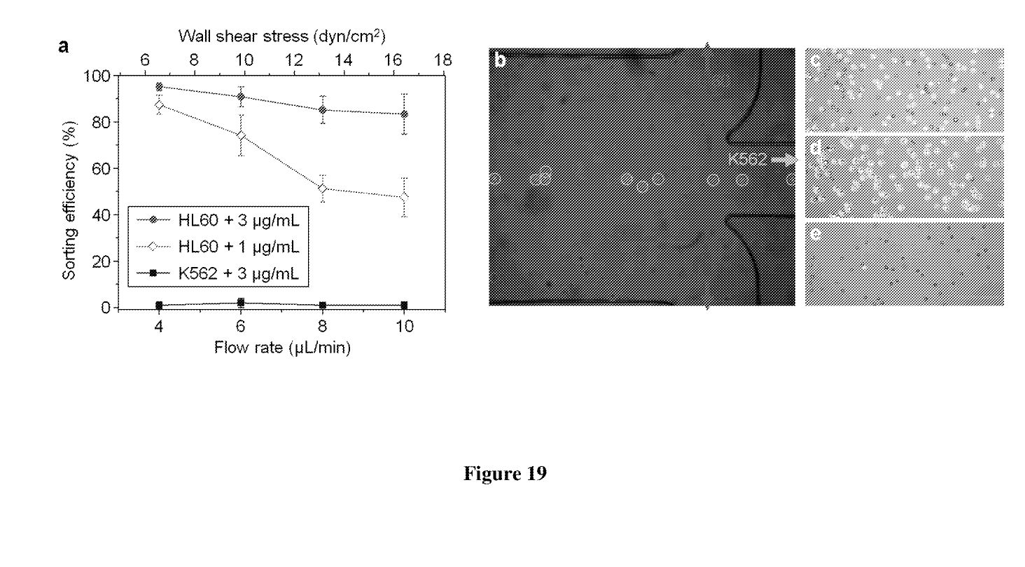

In order to further evaluate the cell rolling process, we defined a sorting efficiency of the device as the ratio of the number of cells going to the outside target outlets to the number of cells going to the central non-target outlet. The higher the applied shear rate, the higher the drag force acting on the cells, thereby accelerating bond dissociation and decreasing a sorting efficiency (see FIG. 19a). Increasing the P-selectin incubation concentration (from 1 μg/mL to 3 μg/mL) increased the potential number of interactions formed between surface receptors on the cells and the P-selectin cell adhesion entities on the microstructures, and thus increased a sorting efficiency and potential throughput of the device (see FIG. 19a). After separation of the cell mixture at a flow rate of 6 μL/min, the target and non-target reservoirs exhibited purities of 97.0±2.0 and 90.9±3.1%, respectively (see FIG. 19b-e).

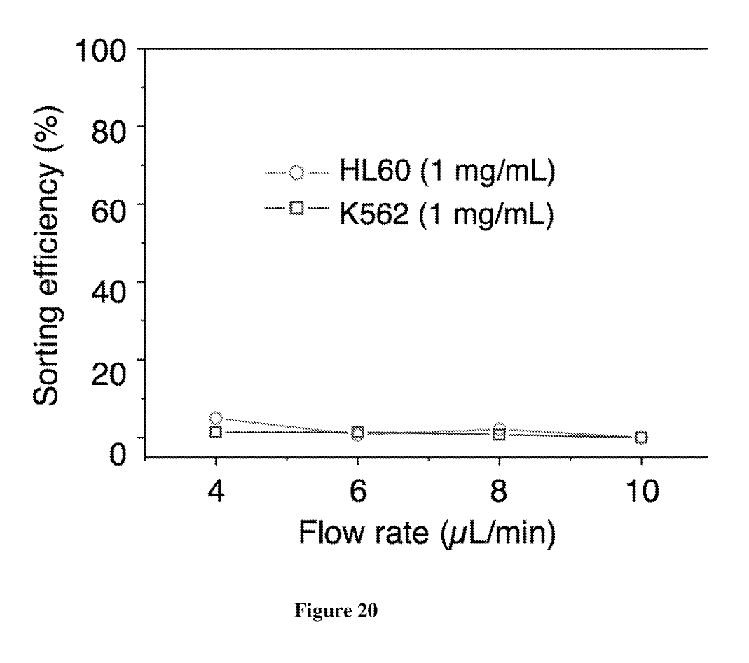

The results of a control experiment using a device that was coated with BSA only are shown in FIG. 20. As shown, >95% of both cell types were focused to the channel center and exited at the center outlet. Error bars (not shown) were all less than 2% (n=3).

### Example 3

### Cell Sorting by Deterministic Cell Rolling

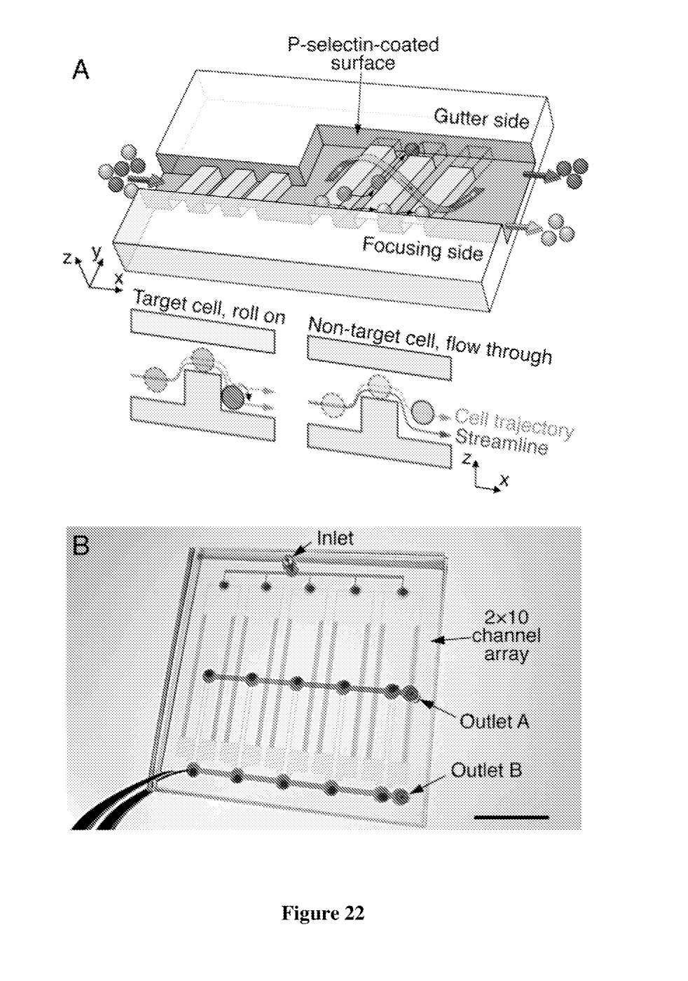

The present Example describes cell separation by “deterministic cell rolling” that combines transient cell-surface molecular interactions with passive hydrodynamic control to separate cells in a continuous process without requiring separate capture and elution steps. Such transient cell-surface interactions occur in cell rolling, which involves continuous formation and dissociation of cell-surface adhesive bonds under fluid flow. Cell rolling plays an important role in the trafficking of lymphocytes, platelets, hematopoietic stem and progenitor cells, and metastatic cancer cells. The particular device utilized in this Example for deterministic cell rolling contains easily parallelizable microfluidic channels with three-dimensional topography that work in synergy to induce effective contact of cells with affinity surfaces that support rolling of target cells, which alters their trajectories and results in cell separation (FIG. 22). While researchers have investigated the possibility of sorting cells based on cell rolling, current methods require surface patterning or microgrooves, and rely on gravitational settling for cell-surface interactions that requires a larger device footprint and yields a low throughput. Compared to these approaches, deterministic cell rolling enables a significantly higher efficiency of separation and a compact form factor that facilitates easy parallelization of sorting channels to process large sample volumes. Here, we confirm the utility of deterministic cell rolling for sorting cells based on a surface marker in a label-free, gentle, and scalable manner.

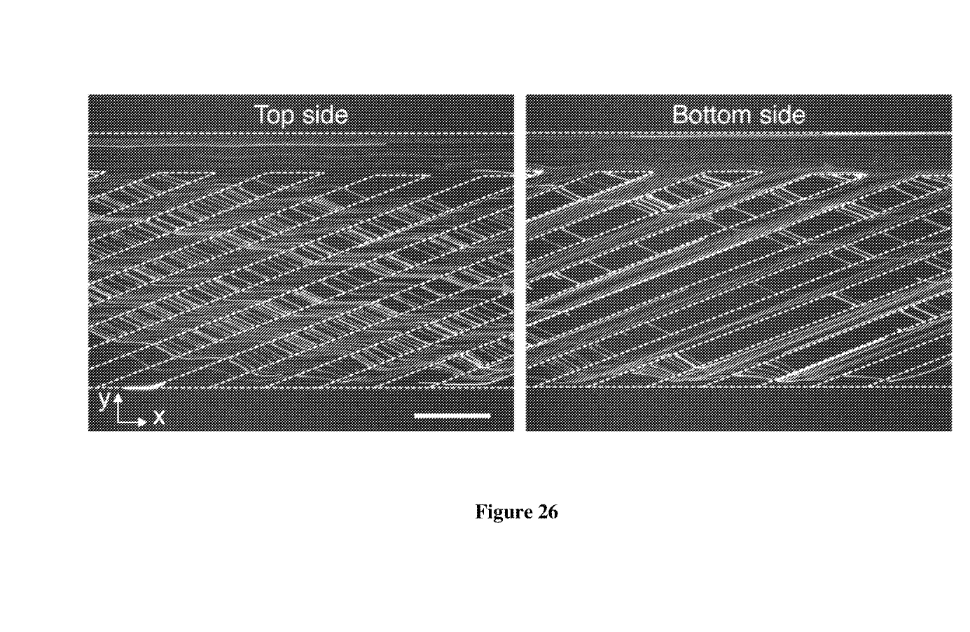

As described in the present specification, separation principle relies on two hydrodynamic phenomena—cell rolling and hydrophoresis. For passive cell manipulation we placed slant ridges on the channel floor, which alter the streamlines and induce repeated collisions between cells and the ridges (FIG. 22). The slant ridges superpose a circulating flow pattern on the axial flow. In the trenches between the ridges, the flow circulates towards a sorting/gutter side of the channel, whereas in the gap above the top surface of the ridges, the flow re-circulates back towards the focusing side of the channel (FIG. 26). This recirculating flow moves downward near the focusing side of the channel, pushing the cells against the ridges (FIG. 22A, top). The size of the cells prevents them from approaching the ridges more closely than the cell radius. In the case of non-target cells that do not roll on the ridges, this interaction forces the cells to remain above the ridges in the gap region where the flow converges towards the focusing side of the channel. These physical interactions result in self-ordering of non-target cells on the focusing side (FIG. 22A). The non-target cells thus follow a trajectory (the dotted arrow in FIG. 22A, bottom right) that keeps them out of the trench (the solid arrow in FIG. 22A, bottom right). This effect is called hydrophoresis. However, in the presence of adhesion entities on the surfaces, target cells are forced into contact with the ridges, and as a consequence, tether (i.e. initiate molecular interactions) and roll on the top surface of the ridges. Upon encountering the corner of the ridges, these cells remain attached to the ridge surface and enter the trenches between the ridges where the flow circulates away from the focusing side (FIG. 22A, bottom left). Thus, the molecular forces exerted on the interacting target cells as they round the corners of the ridges nudge them into a different, laterally diverging trajectory. These cells roll along the trench and finally come out of the ridge region into the gutter region and flow onward towards a sorting exit.

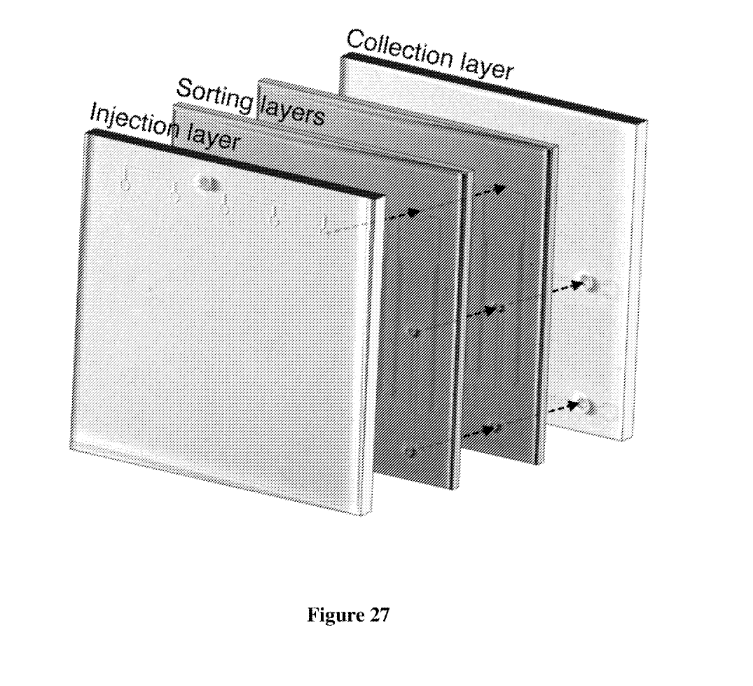

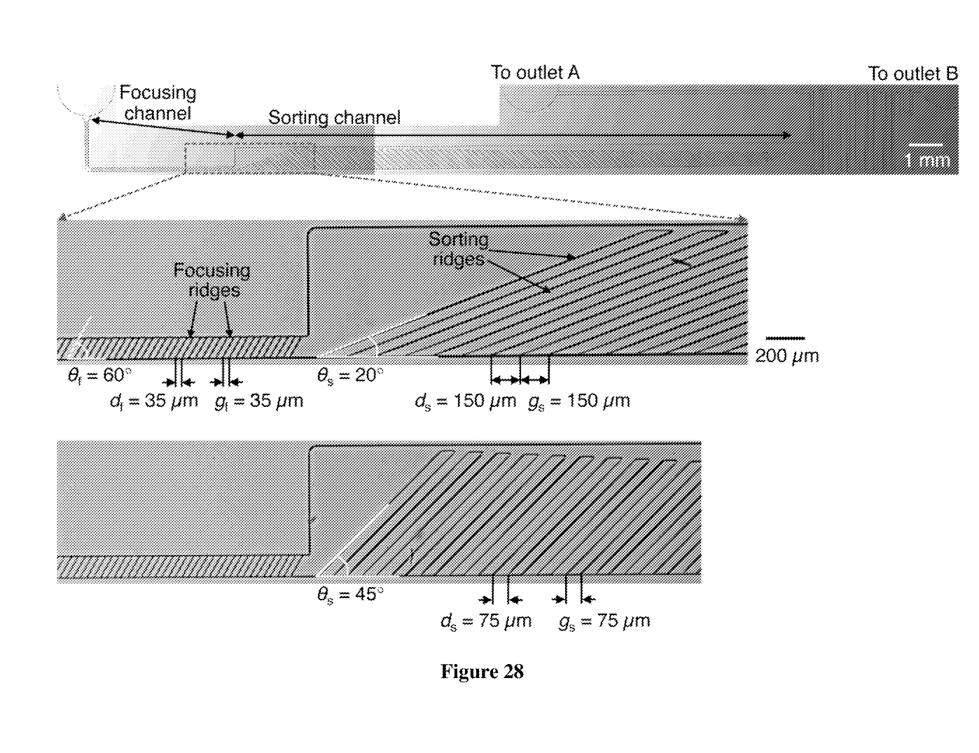

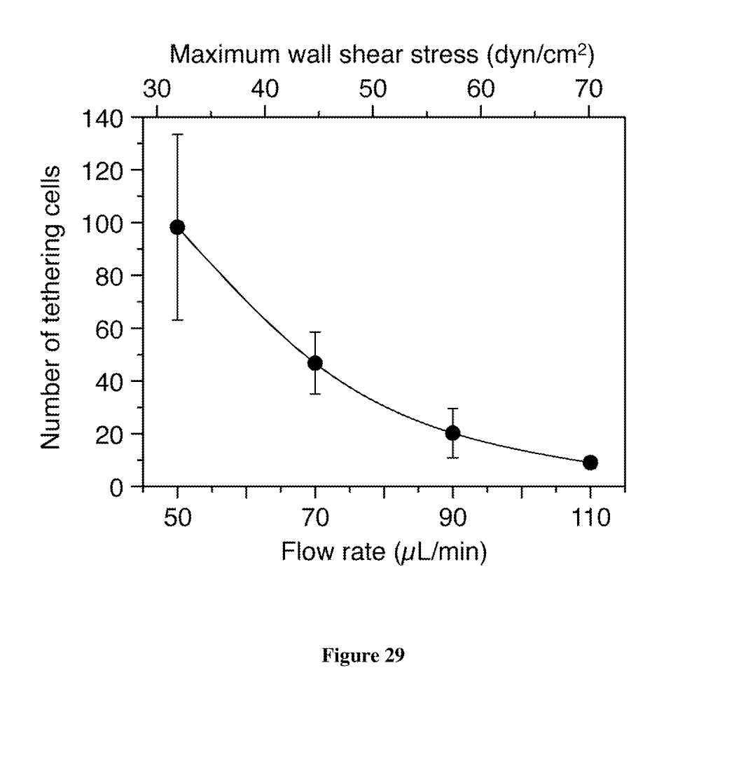

For scalable parallelization, the microfluidic device was fabricated in a multilayer structure in which multiple sorting layers can be sandwiched between the top injection layer and the bottom collection layer (FIGS. 22 and 27). Each sorting layer comprised ten polydimethylsiloxane (PDMS) microchannels with two sets of slant ridges (FIGS. 22 and 28). The first set of ridges, called focusing ridges (FR), were designed in a narrow channel (110 μm in width), such that they can be coated with adhesion entities, yet not support stable cell rolling due to the high shear stress (30 to 45 dyn/cm²) (FIG. 29). The second set, called sorting ridges (SR), were designed in a wider channel (670 μm in width) that allowed stable rolling of target cells on the SR due to lower shear stress (2.5 to 3.5 dyn/cm²). The ridges were arranged in order of decreased widths by 5 μm (from 640 μm to 385 μm), which formed a gutter and prevented sorted cells from re-entering the ridge region. Details of the device fabrication, geometry, and experimental setup are provided in Supplementary Information.

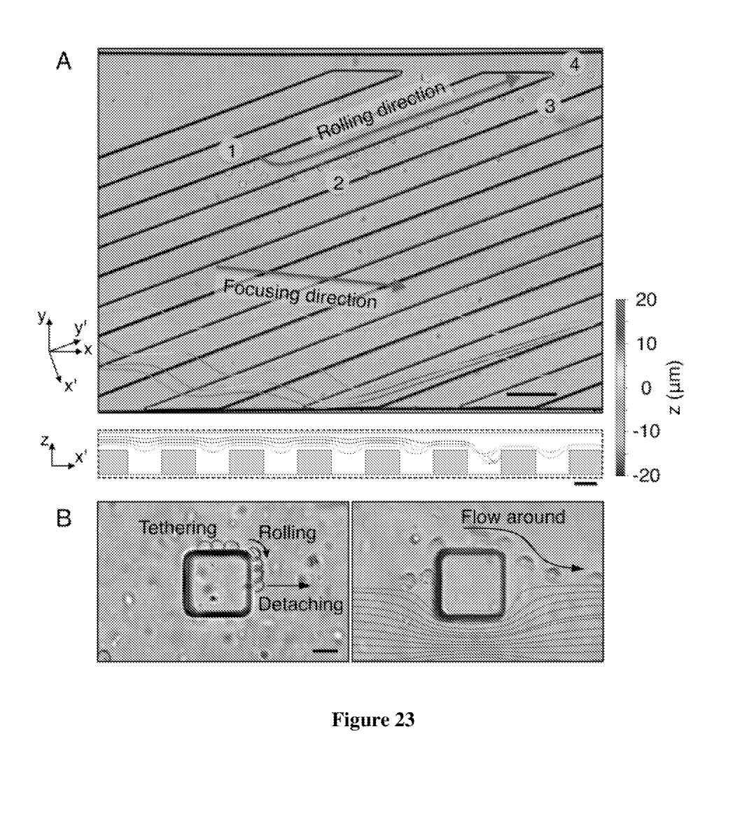

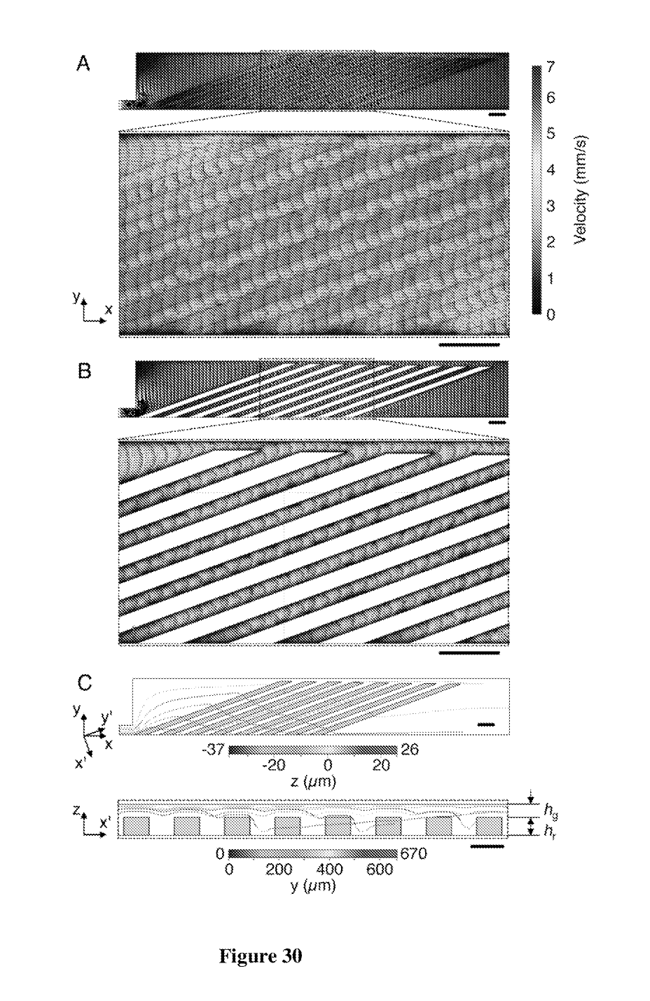

To validate the separation principle we used leukemia cell lines with known receptor-ligand pairs for cell rolling—HL60 as a target cell, K562 as a non-target cell, and P-selectin as a specific ligand. The device was incubated with P-selectin solution (1.5 μg/mL, unless specified) at room temperature. HL60 cells express high levels of P-selectin glycoprotein ligand-1 (PSGL-1, CD62P) and exhibit rolling on P-selectin mediated primarily by PSGL-1. In contrast, K562 cells that lack PSGL-1 do not bind to P-selectin. The rolling process of HL60 cells was highly deterministic, in which the cells were forced to contact and tether on the top surface of a sorting ridges (0 s), rolled along the trench, and were finally detached and re-suspended in the gutter region (66 s) (FIG. 23A). Since the trajectories of the rolling and non-rolling cells differed at the corners of the ridges, we examined the flow of cells when they encountered a square post to better understand this difference. Numerical simulations suggest that the flow streamlines experienced by a cell as it approaches the corner of a ridge are similar to those near the corner of the square post (FIGS. 23 and 30). The rolling cells experience shear-induced force, Fₛ and torque Tₛ, which can be estimated in the low shear regime and no-slip boundary condition as Fₛ=1.7×(6πμr²S) and Tₛ=0.944×(4πμr³S), respectively, where μ is the viscosity, r is the cell radius and S is the shear rate. Tₛ is induced by Fₛ as the rolling cells pivot around bond clusters. Without wishing to be bound to any particular theory, we propose that when the cell reaches the corner, this torque pivots the cell onto the downstream surface of the square post or the ridge. Indeed, we observed that the cells rolled around the corner of the square post and continued to roll towards the stagnation point before detaching from the surface (FIG. 23B, left). Without cell-surface interactions, the cells just followed the streamlines corresponding to the center of the cell, although they came into contact with the square post (FIG. 23B, right). These observations demonstrate that molecular interactions between the target cells and the surface exert a torque Tₛ that can sustain rolling over the surfaces around a right angle corner.

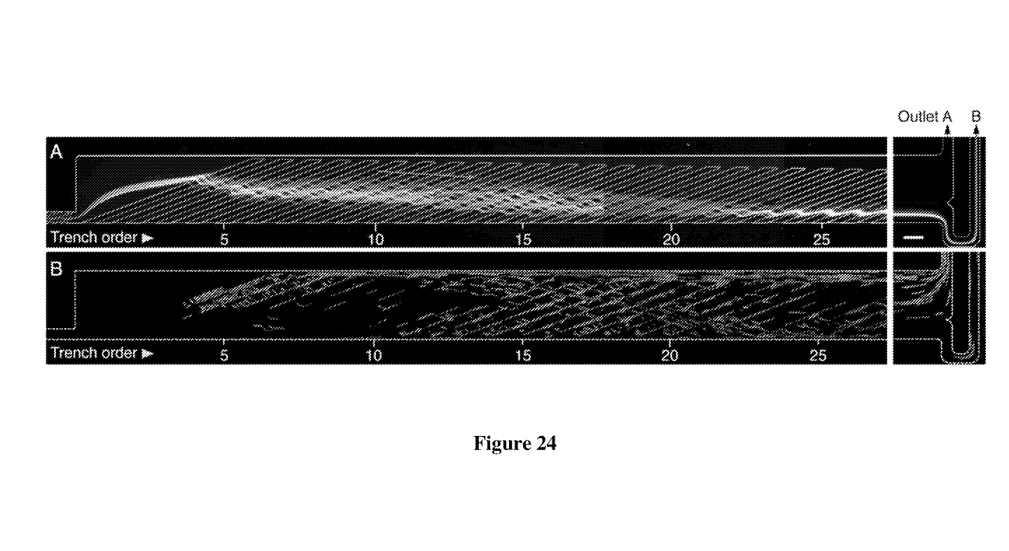

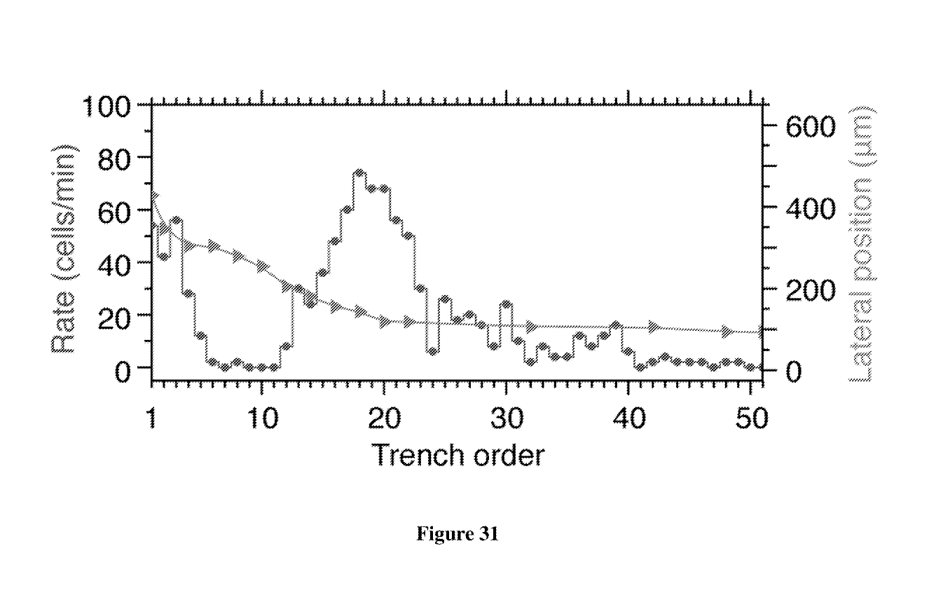

The location of cell tethering, i.e. initialization of molecular interactions, depends on the position where the cells are first focused and encounter the ridges. We observed that the majority (˜56%) of the cell tethering events occurred where cells in suspension just reached the focused position (FIGS. 24 and 31). This means that the steric collisions clearly occurred in the sorting channel as experimentally observed before and induced effective tethering of target cells on a sorting ridges. In the upstream focusing channel, all the cells are focused and assume similar trajectories (FIG. 24A). Although the cell stream spreads slightly upon entering the wider sorting channel, this upstream focusing resulted in some tethering events (˜19%) on the first four sorting ridges (FIGS. 24B and 31), while the remaining cells tethered further downstream. Some of the cells that tethered on the channel ceiling above the first few ridges rolled toward the focusing side (FIG. 24B), where they entered the trench and were sorted to the gutter side.

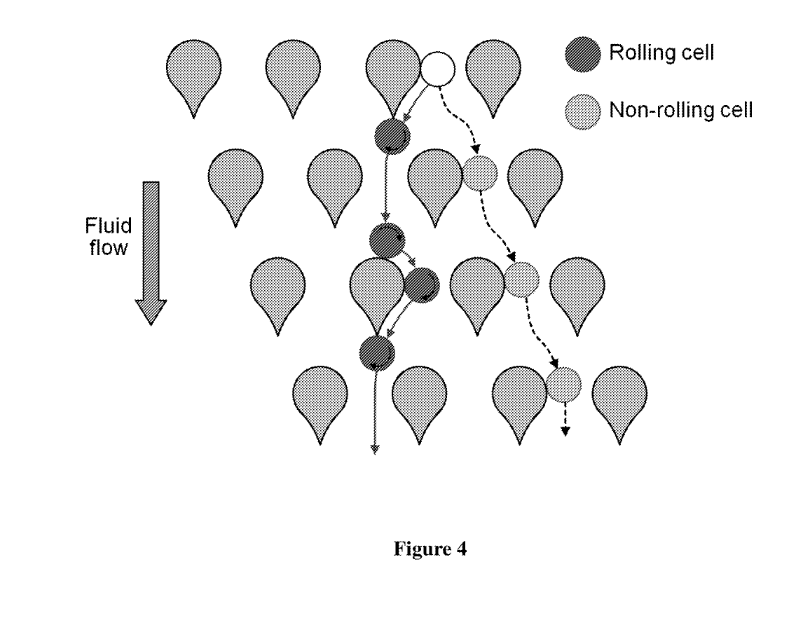

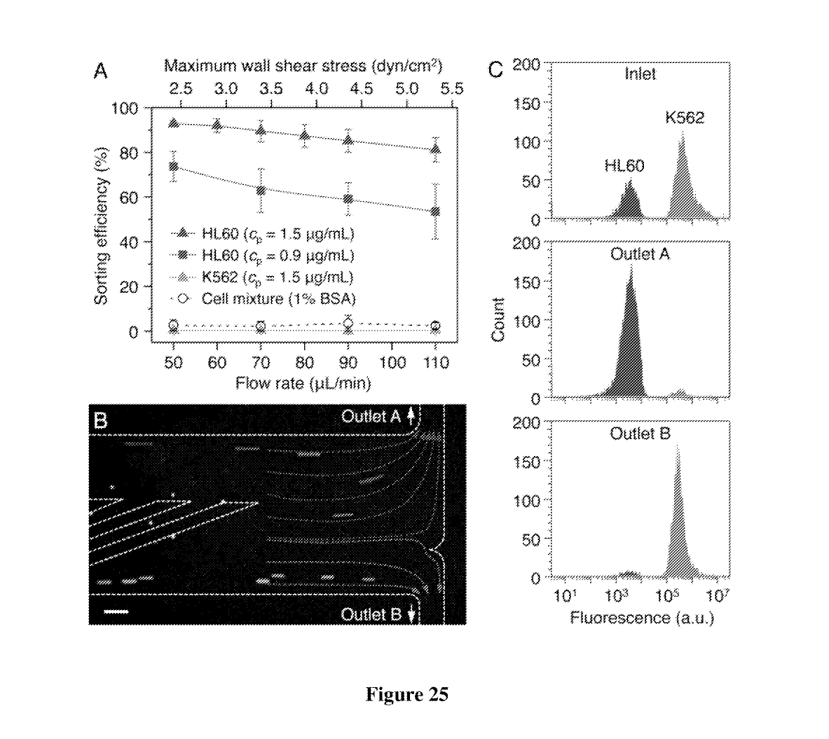

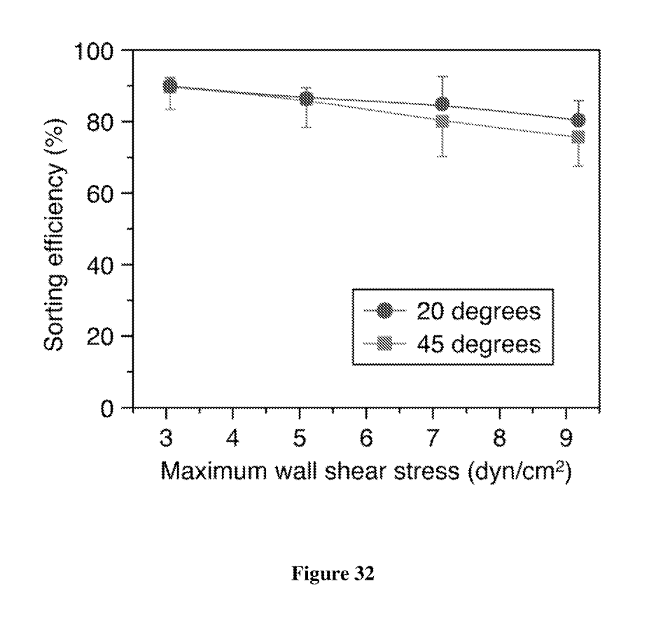

We tested a sorting capability of the device under various operational conditions (i.e. shear stress, selectin concentration, and ridge angle) for an input stream comprising only HL60 or K562 cells (FIG. 25 and FIG. 32). For a single channel, we defined a sorting efficiency, ηₛ=n_{A}/(n_{A}+n_{B})×100(%), where n_{A} and n_{B} are the numbers of cells per unit time (counted at a sorting bifurcation shown in FIG. 4B) flowing to a sorting outlet A and outlet B, respectively. Increasing flow rates create higher levels of shear stress that make it difficult to sustain cell rolling, resulting in a decrease in a sorting efficiency at higher flow rates (FIG. 25A). In contrast, increasing P-selectin concentration (from 0.9 μg/mL to 1.5 μg/mL) facilitates tethering and rolling, thereby improving a sorting efficiency (FIG. 25A). However, a further increase in the concentration to 4.0 μg/mL induced an undesirable transition from stable rolling to firm adhesion. As a negative control, the device was blocked with 1% BSA solution (no P-selectin) and a mixture of HL60 and K562 cells was injected into the device. In this case, there were no observable cell-surface interactions and the cells were not sorted (FIG. 25A).

As such, cell rolling includes a delicate balance between rapid formation and rapid dissociation of adhesive bonds. This dynamic nature results in a trade-off between a sorting efficiency and throughput. If the flow rate is increased for achieving higher throughput, the forces and torques imposed on rolling cells accelerate bond dissociation and the cells can detach into the fluid stream without separation. The device exemplified here circumvented this limitation, for example, by employing scalable parallelization (FIG. 22B). The simple, passive channel design enables a sorting throughput to be greatly augmented by stacking multiple sorting layers without compromising performance parameters such as purity and recovery.

We confirmed the ability of the parallel channel device to separate cells from a heterogeneous mixture. Cells were injected at a concentration of ˜2.4×10⁵ cells/mL (HL60 and K562 in ratio of 2:3) and a sample throughput of 70 μL/min (˜10⁶ cells/h) corresponding to a wall shear stress of 3.4 dyn/cm². The P-selectin incubation concentration was 1.5 μg/mL. For a single sorting channel, these conditions yielded ηₛ=89.6±4.8% and 0.4±0.3% for HL60 and K562 cells, respectively (FIG. 25A). A single run through the parallel channel device produced high-purity cell populations at the outlets; the outlet A with a flow rate of ≈51.5 μL/min held 95.0±2.8% HL60 cells, while the outlet B with a flow rate of ≈18.9 μL/min had 94.3±0.9% K562 cells (n=5 different devices; FIG. 25C). The HL60 cells and K562 cells were enriched by factors of 28 and 11 at the corresponding outlets, respectively. The enrichment was calculated as the ratio of the numbers of HL60 cells to K562 cells (or vice versa) collected at the outlet, divided by the same ratio at the inlet. A sorting process yielded considerably high sorting recovery of 87.2±3.7% and 76.7±14.2% for K562 and HL60 cells, respectively. Sorting recovery was calculated as the number of collected target cells in each outlet (HL60 for the outlet A and K562 for the outlet B) divided by the total number of each cell type injected. Cell loss occurred by gravitational cell settling in the injection syringe and tubing, and with cells remaining in the sorting channels and dead volumes of the collection channels. Recovery may be enhanced by using density-matched or viscous buffer solutions, or by selectively coating only sorting channels with P-selectin. As determined by trypan blue staining, there was no significant difference between the viabilities of sorted cells (97.4±2.6% for HL60 and 96.3±3.3% for K562) and unsorted cells (97.3±2.4%).

In summary, deterministic cell rolling represents a useful method of affinity cell separation, enabling effective cell capture, easy cell recovery, and highly scalable parallelization in a passive device. The method can obviate separate capture and elution steps, and produces high-purity output streams of target and non-target cells from a single input stream of cells. In some embodiments, a useful device in accordance with the present disclosure can be configured to perform positive selection from heterogeneous cultures to enrich cells with more robust rolling capacity for therapeutic use. Many cell types including leukocytes, platelets, hematopoietic stem and progenitors, and metastatic cancer cells exhibit rolling adhesion on vascular surfaces. This approach could be applied to sort cells based on these cell rolling interactions. In some embodiments, surfaces are designed to produce cell rolling behavior based on specific cell surface markers or phenotypes, which is so far an unexplored area. Also, in some embodiments, the purity and throughput may be further improved for any particular target cell type, for example, via optimization of the obstacle geometry to enhance cell-surface interactions while minimizing sorting of non-target cells, and by configuring sorting channels in series. This approach therefore represents a promising tool for applications including point-of-care diagnostics, cell-based therapeutics, and cell separation in research laboratories.

Materials

Recombinant human P-selectin (sP-selectin monomer) was purchased from R&D Systems (Minneapolis, Minn.). Human promyelocytic leukemia cell line (HL60) and human chronic myelogenous leukemia cell line (K562), Iscove's modified Dulbecco's medium (IMDM), and fetal bovine serum (FBS) were obtained from American Type Culture Collection (ATCC, Manassas, Va.). Dulbecco's phosphate-buffered saline (DPBS) was supplied by Mediatech Inc. (Manassas, Va.). All other materials were obtained from Invitrogen Inc. (Carlsbad, Calif.) and Sigma-Aldrich (St. Louis, Mo.), unless specified.

Cell Culture and Characterization

HL60 and K562 cells were cultured in IMDM supplemented with 20% FBS, 100 U/mL penicillin and 100 μg/mL streptomycin. Cell concentration was maintained between 10⁵ and 10⁶ cells/mL. HL60 cells at passages between 10 and 40 were used for experiments. To determine sorting performance (i.e. purity, throughput, and recovery), K562 cells were washed with DPBS and then stained with 5 μM CFDA at 37° C. for 30 min only for separation of mixed samples of HL60 and K562 cells shown in FIGS. 25B and 25C. For the experiments in FIG. 25A, K562 cells were used without staining and did not exhibit cell rolling on P-selectin coated ridges. After staining, K562 cells were washed twice with DPBS, and mixed with HL60 cells before each sorting experiment. HL60 cells were normally used without staining. For taking a sorting video, HL60 cells were washed with DPBS and then stained with 5 μM CellTracker at 37° C. for 30 min. After staining, the cells were washed twice with DPBS, and mixed with K562 cells. There was no observable difference in cell rolling behavior between stained and unstained HL60 cells, or between stained and unstained K562 cells. The sorted cells were collected separately by using 2.0-mL centrifuge tubes and analyzed with a fluorescence-activated cell sorter (FACS; Accuri Cytometers, Inc., MI). Sorting recovery was calculated as the number of collected target cells in each outlet (HL60 for the outlet A and K562 for the outlet B) divided by the total number of each cell type injected.

Device Fabrication

Microfluidic devices were fabricated in a multilayer structure for scalable parallelization in which multiple sorting layers could be sandwiched between the top injection layer and the bottom collection layer (FIG. 27). Each layer of poly(dimethylsiloxane) (PDMS) was separately cast from microfabricated photoresist molds and then selectively punched to provide fluid interconnections with other layers. The perforated layers were exposed to oxygen plasma for 40 s, and irreversibly assembled by sequentially stacking the collection layer, sorting layers, and the injection layer. This method allows for easy addition of more sorting layers as required. Each sorting layer comprised ten microchannels, each further comprising a focusing and a sorting channel (FIG. 28). The focusing channel had 80 focusing ridges with θ_{f}=60°, d_{f}=35 μm, and g_{f}=35 μm (FIG. 28). A sorting channel comprised 51 sorting ridges with dₛ=150 μm and gₛ=150 μm for θₛ=20°, and with dₛ=75 μm and dₛ=75 μm for θₛ=45° (FIG. S3). The devices with θₛ=20° were used for experiments, unless specified. We tailored the channel gap, h_{g}=26 μm to be in the range d<h_{g}<2.5d so that the cell motion and interaction with the ridges can be limited by steric hindrance, where d is the cell diameter of 11.7±1.5 μm (HL60) and 14.6±1.4 μm (K562).

Master molds for each layer were made by patterning SU8 photoresist (Microchem Corp., Newton, Mass.). The master mold which contained thick channel features (244.8±30.6 μm in height) for cell injection and collection was formed on a silicon substrate in single photolithographic process. Two-step photolithographic techniques were used to define two-layered features for cell sorting. The first layer of photolithography defined the main linear-channel structures (h_{g}, 26.0±1.0 μm in depth); the second layer was aligned to lie on top of the channel structures in the first layer and defined the pattern of slant ridges (hₑ, 62.6±2.3 μm in depth).

The microfluidic conduits in each layer were designed to uniformly distribute and collect cells. The sub-millimeter-scale channels in the injection and collection layers were designed to have negligible pressure drop, and most of the pressure drop occurred through the pressure dump resistors connected to the end of each separation channel (FIG. 28). The pressure drop for a rectangular channel is given by

$$Δ P = \frac{a μ QL}{{WH}^{3}}$$

$$a = {12 [ 1 - \frac{192 H}{{π}^{5} W} tanh ( \frac{π w}{2 h} ) ]}^{- 1}$$

where W is the width of the channel, H is the height of the channel, a is a dimensionless parameter that depends on aspect ratio (W/H), μ is the viscosity, Q is the volumetric flow rate, and L is the channel length. The calculated ratio of the pressure drop in the injection and sorting channels to the pressure-dump channels was roughly 1:110, sufficiently high for the fluid to be distributed uniformly through the parallel sorting channels.

Square posts of 50 μm×50 μm, spaced 50 μm apart were fabricated in PDMS (58.9±2.0 μm in depth) to examine the difference in the trajectories of the rolling and non-rolling cells at the corners of the posts.

Experimental Setup

The assembled device was degassed in a vacuum chamber for 20 min, filled with P-selectin solution (cₚ=1.5 μg/mL, unless specified) by pipetting, and then incubated at room temperature. After 3 h incubation, the device was washed with 1% bovine serum albumin (BSA). The inherent hydrophobicity of PDMS can facilitate protein physisorption although covalent immobilization of P-selectin enhances its functional stability on surface. Stable, reliable cell rolling for at least 3 h observed in the device shows that selectin physisorption on PDMS substrates is sufficient for proof-of-concept studies.

Cells (˜1×10⁵ to 2×10⁵ cells/mL) were flowed into the device at 50 to 110 μL/min using a syringe pump (KD Scientific Inc., Holliston, Mass.). Cell rolling and sorting were recorded using a high-speed camera (EX-F1; CASIO, Japan) mounted on inverted microscopes (TE2000-U and TS100; Nikon, Japan). Visualization of flow patterns was performed using streak images of 1-μm diameter fluorescent polystyrene beads (Invitrogen Inc.), which were estimated to have negligible inertial effects (particle Reynolds number ˜10⁻⁴) under the device operating conditions. Particles flowing near either the top or bottom surface of a sorting channel could be discerned by adjusting the focal plane of the objective.

Numerical Simulation

Flow simulations were performed to calculate the maximum shear stress on the slant ridges where cells can tether and roll, and to visualize streamlines in the channels. Commercial finite element analysis software (COMSOL Multiphysics 3.4) was used to solve three-dimensional models (focusing and sorting channels) in the “Incompressible Navier-Stokes Mode.” No-slip boundary conditions were applied at the channel walls. The velocity at the inlet was set to have a parabolic profile and the pressure at the outlet was set to zero. The channel for simulation was 670 μm in width and 63 μm in depth with a gap between the top surfaces of the SR and the channel, h_{g}=26 μm, a ridge interval, gₛ=150 μm, and a ridge length, dₛ=150 μm (FIG. S3 and S5). The first eight and nine ridges arranged in order of decreasing widths by 5 μm from the initial width of 640 μm were simulated.

Flow Visualization

Visualization of flow patterns was performed using streak images of 1-μm diameter fluorescent polystyrene beads in the device with θₛ=20°. Flow visualization with 1-μm particles revealed that the geometry-driven flow circulation was induced and composed mainly of two oppositely flowing currents (FIG. 26). Above the top surface of the ridges, the flow circulates from a sorting/gutter side to the focusing side, while within the trenches, the flow circulates in the opposite direction towards the gutter side. This flow pattern directs cell rolling from a sorting ridges to the channel floor and out towards the gutter (FIG. 27A).

Sorting Efficiency (ηₛ) Dependence on Ridge Angles

Previous studies have shown that the degree of non-axial flow is maximized when the groove intersection angle θ=45° and that it decreases with deviation from this angle. We investigated whether a sorting efficiency, ηₛ is influenced by change in the angle of a sorting ridges (SR), θₛ. To conduct this experiment, we fabricated two different devices with θₛ=20° and 45° (Fig. S3). We found that there was no significant difference between the devices over shear stresses ranged from 3 to 9 dyn/cm² (FIG. 32). In either case, the fluid flow caused the cells to flow in the lateral direction and come into contact with the SR. Once the target cells tethered on the SR, whether they sustained cell rolling was determined by shear stress, not θₛ (FIG. 32).

Effect of Gravity on Deterministic Cell Rolling

The motion of cells is under the influence of buoyant and gravitational forces as well as hydrodynamic forces. However, we estimate that gravitational forces are not significant in the device operation. The maximum fluid velocity through the grooved region is ˜3.5 mm/s for a sorting condition (FIG. 30). Assuming Stokes drag, a cell with a diameter of 11.7 μm and a density of 1.05 g/cm³ has a settling velocity of ˜3.7 μm/s in water at 22° C. The cell is estimated to settle down by a distance on the order of 100 nm under the influence of gravity while traversing a sorting ridge (or ˜2.5 μm while traversing 25 ridges before tethering), which is small compared to the channel height of 62.6 μm. The flow rate in the focusing channel is an order of magnitude higher, and gravitational effects are expected to be even smaller.

Effect of Inertial Forces on Deterministic Cell Rolling

To assess the influence of inertial forces on deterministic cell rolling, we examined the Reynolds number R=UₘC/ν and particle Reynolds number Rₚ=Uₘd²/νC, where Uₘ is the maximum flow velocity, d is the particle diameter, ν is the kinematic viscosity, and C is a characteristic dimension (the gap size, h_{g}). Since the device is parallelized with 20 channels, a 70 μL/min injection rate for a sorting corresponds to a flow rate of 3.5 μL/min in each channel. For this sorting condition, the above equations yield R=0.09 and Rₚ=0.02 for a sorting channel, and R=1.12 and Rₚ=0.2 for the focusing channel. Inertial forces dominate particle motion at Rₚ of order 1. Due to the low Rₚ for a sorting channel, we can ignore the effect of inertial forces on deterministic cell rolling. In contrast, based on the high Rₚ and the small dimensions (a/h_{g}˜0.45) of the focusing channel, inertial forces may have an influence on the focusing process and their effect should be further investigated for better understanding.

Device Design Criteria

Deterministic cell rolling employs a complex flow pattern that results in cell sorting in the presence of cell rolling interactions. For deterministic cell rolling, the following two phenomena occur under the same flow conditions and device geometry:

1) In the absence of cell rolling interactions, the cells are desirably focused by hydrophoresis.

The following design guidelines for channel dimensions permit cells to be focused by hydrophoresis: If the cell has a diameter d, the gap size (h_{g}) should typically be in d<h_{g}<2.5d and the total channel height (hₜ) should satisfy 2h_{g}<hₜ. Stated in terms of the trench depth (hᵣ), the latter implies h_{g}<hᵣ. The first condition states that the gap is preferably greater than the cell diameter (to prevent clogging), but not so large that the cells will follow individual streamlines. This part can be appreciated by considering the streamlines shown in FIG. 30C, bottom panel. When a cell approaches the focusing region, the streamline that it follows enters into the trench. However, the cell is displaced into another streamline above it, and thus keeps out of the trench. The displacement is proportional to the cell radius; a point particle will just follow the streamline into the trench and go towards a sorting side. At the next ridge, the cell is further displaced into another streamline above the present one, and so on. Thus, the cell preferably has a certain minimum size in order to stay focused by hydrophoresis. The second criterion states that the trench preferably has sufficient depth to create a circulating flow pattern. In addition, the trench angle cannot be too close to 0° or 90° for the circulation patterns to be created.

2) In the presence of cell rolling interactions, cells are desirably deflected into the trenches and sorted to the gutter side.

Due to the nature of the streamlines near the focusing side, we hypothesize that cells will be directed into the trench as long as conditions for stable rolling are maintained. Shear stress on the order of 0.1-10 dyn/cm² can typically support stable rolling of cells on selectins; therefore, the flow rate is preferably set to achieve this range of shear stresses. In addition, the trench is preferably deep enough and wide enough to allow the cell to roll in it towards a sorting side, i.e. d<hᵣ, and d<gₛ sin θ, where gₛ is the groove spacing, and gₛ sin θ is the width of the trench (FIG. 28). Prior studies on cell rolling suggest that the area of contact is typically in the range of 5 to 10 μm. To ensure the stable tethering of cells, the length (dₛ) of a sorting ridges should be larger than 10 μm. We set dₛ to 150 μm for stable tethering of multiple cells without interference of each other. We also set the groove spacing (gₛ) to the same dimension with dₛ so that multiple cells can roll in the trench without significant cell-cell interactions.

Application of Deterministic Cell Rolling to Other Systems

To develop deterministic cell rolling as a new technique for cell separation, we chose a robust and well-characterized system of HL60 cells rolling on P-selectin to verify the principle. Hematopoietic stem and progenitor cells have been studied for their specific separation by CD34-mediated rolling adhesion on P-selectin. Myung et al. have shown that MCF7 cells, human breast cancer cells exhibit specific rolling adhesion on E-selectin mediated by CD24. Several other receptor-ligand pairs are known to support cell rolling, including molecules expressed on non-mammalian cells. While we anticipate that deterministic cell rolling will be extended to these and other cell types, new applications will need to be developed on a case-by-case basis due to the need to tailor the surfaces to ensure cell rolling. In cases where a specific affinity molecule that supports rolling is not available, tailoring of the surface may require selection or identification of low-affinity adhesion entities, other lectins, or co-immobilization of antibodies with selectins. Cells may also potentially be modified by labeling them with molecules that facilitate cell rolling or by expressing such molecules on the cell surface. These approaches could potentially enable deterministic cell rolling to be extended to other cell systems of practical interest.

### Example 4

### Characterization of Dynamic Adhesion of Mesenchymal Stem Cells

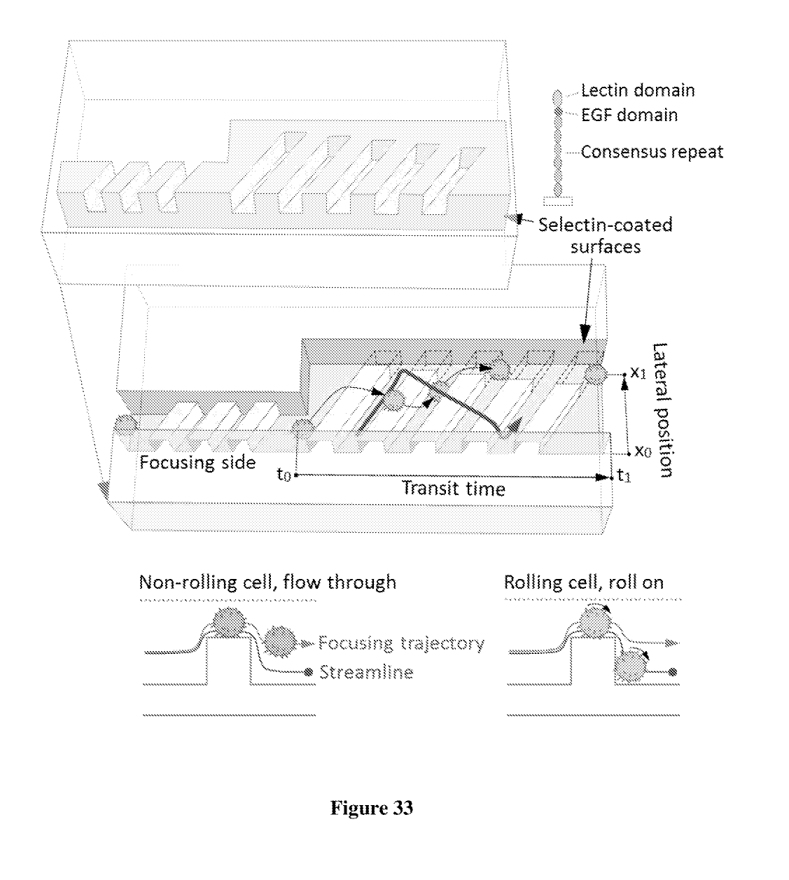

The Cell Rolling Cytomer (CRC) described in the present Example is specifically designed to examine the adhesion characteristics of a given cell sample without limiting the information to only those cells that exhibit adhesion. The polydimethylsiloxane (PDMS) device comprises two sets of slant ridges placed on both the top and bottom of the channel, which superpose circulating flow patterns on the axial flow, thereby pushing the cells against the ridges (FIG. 33). The first set of ridges called focusing ridges (FR) were designed in a narrow channel (100 μm in width), such that they can be coated with adhesion entities, yet not support stable cell rolling due to the high shear stress. As cells pass through the channel, cell focusing autonomously occurs by physical interactions between the cells and the ridges, which force the cells to remain over the ridges in the gap region where the flow converges toward the focusing side of the channel. The second set of ridges, called adhesion ridges (AR), were designed in a wider channel (200 μm in width) that allowed stable rolling of target cells on the AR due to lowered shear stress. This design ensures that every cell that flows into the CRC is forced into contact with adhesive surfaces in the controlled location, the AR region, where the cell trajectories can be observed.

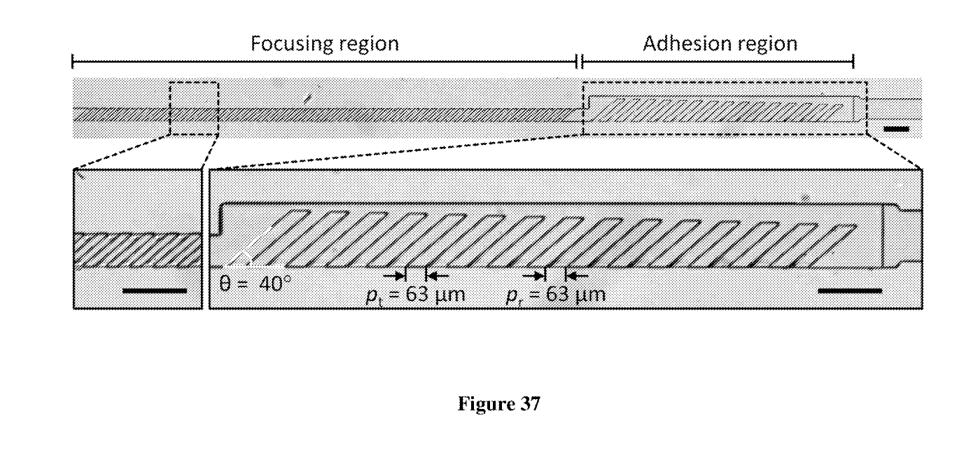

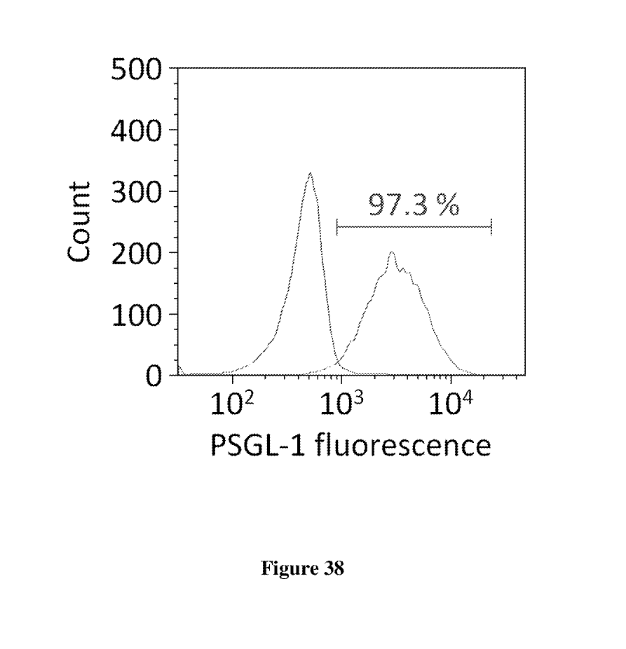

The CRC was fabricated by replica molding of PDMS with a photoresist mold which is made by two-step photolithography (FIG. 37). Prior to each experiment, the device was degassed for 30 min, filled with selectin solutions by pipetting, and then incubated at room temperature for surface functionalization with selectins via physisorption. A syringe pump was utilized to wash the device with 1% bovine serum albumin (BSA) and to control the injection flow rate of cell suspensions.

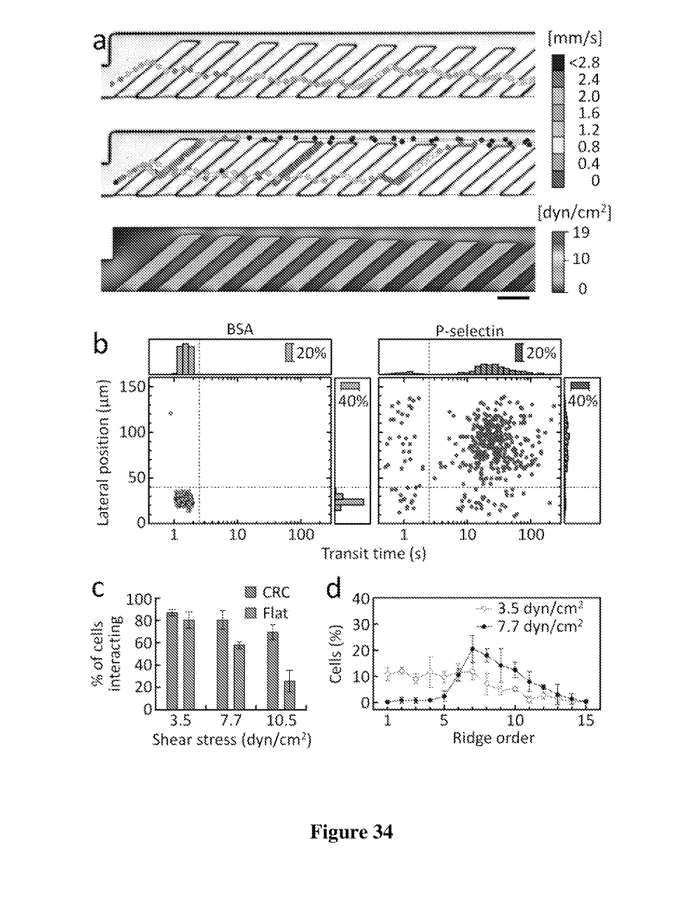

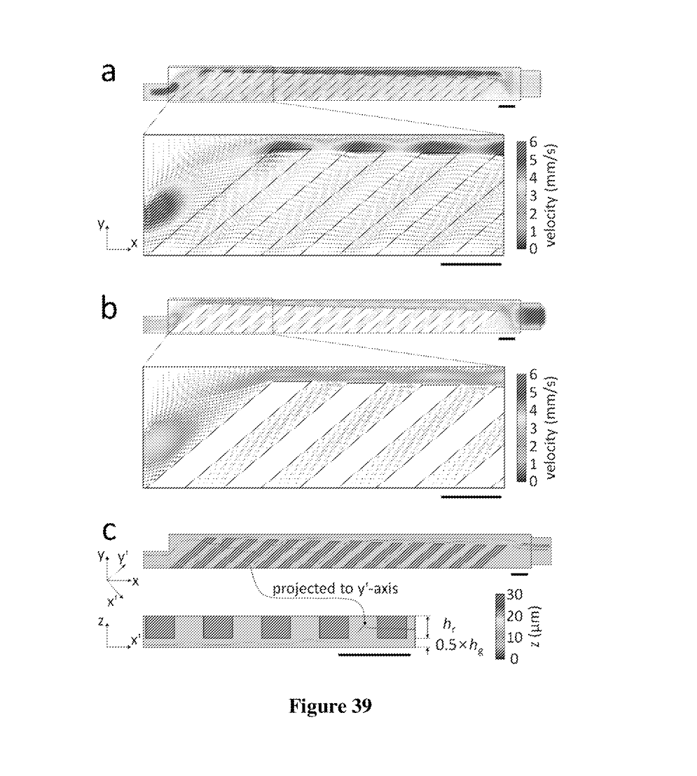

As a model system, we first tested a leukemic cell line, HL60 that expresses high levels of P-selectin glycoprotein ligand-1 (PSGL-1, CD62P) (Figure S2) and exhibit rolling on P-selectin mediated primarily by PSGL-1. The cells were introduced into the CRC coated with P-selectin (1.5 μg/mL) or passivated with 1% BSA as a negative control. The trajectories of HL60 cells that were subjected to a shear-stress gradient of 3.5-8.2 dyn/cm² are shown in FIG. 34a. Transient ligand-receptor interactions slow down flowing HL60 cells at 1.5±0.6 mm/s (n=19) to 7.4±3.5 μm/s (n=39) and mediate cell rolling along the AR until they were detached in the gutter region. The traces of the rolling HL60 cells showed that they followed the same path as the streamlines inside the trenches, while the flowing HL60 cell without the adhesion interactions followed the streamlines over the AR (FIGS. 234a and 39). This clearly confirms that the flow circulation not only enhances cell-surface interactions by inducing repeated collisions with the slant ridges, but also directs the flow of cells differently according to their affinity to adhesion ligands (FIGS. 33 and 34a). Transit-time and position measurements were plotted in scatter plots that flowing, non-interacting cells were in the left lower quadrant and rolling, interacting cells were mostly in the right upper quadrant (FIG. 34b). The left upper quadrant indicates weak interacting cells, which can change their trajectories by transient interactions and be readily detached from the adhesion surface. The right lower quadrant represents interacting cells, which re-entered the ridge region after detaching at the edge of the AR and came out of the CRC at the lateral position below 40 μm, since the recirculation is still formed at the boundary between the ridge and gutter regions.

Next, we examined how the shear stress affect the cell-capture efficiency of the CRC, comparing with a conventional flat chamber (w×h=98 μm×1,000 μm). In the flow chamber, cells were allowed to settle down on the bottom surface, and were then subjected to a shear stress. The level of shear stress corresponds to the minimum shear stress that cells can experience during tethering (i.e. initialization of molecular interactions) in the CRC with spatial shear stress gradients (FIG. 34a). The adhesion ridges were arranged in order of decreased widths by 3 μm, which generates a shear stress gradient of −0.28 dyn/cm² per ridge. With the CRC, we observed that rolling HL60 cells took ≈25 times longer than flowing cells to pass through the channel (tₜ>2.5 s) (FIG. 34b). Gating in this region yields 86.9±2.8% in the right two quadrant (n=3). At shear stresses of 7.7 and 10.5 dyn/cm², the capture efficiency of the flat chamber significantly compromised (FIG. 34c). In contrast, the CRC exhibit high efficiency in capturing cells and support stable rolling in the range of shear stress (3.5 to 10.5 dyn/cm²). We demonstrated the capability of the CRC to capture cells in the controlled location, the AR region with high capture efficiency, which is crucial for quantification of cell adhesion.

Examining the frequency of cell tethering on each ridge provides an additional quantitative metric for rolling adhesion. The tethering frequency is calculated as the number of cells tethering at each ridge divided by the total number of rolling cells. With increasing shear stress from 3.5 dyn/cm² to 7.7 dyn/cm², the peak of the tethering profile shifts to the seventh ridge where the level of shear stress is ≈1.5 times lower than ones of the first ridge, although there is no significant difference in cell-capture efficiency (FIGS. 34c and 34d). Since the level of shear stress and the number of ligand-receptor bonds can affect a cell's ability to initiate and sustain rolling adhesion, the tethering profile in the CRC with spatial shear stress gradients can be also changed by those factors, and be utilized to determine optimal flow conditions for cell adhesion and compare rolling abilities between cell populations.

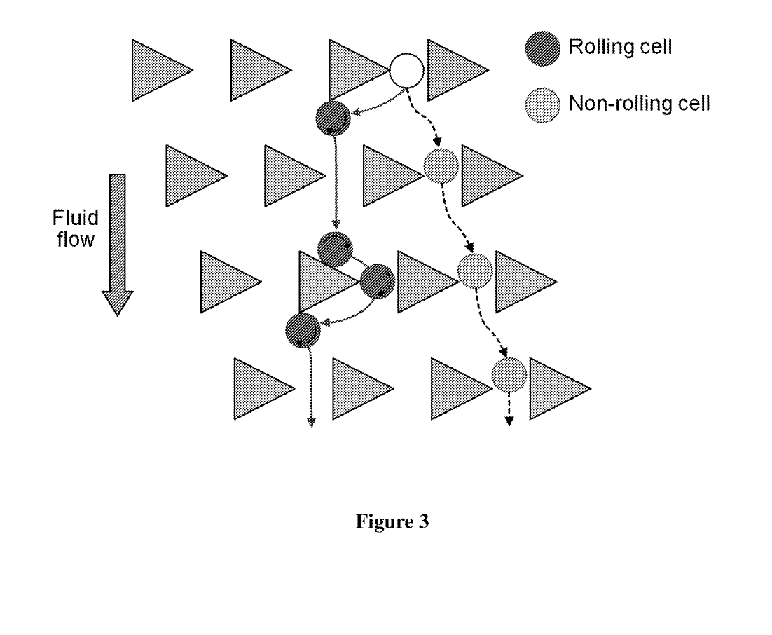

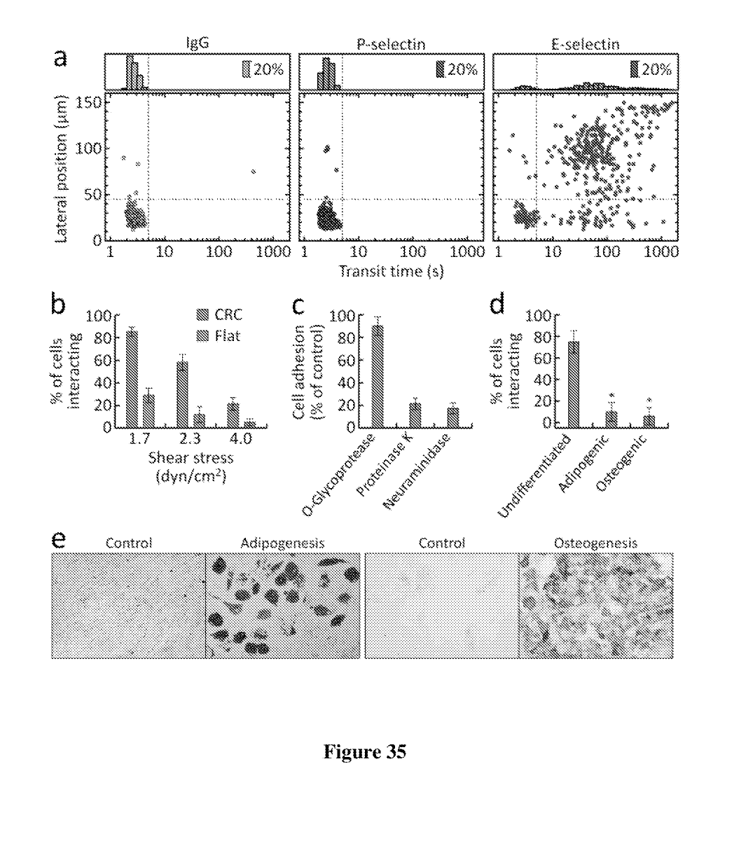

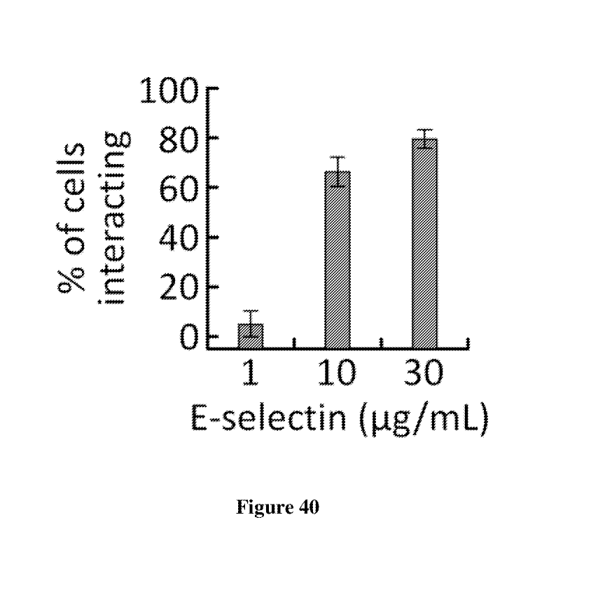

After characterization of the CRC, we performed adhesion cytometry on human MSCs to identify specific ligands that can mediate MSC rolling and quantify their rolling ability. Since it is known that human MSCs exhibit a rolling response on activated endothelial cells, we first examined E- and P-selectin which are expressed on the surface of activated endothelium and mediate rolling adhesion of circulating cells. As shown in FIGS. 3a and S5, the majority of MSCs (85.3±4.0%, n=3) exhibited a rolling response on E-selectin at aν=1.7 dyn/cm² and cₛ=30 μg/ml, where σ is the shear stress and cₛ is the selectin incubation concentration. The rolling response decreases in a shear stress-dependent manner, while the response increases with cₛ (FIGS. 35a and 40). An optimal condition σ=1.7 dyn/cm² and cₛ=30 μg/ml was used for the following rolling assays. As expected, the CRC was highly effective at capturing cells, whereas significantly less capture was measured with the flat device (p<0.05 for all shear stress conditions tested; one-way ANOVA), suggesting that forced cell contact is crucial for initiation of rolling adhesion. There were no observable adhesion events in P-selectin-coated channels (FIG. 35a). Our results suggest that MSCs exhibit specific transient adhesion on E-selectin-coated surfaces. The surface coating of the P- and E-selectin channels was checked after each experiment using HL60 positive control cells, which express high levels of PSGL-1, a major ligand for E- and P-selectins. The cells exhibited the same adhesion response, firm adhesion in both channels.

It is noteworthy that the adhesion response of human MSCs for E- and P-selectin is contrary to previous observations. This might be because 1) the adhesion response for a single adhesion ligand can be different with ones for activated endothelial cells which express multiple adhesion ligands and mediate cell rolling with their combination, and 2) the high concentration of selectins (30 μg/ml) in this study can facilitates tethering and rolling, compared with ones (5 μg/ml) of a previous study. Previously MSCs have been shown to exhibit poor rolling properties on selectin-coated flat surfaces. Given that MSCs preferentially home to sites of inflammation, which in turn suggests there is a rolling mechanism for MSCs, the CRC is an effective method to probe the rolling adhesion of a cell type that exhibits non-robust rolling properties.

The binding receptors of MSC adhesion still remain unknown, although Henschler and colleagues reported the rolling of human MSCs on human umbilical cord vein endothelial cells. As determined by flow cytometry, MSCs lacked E-selectin ligands such as CD15s, CD18, CD24, CD43, CD65, and CD162 (Figure S6). We tested the susceptibility of the unknown binding receptors on MSCs for E-selectin to treatment with O-glycoprotease, proteinase K, and neuraminidase. The ability of MSCs to form rolling adhesion was significantly blocked by treatment with proteinase K and neuraminidase, while treatment with O-glycoprotease failed to inhibit the rolling response (FIG. 35c). These enzymes selectively cleave peptide bonds mostly after the carboxyl group of N-substituted hydrophobic aliphatic and aromatic amino acids, the glycosidic linkages of neuraminic acids (also called sialic acid), and mucin-like domains, respectively. The results indicate that human MSCs may bind to E-selectin using receptors that contain sialic acid residues on protein scaffolding, not O-sialo mucin-like glycoproteins.

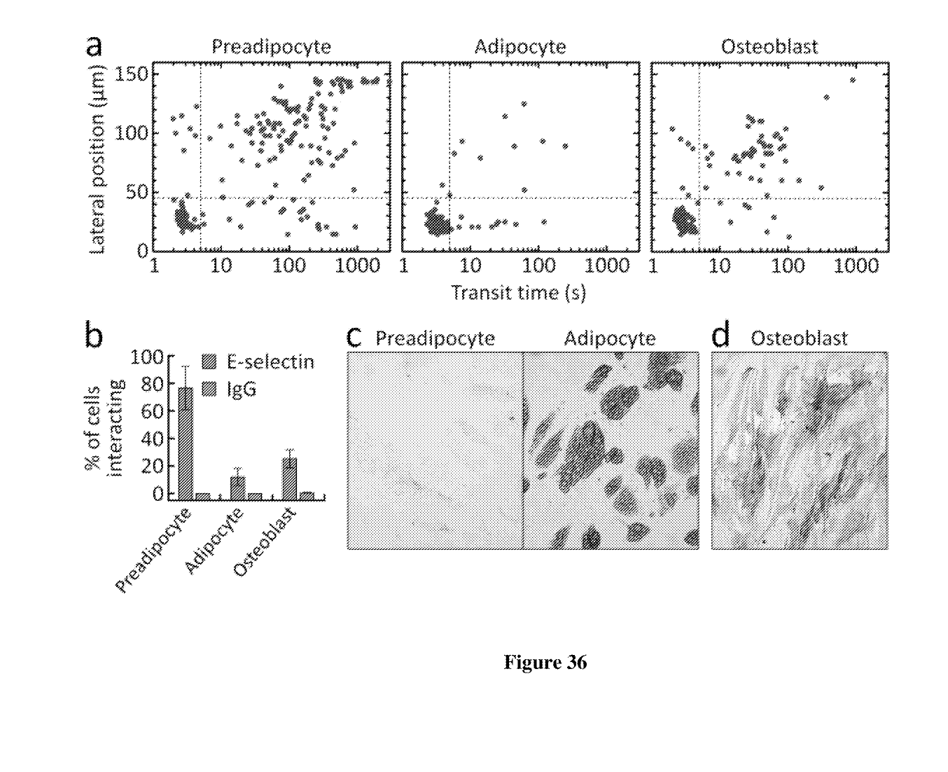

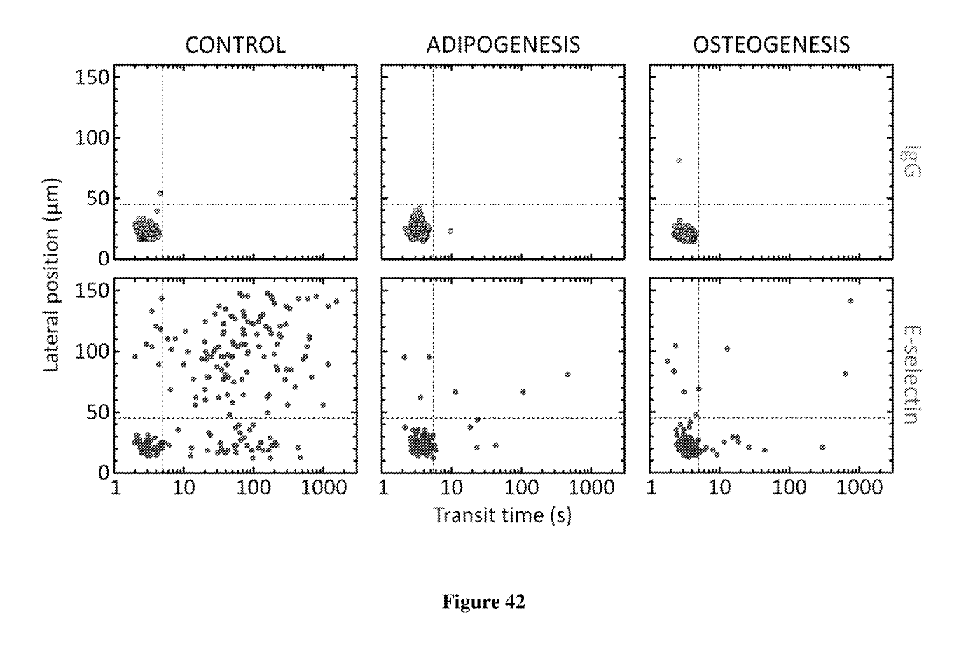

Cell differentiation is often associated with changes in mechanical properties of a cell. Without wishing to be bound to any particular theory, we hypothesize that the adhesion capability of MSCs can correlate with their differentiation status was examined by performing cell rolling cytometry on differentiated MSC populations. For induction of differentiation, the medium was replaced either with an adipogenesis differentiation medium or the MSC culture medium supplemented with 10 nM dexamethasone. The osteogenic- and adipogenic-induced MSCs were harvested on day 14 and the induction of differentiation was confirmed by histochemical staining. MSCs were stained positive for Oil Red O as induced to adipocytes and positive for alkaline phosphatase as differentiated along osteogenesis (FIG. 35e). As shown in FIGS. 35d and 42, significant correlations existed between differentiation and rolling response, supporting the proposed hypothesis. Analyses showed that the rolling response in both differentiated populations was significantly decreased relative to non-induced control group. To gain insight into whether the change in rolling activity is applicable to mature cell types, we measured the rolling adhesion of human osteoblasts and adipocytes. Adipocytes were obtained from 7 days of differentiation of human preadipocytes which are adipocyte progenitors and exhibit robust rolling adhesion in a similar way to MSCs (76.7±15.8%, n=3) (FIG. 36a). As shown in FIG. 36, both adipocytes and osteoblasts exhibit weak rolling response of 12.0±6.3% and 25.3±6.4%, respectively (n=3). Our data suggest that differentiation along adipogenesis and osteogenesis induces a statistically significant decrease in the rolling adhesion of MSCs.

In conclusion, this Example provides some embodiments of a cell rolling separation device as described here and confirms that such devices enables effective cell capture and quantitative analysis of rolling adhesion and achieves cell sorting. Such devices also provide insight into the transient adhesion process of human MSCs; 1) E-selectin is an adhesion entity that supports rolling adhesion of MSCs, 2) the rolling response may be mediated by sialic acid residues of receptor proteins on MSCs, and 3) significant correlation exists between MSC differentiation (adipogenesis and osteogenesis) and rolling response. The applicability of the CRCs as described in this Example, like other devices described herein, extends beyond MSCs, and could potentially introduce a new label-free quantitative method to characterize surface expression of a variety of cells and tissues.

Materials

Recombinant human P-selectin, P-selectin/Fc chimera, E-selectin/Fc chimera, and recombinant IgG₁ Fc were purchased from R&D Systems (Minneapolis, Minn.). Human promyelocytic leukemia cell line (HL60), Iscove's modified Dulbecco's medium (IMDM), and fetal bovine serum were obtained from American Type Culture Collection (ATCC, Manassas, Va.). Human mesenchymal stem cells (MSC), MSC growth medium, MSC adipogenic differentiation medium, human osteoblast, osteoblast growth medium, human subcutaneous preadipocytes, and preadipocyte growth medium (PGM) were purchased from Lonza (Walkersville, Md.). Oil red 0, Fast Blue RP salt, and Naphthol AS-MX phosphate alkaline solution were obtained from Sigma-Aldrich (St. Louis, Mo.). Monoclonal antibodies were mouse antihuman anti-CD18, -CD24, -CD34, -CD43, -CD45, -CD73, -CD90, and -CD162 (BD Biosciences, San Jose, Calif.); -CD15s (Santa Cruz Biotechnology, Santa Cruz, Calif.); and -CD65 (eBioscience, San Diego, Calif.). Dulbecco's phosphate-buffered saline (DPBS) was supplied by Lonza. All other materials were obtained from BD Biosciences and Sigma-Aldrich, unless specified.

Cell Culture and Differentiation

All the cells were cultured at 37° C. in 5% humidified CO₂ using their own culture medium. MSCs at passage number 3-7, osteoblasts at 2-5, and preadipocytes at 2-5 were used for experiments. For adipogenic differentiation of MSCs, the medium was switched to the MSC adipogenic differentiation medium. The medium was alternated twice or thrice per week between the adipogenic induction and maintenance media for 14 days. Osteogenic differentiation of MSCs was performed using the MSC culture medium supplemented with 10 nM dexamethasone (Millipore, Billerica, Mass.) for 14 days. Adipocyte induction of preadipocytes was performed for 7 days using the adipocyte differentiation media which was prepared by adding the entire contents of the PGM supplements to the 100 mL of PGM. Noninduced controls were kept in culture medium. For experiments, cell culture media was aspirated and the flask washed with DPBS. Cells were detached using accutase cell detachment solution (BD Biosciences). The cells were then washed twice and re-suspended in DPBS or culture medium. Cell samples were filtered with 30 μm celltrics filter (Partech, Germany) to remove cell aggregates before running experiments.

The cell viability was determined by trypan blue, and was 96.2±2.1%, 89.7±3.5%, and 91.0±1.6% for un-treated, enzyme-treated, and differentiated MSCs, respectively. The viability of osteoblasts, preadipocytes, and adipocytes which were differentiated from preadipocytes was 97.0±3.0%, 96.0±2.0%, and 91.2±1.0%, respectively.

Histochemical staining was performed to examine cell differentiation. Cells were rinsed with PBS, fixed with 4% paraformaldehyde, and carefully washed with deionized water. Fixed cells were stained probing solutions (Oil Red O or alkaline phosphatase) and then washed with deionized water. Osteoblasts were also identified based on positive staining for alkaline phosphatase activity.

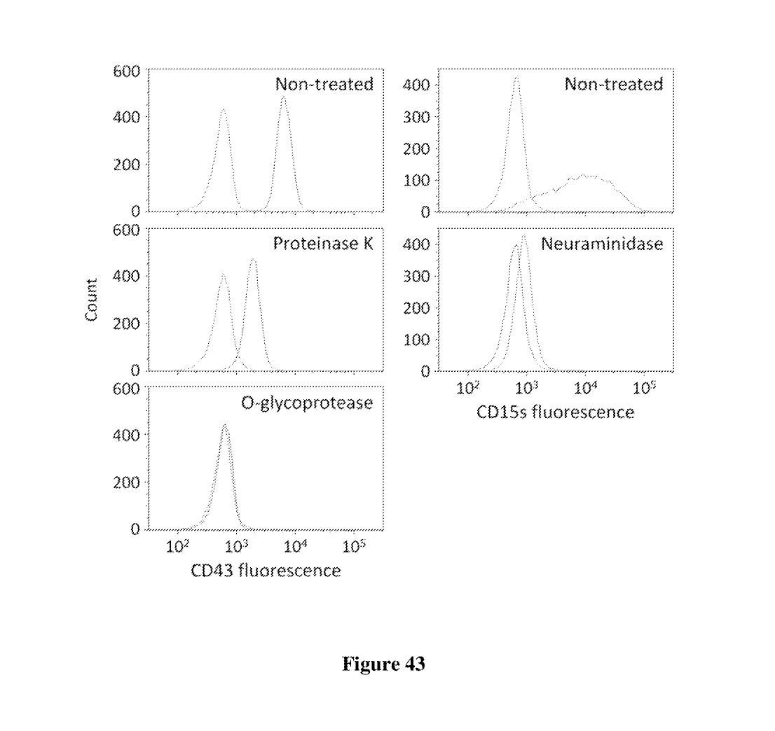

For enzymatic inhibition experiments, MSCs were treated with 120 μg/mL O-glycoprotease (Accurate Chemical and Scientific Corporation, Westbury, N.Y.), 200 μg/mL Proteinase K (Sigma-Aldrich), or 100 U/mL neuraminidase (New England BioLabs, Ipswich, Mass.) for 30 min at 37° C. Untreated controls were kept in 1% BSA solution under the same conditions. Efficiency of enzyme treatment was examined by staining of treated and untreated HL60 cells, which have known receptors that contain 0-sialo mucin-like glycoproteins (i.e. CD43) or sialic acid residues (i.e. CD15s), and subsequent flow cytometric analysis, leading to a significant reduction in fluorescence intensity after enzyme treatment (FIG. 43).

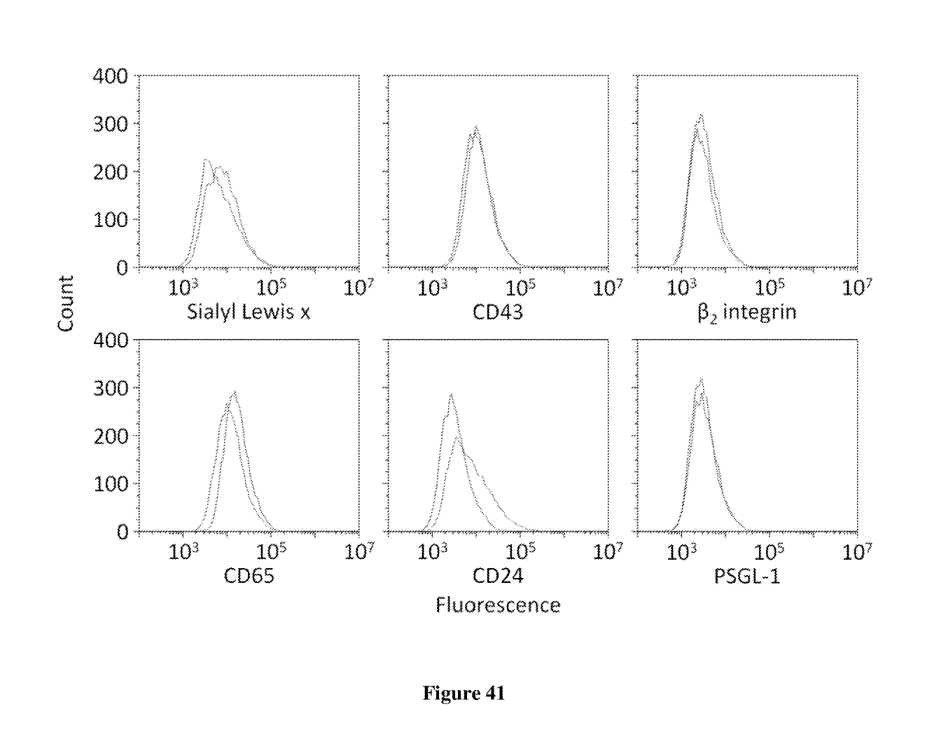

Flow cytometry analysis was performed using a fluorescence-activated cell sorter (FACS; Accuri Cytometers, Inc., MI). MSCs expressed high level MSC markers CD73 and CD90 (>99% cells), while they did not express hematopoietic markers CD34 or CD45 and receptors which are known to have a binding affinity to E-selectin (FIGS. 41 and 44).

Device Design and Fabrication

The cell rolling cytometer (CRC) has a stacked structure in which two poly(dimethylsiloxane) (PDMS)-channel layers with upper and lower ridges face each other (FIG. 33). Each layer of PDMS was cast from microfabricated photoresist molds, and then aligned and bonded together. Master molds for each layer were made by patterning SU8 photoresist (Microchem Corp., Newton, Mass.). Two-step photolithographic techniques were used to define slant ridges on linear channels. The first layer of photolithography defined the main linear-channel structures; the second layer was aligned to lie on top of the channel structures in the first layer and defined the pattern of slant ridges. The focusing channel had 55 focusing ridges with θ=40°, pₜ=35 μm, and pᵣ=35 μm (FIG. 37). The adhesion channel comprised 15 adhesion ridges with θ=40°, pₜ=35 μm, and pᵣ=35 μm (FIG. 37). The channel height (h_{c}) and gap height (h_{g}) between the top and bottom ridges were determined by the following design rule. In the absence of adhesion interactions, the cells must be focused by hydrophoresis. For the cells to be focused by hydrophoresis, the channel dimensions should satisfy the following design guidelines: If the cell has a diameter d, the gap size (h_{g}) should typically be in d<h_{g}<5d and the total channel height (hₜ) should satisfy 2h_{g}<hₜ. On these criteria, the CRC for HL60 cells (d=11.7±1.5 μm) was defined with h_{g}=25.8±0.2 μm and hₜ=87.6±1.4 μm and the CRC for MSCs (d=19.1±5.1 μm) was defined with h_{g}=36.1±0.1 μm and hₜ=100.9±2.7 μm. The flat chamber device was also formed in PDMS with a cross-section of w×h=98 μm×1,000 μm.

Experimental Setup and Measurement

Cells (˜8 to 30 cells/μL) were flowed into the CRC using a syringe pump (KD Scientific Inc., Holliston, Mass.). The injection rate was 13.4±8.1 cells/min Cell adhesion was recorded at 300 frames per second (fps) using a high-speed camera (EX-F1; CASIO, Japan) mounted on an inverted microscope (TE2000-U; Nikon, Japan). The transit time at which cells pass through the adhesion region was counted manually with a time resolution of 0.2 msec. The lateral position of cells at the end of the channel was measured using ImageJ software (NIH). For flow-chamber experiments, cells were allowed to settle down to the bottom for 5 min and then applied the target shear stresses. The cells were considered non-interacting when they moved at the velocity of the flow, whereas cells moving at lower velocities were defined as interacting. Prior to each experiment, the channels were degassed in a vacuum chamber for 30 min, filled with 1.5 μg/mL P-selectin for HL60 cells and with 30 μg/mL E- or P-selectin/Fc for other cell types, unless specified. After 3 h incubation at room temperature, the channels were washed with 1% bovine serum albumin.

Numerical Simulation

Flow simulations were performed to calculate the shear stress on the slant ridges where cells can tether and roll, and to visualize streamlines in the channels. Commercial computational fluid dynamics software (CFD-ACE+; ESI, Huntsville, Ala.) was used to solve three-dimensional models (focusing and adhesion channels) in the “Flow Mode.” No-slip boundary conditions were applied at the channel walls. The four different geometries of channel were used for simulation; the focusing channel for HL60 cells with w=100 μm, h_{g}=26 μm, and hₜ=88 μm; the adhesion channel for HL60 cells with w=200 μm, h_{g}=26 μm, and hₜ=88 μm (FIG. 39); the focusing channel for MSCs with w=100 μm, h_{g}=36 μm, and hₜ=101 μm; and the adhesion channel for MSCs with w=200 μm, h_{g}=36 μm, and hₜ=101 μm.

### Other Embodiments and Equivalents

Although this disclosure has described and illustrated by reference to certain embodiments and examples, it is to be understood that the disclosure is not restricted to those particular embodiments or examples. Rather, the disclosure includes all embodiments that are functional and/or equivalents of the specific embodiments and examples that have been described.

1. A device comprising:
a flow channel dimensioned to permit a cell stream flow therethrough;
one or more 3D structures protruding from at least one surface of the flow channel, wherein the 3D structures are arranged and constructed so that at least two sets of streamlines are defined when the cell stream is flowed therethrough;
at least one cell adhesion entity coated on at least part of the 3D structures, which adhesion entity interacts with a target cell in the cell stream brought into contact with the 3D structures by flow of a stream comprising the target cell through the flow channel such that the target cell's trajectory through the flow channel is diverted due to the interaction.

2. The device of claim 1, wherein the 3D structures have a height greater than half the average diameter of the target cell.

3. The device of claim 2, wherein interaction between the target cell and the adhesion entity on the 3D structures diverts the target cell trajectory from a first set of streamlines to a second set of streamlines.

4. (canceled)

5. The device of claim 1, wherein the 3D structures are arranged and constructed to define at least one trench therebetween along which target cells roll by virtue of interaction with the adhesion entity.

6. The device of claim 5, wherein the at least one trench has a width larger than the average diameter of the target cell.

7. The device of claim 1, wherein the 3D structures are coated substantially uniformly with the at least one cell adhesion entity.

8. The device of claim 1, wherein the flow channel is coated substantially uniformly with the at least one cell adhesion entity.

9-13. (canceled)

14. The device of claim 13, wherein the 3D structures comprise a plurality of lateral microstructures.

15-16. (canceled)

17. The device of claim 1, wherein 3D structures are arranged and constructed so that cells with differences in size are separated.

18. The device of claim 17, wherein the 3D structures are arranged and constructed so that cells flowing through the flow channel are sorted by deterministic lateral displacement (DLD), in which the lateral displacement is influenced by interaction with the adhesion entities.

19-53. (canceled)

54. A device comprising:
a flow channel defined by opposing side walls and opposing lower and upper surfaces, wherein a flow channel comprises a longitudinal axis defined along the lower and upper surfaces and parallel to the side walls, a width W_{S} between the side walls, a height H_{S} between the lower and upper surfaces and an inlet for introducing a stream of target and non-target cells into a flow channel; and
a series of lateral microstructures protruding from one or both of the lower and upper surfaces of a flow channel that are coated with a cell adhesion entity, wherein the microstructures comprise a longitudinal axis defined across the width of a flow channel that forms an acute angle α_{M} with the longitudinal axis of a flow channel, a width W_{M}<W_{S} defining a gap between the microstructures and at least one of the side walls and a height H_{M}<H_{S} defining a clearance over or under the microstructures,
wherein the dimensions of a flow channel and microstructures are such that when a stream of target and non-target cells is flowed along the direction of the longitudinal axis of a flow channel under conditions that permit cell rolling, target cells are diverted laterally from the direction of the longitudinal axis and into the gap between the microstructures and at least one of the side walls as a result of rolling on the microstructures.

55. The device of claim 54 further comprising:
an outlet through which target cells are collected; and
an outlet through which non-target cells are collected.

56. The device of claim 55, wherein the longitudinal axis of a flow channel bisects both the inlet and the outlet through which non-target cells are collected.

57. The device of claim 54, wherein the gap between the microstructures and at least one of the side walls increases as the microstructures move downstream.

58. The device of claim 57, wherein the gap between the microstructures and at least one of the side walls defines a gutter along which the target cells flow once they approach the side walls.

59. The device of claim 54, wherein the microstructures are parallelograms.

60. The device of claim 54, wherein the microstructures are V-shaped and the longitudinal axis of a flow channel bisects the microstructures.

61-67. (canceled)

68. The device of claim 54, wherein the microstructures protrude from both the lower and upper surfaces of a flow channel.

69. The device of claim 58, wherein regions of the lower and upper surface that are located in between the microstructures are also coated with a cell adhesion entity.

70. (canceled)

71. The device of claim 58, wherein the microstructures that protrude from the lower surface are positioned directly below the microstructures that protrude from the upper surface.

72-98. (canceled)
